(19) United States
(12) Patent Application Publication
(10) Pub. No.: US 2022/0064859 A1
(43) Pub. Date: Mar. 3, 2022

(54) MODIFIED FIBER-BASED MATERIALS AND METHODS OF MAKING THE SAME

(71) Applicant: Apeel Technology, Inc., Goleta, CA (US)

(72) Inventors: Carlos Hernandez, Santa Barbara, CA (US); Charles Frazier, Goleta, CA (US); Mina Faust, Santa Barbara, CA (US); Alena Higgins, Goleta, CA (US); Gigi Lin, Fremont, CA (US); Wade Ingram, Goleta, CA (US)

(21) Appl. No.: 17/461,945

(22) Filed: Aug. 30, 2021

Related U.S. Application Data
(60) Provisional application No. 63/071,559, filed on Aug. 28, 2020.

(51) Int. Cl. D21H 17/14; D21H 19/18; D21H 19/12; D21H 17/18; D21H 21/16; D21H 27/10

(52) U.S. Cl. CPC D21H 17/14; D21H 19/18; D21H 27/10; D21H 17/18; D21H 21/16; D21H 19/12

(57) ABSTRACT

Compounds, monomers, and compositions that are useful for modifying the properties of fiber-based materials, and methods of manufacturing those materials are described.

### CROSS-REFERENCE TO RELATED APPLICATION

This application claims the benefit of U.S. Patent Application No. 63/071,559 filed on Aug. 28, 2020.

### BACKGROUND

Food packaging allows for various types of food products to be shipped and stored without destroying the integrity of the food product. For example, food packaging can increase the length of time during which a food product is fit for human consumption and can protect the food product from stressors and contaminants that may diminish the integrity of the food product during shipment and/or storage.

Paper is an appealing, environmentally friendly option for use in food packaging applications. However, paper has certain limitations that need to be overcome before it can be useful on a wide scale. For example, paper-based materials can be weak, and are not impermeable to grease and/or water. Thus, there is a need to develop materials, and methods of manufacturing those materials, that are biodegradable, and are impermeable to water, grease, and other substances.

### SUMMARY

This specification describes modified fiber-based materials and methods of making the same. The compounds that are useful in the compositions, materials, and methods of this disclosure form coatings and/or polymers that can be used to confer certain characteristics (e.g., hydrophilicity, hydrophobicity, lipophilicity, lipophobicity, omniphobicity, gas and/or grease impermeability, water impermeability, etc.) in fiber-based materials. In some embodiments, the compounds are commercially available, or are derived from plant matter, e.g., cutin or seed oil. In some embodiments, the compounds are obtained by depolymerizing cutin to isolate cutin-derived monomers, oligomers, and/or their esters, and mixtures thereof. In some embodiments, the compounds are extracted from seed oil to obtain seed-oil derived monomers, oligomers and/or their esters, and mixtures thereof.

In one or more embodiments, the compounds according to this disclosure are associated with the fibers of the fiber-based products described herein. In certain such embodiments, the compounds are associated with the fibers through physical adsorption i.e., non-covalent interactions (e.g., Van der Waals interactions, hydrogen bonding, and/or electrostatic interactions), chemical adsorption, i.e., covalent interactions (e.g., covalent bonds and ionic bonds), or associated by proximity, i.e., present within the same material. In some embodiments, the compounds according to this disclosure are associated with the fibers by intercalation with the fibers of the fiber-based products according to this disclosure. In some embodiments, the compounds according to this disclosure are associated with fibers by forming a coating on the surface of the fibers according to this disclosure. In one or more embodiments, the compounds described herein are useful for applying one or more optional coatings to the surface of the fiber-based products described herein.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a fiber-based composite, comprising:

a network comprising a multiplicity of fibers; and

a coating on the multiplicity of fibers, wherein the coating comprises:
one or more compounds of Formula IA; and
one or more compounds of Formula IIA,
wherein a ratio of a total weight of the one or more compounds of Formula IA to a total weight of the one or more compounds of Formula IIA is in a range of 1:1 to 99:1, Formula IA is:

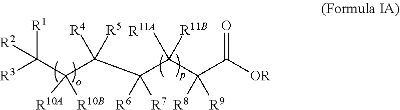

or a salt thereof when R is C₁-C₆ alkyl optionally substituted with one or more of OH and C₁-C₆ alkoxy,

wherein:

R is selected from the group consisting of H and C₁-C₆ alkyl optionally substituted with one or more of OH and C₁-C₆ alkoxy;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

the sum of o and p is from 0 to 17, and

### Formula IIA is:

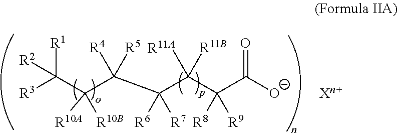

wherein:

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17;

the sum of o and p is from 0 to 17;

Xⁿ⁺ is a cationic moiety having formal charge n; and

wherein a surface of the fiber-based composite is hydrophobic and lipophobic.

Embodiment 2 is the fiber-based composite of embodiment 1, wherein the ratio is in a range of 2:1 to 20:1 or 5:1 to 10:1.

Embodiment 3 is the fiber-based composite of embodiments 1 or 2, wherein:

a carbon chain length of at least one of the compounds of Formula IA is in a range of C12 to C30,

a carbon chain length of at least one of the compounds of Formula IIA is in a range of C12 to C30, or

a carbon chain length of at least one of the compounds of Formula IA is in a range of C12 to C30 and a carbon chain length of at least one of the compounds of Formula IIA is in a range of C12 to C30.

Embodiment 4 is the fiber-based composite of any one of embodiments 1 through 3, wherein:

a carbon chain length of at least one of the compounds of Formula IA is in a range of C16 to C24,

a carbon chain length of at least one of the compounds of Formula IIA is in a range of C16 to C24, or

a carbon chain length of at least one of the compounds of Formula IA is in a range of C16 to C24 and a carbon chain length of at least one of the compounds of Formula IIA is in a range of C16 to C24.

Embodiment 5 is the fiber-based composite of any one of embodiments 1 through 4, wherein the network defines pores, and some of the pores are at least partially filled with the coating.

Embodiment 6 is the fiber-based composite of any one of embodiments 1 through 5, wherein the coating comprises a polymerization product of one or more compounds of Formula IA-B, wherein Formula IA-B is Formula IA when R is hydrogen.

Embodiment 7 is the fiber-based composite of any one of embodiments 1 through 6, wherein:

at least one of the one or more compounds of Formula IA-B has a chain length of C16 or C18,

at least one of the one or more compounds of Formula IA-B has 0, 1, 2, or 3 hydroxyl groups, or

at least one of the one or more compounds of Formula IA-B has a chain length of C16 or C18 and at least one of the one or more compounds of Formula IA-B has 0, 1, 2, or 3 hydroxyl groups.

Embodiment 8 is the fiber-based composite of any one of embodiments 1 through 7, wherein:

the one or more compounds of Formula IA-B comprise two or more compounds of Formula IA-B, and the two or more compounds of Formula IA-B comprise at least:
a first compound of Formula IA-B and a second compound of Formula IA-B;
a first compound of Formula IA-B and a third compound of Formula IA-B; or
a second compound of Formula IA-B and a third compound of Formula IA-B,
   wherein:
      the first compound of Formula IA-B is an omega hydroxy compound, wherein at least one of R¹, R², R³, R⁴, and R⁵ or at least one occurrence of R^{10A}, R^{10B}, R^{11A}, and R^{11B} is a hydroxyl group,
      the second compound of Formula IA-B is a mid-chain hydroxy compound, wherein at least one of R⁴, R⁵, R⁶, and R⁷ or at least one occurrence of R^{10A}, R^{10B}, R^{11A}, and R^{11B} is a hydroxyl group, and
      the third compound of Formula IA-B is a dihydroxy compound, wherein two of R¹, R², R³, R⁴, R⁵, R⁶, R⁷, R⁸, and R⁹ or at least one occurrence of R^{10A}, R^{10B}, R^{11A}, and R^{11B} are hydroxyl groups.

Embodiment 9 is the fiber-based composite of any one of embodiments 1 through 8, wherein the coating is hydrophobic and lipophobic.

Embodiment 10 is the fiber-based composite of any one of embodiments 1 through 9, wherein:

a contact angle of water on the surface in air at 25° C. is at least 50°, and

a contact angle of an oil on the surface in air at 25° C. is at least 50°.

Embodiment 11 is the fiber-based composite of any one of embodiments 1 through 10, wherein the surface is a first exterior surface, and a second exterior surface opposite the first exterior surface is hydrophilic, lipophilic, or both.

Embodiment 12 is the fiber-based composite of any one of embodiments 1 through 11, wherein the multiplicity of fibers comprises one or more cellulose-containing materials.

Embodiment 13 an article comprising the fiber-based composite of any one of embodiments 1 through 12.

Embodiment 14 is the article of embodiment 13, wherein a surface of the article is hydrophobic and lipophobic.

Embodiment 15 is the article of embodiments 13 or 14, wherein the fiber-based article is a package, a dish, or a container.

Embodiment 16 is a method of making the fiber based composite of any of embodiments 1 through 12, the method comprising:

contacting the network comprising the multiplicity of fibers with a liquid composition, wherein the liquid composition comprises:
the one or more compounds of Formula IA; and
the one or more compounds of Formula IIA; and

drying the liquid composition to yield the fiber-based composite.

Embodiment 17 is a method of making a fiber-based composite, the method comprising:

combining a multiplicity of fibers and a liquid to yield a slurry;

combining one or more compounds of Formula IA with the slurry;

removing some of the liquid from the slurry to yield a fibrous mass; and

drying the fibrous mass, wherein drying the fibrous mass comprises polymerizing the one or more compounds of Formula IA, thereby forming a polymer in contact with the multiplicity of fibers to yield the fiber-based composite,

wherein a surface of the fiber-based composite is hydrophobic and lipophobic, and Formula IA is:

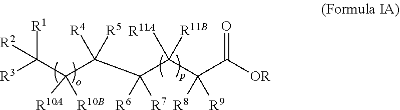

or a salt thereof when R is C₁-C₆ alkyl optionally substituted with one or more of OH and C₁-C₆ alkoxy,

wherein:

R is selected from the group consisting of H and C₁-C₆ alkyl optionally substituted with one or more of OH and C₁-C₆ alkoxy;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

the sum of o and p is from 0 to 17.

Embodiment 18 is the method of embodiment 17, further comprising disposing a liquid comprising one or more compounds of Formula IA and one or more compounds of Formula IIA on the surface of the fiber-based composite to form a coating on the fiber-based composite, wherein Formula IIA is:

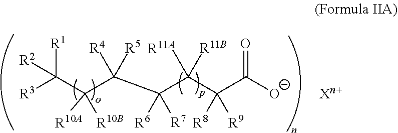

wherein:

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17;

the sum of o and p is from 0 to 17; and

Xⁿ⁺ is a cationic moiety having formal charge n.

Embodiment 19 is the method of embodiment 18, wherein the fiber-based composite defines pores, and some of the pores are at least partially filled with the coating.

Embodiment 20 is the method of any one of embodiments 17 through 19, wherein drying the fibrous mass comprises forming a fiber-based article comprising the fiber-based composite.

Embodiment 21 is the method of any one of embodiments 17 through 20, wherein drying the fibrous mass comprises heating the fibrous mass to a temperature greater than 140° C.

Embodiment 22 is the method of any one of embodiments 18 through 21, wherein forming the coating comprises removing at least a portion of the solvent by heating to a temperature at least 10° C. less or at least 20° C. less than a melting point or glass transition temperature of at least one of the one or more compounds of Formula IA.

Embodiment 23 is the method of any one of embodiments 18 through 22, wherein forming the coating comprises removing at least a portion of the solvent by heating the fibrous mass to a temperature in a range of 50° C. to 100° C.

Embodiment 24 is the method of any one of embodiments 17 through 23, wherein drying the fibrous mass comprises thermoforming the fibrous mass.

Embodiment 25 is the method of any one of embodiments 17 through 24, wherein the fiber-based composite defines pores, and some of the pores are at least partially filled with a polymerization product of one or more compounds of Formula IA-B, wherein Formula IA-B is Formula IA when R is hydrogen.

Embodiment 26 is the method of any one of embodiments 17 through 25, wherein the multiplicity of fibers comprises one or more cellulose-containing materials.

Embodiment 27 is a fiber-based composite formed by any one of embodiments 17 through 26.

Embodiment 28 is an article comprising the fiber-based composite of embodiment 27.

Embodiment 29 is the article of embodiment 28, wherein a surface of the article is hydrophobic and lipophobic.

Embodiment 30 is the article of embodiments 28 or 29, wherein the fiber-based article is a package, a dish, or a container.

In another aspect, this disclosure is directed to a package made from fiber-based material comprising an inner layer of fibers associated with polymerized monomers according to this disclosure, and one or more optional outer coatings as described herein.

### BRIEF DESCRIPTION OF THE DRAWINGS

FIG. 1 is a graph showing the Cobb values for untreated cardboard, cardboard that was manufactured with a 95:5 SA-1G to SA-Na (the monoglycerides being a 1:1 ratio of PA-1G to SA-1G), and cardboard treated with traditional wax.

FIG. 2 shows images of drops of water and grapeseed oil on untreated filter paper, filter paper treated with a 50 g/L solution of 10,16-dihydroxypalmitic acid (10,16-DHPA), and 10,16-dihydroxypalmitic acid (10,16-DHPA) followed by a 50 g/L solution of a 95:5 (weight ratio) mixture of SA-1G to SA-Na.

FIG. 3A is a chart depicting the gas permeability results for untreated wax paper, wax paper containing polymerized 10,16-DHPA, and wax paper containing polymerized 10,16-DHPA and a coating of a 95:5 (weight ratio) mixture of SA-1G to SA-Na (left). FIG. 3B is an enlarged view of the treated samples in FIG. 3A.

FIG. 4 is a chart depicting the gas permeability results for untreated filter paper, filter paper containing polymerized 10,16-DHPA, and filter paper containing polymerized 10,16-DHPA and a coating of a 95:5 (weight ratio) mixture of SA-1G to SA-Na.

FIG. 5 shows images of drops of water and grapeseed oil on untreated filter paper, filter paper containing polymerized 10,16-DHPA, and filter paper containing polymerized 10,16-DHPA and a coating of a 95:5 (weight ratio) mixture of SA-1G to SA-Na.

FIG. 6A is a chart depicting the effect of the deposition method on the gas permeability of wax paper substrates and filter paper substrates. FIG. 6B is an enlarged view of FIG. 6A.

FIG. 7 is a chart depicting the effect of polymerization temperature on the gas permeability of wax paper substrates.

FIGS. 8A and 8B are charts depicting the effect of the number of coating layers on the gas permeability of wax and filter paper substrates, respectively.

FIGS. 9 and 10 show oil absorptivity versus concentration of coating solution for various samples.

FIG. 11 shows visual results of the oil and water absorptivity tests.

### DETAILED DESCRIPTION

### Definitions

Unless otherwise defined herein, scientific and technical terms used in this application have the meanings that are commonly understood by those of ordinary skill in the art. In case of conflict, the present specification, including definitions, will control.

Throughout this specification and embodiments, the word “comprise,” or variations such as “comprises” or “comprising,” will be understood to imply the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting.

Unless otherwise required by context, singular terms shall include pluralities and plural terms shall include the singular.

The articles “a”, “an”, and “the” are used herein to refer to one or to more than one (i.e., to at least one) of the grammatical object of the article.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

When the terms “about” and “at least” precede a numeral, these terms also apply to any following numeral or range. For example “about 1, 2, or 3” means “about 1, about 2, or about 3” and “about 1 to 10, 10 to 20, or 20 to 30” means “about 1 to about 10, about 10 to about 20, or about 20 to about 30.” “At least” is used in the same way.

Each embodiment of this disclosure may be taken alone or in combination with one or more other embodiments of this disclosure.

Exemplary methods and materials are described herein. Methods and materials similar or equivalent to those described herein can also be used in the practice or testing of the various aspects and embodiments. The materials, methods, and examples are illustrative only and not intended to be limiting.

In order for the disclosure to be more readily understood, certain terms are first defined. These definitions should be read in light of the remainder of the disclosure as understood by a person of ordinary skill in the art. Additional definitions are set forth throughout the detailed description.

As used herein, the term “fiber” or “fibers” refers to a natural or man-made substance that is longer than it is wide. Fibers are useful to produce a variety of consumer products, including, e.g., paper, textiles, and packaging materials. Specific types of fiber include, but are not limited to, cellulose, acrylic, kevlar, modacrylic, nomex, nylon, polyester, polyethylene, polypropylene, polycarbonates, polyamides, spandex, rayon, abaca, acetate, aloe vera, bamboo, baba, kapok, coir, corn, flax, hemp, jute, kenaf, lyocell, modal, pina, raffia, ramie, rayon, sisal, seacell, lenpur, lyocell, soy protein, pineapple, alpaca, angora wool, azlon, byssus, camel hair, cashmere wool, chiengora, lambswool, llama, mohair wool, qiviut, rabbit, silk, vicuna, wool, and yak fiber. In some embodiments, the fiber is nylon, polyester, polyethylene, polypropylene, polycarbonates, polyamides or cellulose fiber. In some embodiments, the fiber is cellulose fiber.

As used herein, the term “fiber-based material” refers to a substance that has been made from individual fibers, such as those described herein. Examples of fiber-based materials include packaging material, paper products, and textiles. The fiber-based materials can be manufactured with process additives or functional additives known to those skilled in the art, in addition to the compounds, monomers, and compositions described herein. Process additives are additives that improve the operation of the manufacturing process of the material. Functional additives are those that enhance or alter properties of the final material. In some embodiments, the additive is a wax additive.

As used herein, the terms “polymer” and “copolymer” are used interchangeably, and refer to a substance that has a molecular structure consisting of one or more repeating units (i.e., monomers). Those skilled in the art will recognize that the term “copolymer” specifically refers to substances that consist of two or more distinct repeating monomers.

At various places in this disclosure, substituents of compounds of the disclosure are disclosed in groups or in ranges. It is specifically intended that the disclosure include each and every individual sub-combination of the members of such groups and ranges. For example, the term “(C₁-C₆)alkyl” is specifically intended to include C₁ alkyl (methyl), C₂ alkyl (ethyl), C₃ alkyl, C₄ alkyl, C₅ alkyl, and C₆ alkyl.

The term “—C₁-C₆ alkyl” as used herein, refers to a saturated, branched- or straight-chain alkyl group containing from 1 to 6 carbon atoms, such as, but not limited to, methyl, ethyl, n-propyl, isopropyl, n-butyl, sec-butyl, isobutyl, tert-butyl, n-pentyl, isopentyl, neopentyl, and n-hexyl.

The term “—C₂-C₆ alkenyl” refers to an aliphatic hydrocarbon having from 2 to 6 carbon atoms, including straight chain or branched chain groups having at least one carbon-carbon double bond. Representative examples include, but are not limited to, ethenyl, 1-propenyl, 2-propenyl (allyl), isopropenyl, 2-methyl-1-propenyl, 1-butenyl, 2-butenyl, and the like. When the compounds of the disclosure contain a C₂-C₆ alkenyl group, the compound may exist as the pure E (entgegen) form, the pure Z (zusammen) form, or any mixture thereof.

The term “—C₂-C₆ alkynyl” refers to an aliphatic hydrocarbon having two to six carbon atoms and at least one carbon-carbon triple bond, including straight chains and branched chains having at least one carbon-carbon triple bond. Representative examples include, but are not limited to, ethynyl, propynl, butynyl, pentynyl, and hexynyl.

As used herein, the term “—C₃-C₇ cycloalkyl” refers to a carbocyclic substituent wherein the cyclic framework has 3 to 7 carbons. A “C₃-C₆ cycloalkyl” refers to a saturated carbocyclic substituent wherein the cyclic framework has 3 to 6 carbons. A “cycloalkyl’ may be a monocyclic ring, examples of which include cyclopropyl, cyclobutyl, cyclopentyl, cyclohexyl, cycloheptyl, and cyclooctyl. Also included in the definition of cycloalkyl are unsaturated non-aromatic cycloalkyls such as, but not limited to, cyclohexenyl, cyclohexadienyl, cyclopentenyl, cycloheptenyl, and cyclooctenyl. Alternatively, a cycloalkyl may contain more than one ring such as a “—C₄-C₅ bicycloalkyl”. The term “—C₄-C₅ bicycloalkyl” refers to a bicyclic ring system containing from 4 to 8 carbon atoms. The bicycloalkyl may be fused, such as bicyclo[1.1.0]butanyl, bicyclo[2.1.0]pentanyl, bicyclo[2.2.0]hexanyl, bicyclo[3.1.0]hexanyl, bicyclo[3.2.0]heptanyl, and bicyclo[3.3.0]-octanyl. The term “bicycloalkyl” also includes bridged bicycloalkyl systems such as, but not limited to, bicyclo[2.2.1]heptanyl and bicyclo[1.1.1]pentanyl.

A “heterocycle,” as used herein, refers to a cycloalkyl as defined above, wherein at least one of the ring carbon atoms is replaced with a heteroatom selected from nitrogen, oxygen or sulfur. The term “3- to 6-membered ring heterocycle” means the heterocycle substituent contains a total of 3 to 6 ring atoms, at least one of which is a heteroatom. A heterocycle may be a single ring with up to 10 total members. Alternatively, a heterocycloalkyl as defined above may comprise 2 or 3 rings fused together, wherein at least one such ring contains a heteroatom as a ring atom (i.e., nitrogen, oxygen, or sulfur). The heterocycle substituent may be attached to the core of the compounds of the present disclosure via a nitrogen atom having the appropriate valence, or via any ring carbon atom. Examples of heterocycloalkyl rings include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1]heptanonyl, 3-azabicyclo[3.1.0]hexanyl, 3-azabicyclo[4.1.0]heptanyl, and the like. Further examples of heterocycloalkyl rings include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

As used herein, the term “aryl” refers to an all-carbon monocyclic or fused-ring polycyclic aromatic group having a conjugated pi-electron system containing from 6 to 10 carbon atoms, such as phenyl, or naphthyl.

As used herein, the term “heteroaryl” refers to monocyclic or fused-ring polycyclic aromatic heterocyclic groups with one or more heteroatom ring members (ring-forming atoms) each independently selected from oxygen (O), sulfur (S), and nitrogen (N) in at least one ring. A “(5- to 14-membered)heteroaryl” ring refers to a heteroaryl ring having from 5 to 14 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 10-membered)heteroaryl” ring refers to a heteroaryl ring having from 5 to 10 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 8-membered)heteroaryl” ring refers to a heteroaryl ring having from 5 to 8 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 8-membered) nitrogen-containing heteroaryl” ring refers to a heteroaryl ring having from 5 to 8 ring atoms in which at least one of the ring atoms is nitrogen, with the remaining ring atoms being independently selected from the group consisting of carbon, oxygen, sulfur, and nitrogen. A “(5- to 6-membered)heteroaryl” refers to a heteroaryl ring having from 5 to 6 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A heteroaryl may be a single ring or 2 or 3 fused rings. Examples of heteroaryls include, but are not limited to, 6-membered ring substituents such as pyridinyl, pyrazinyl, pyrimidinyl, and pyridazinyl; 5-membered heteroaryls such as triazolyl, imidazolyl, furanyl, isoxazolyl, isothiazolyl, 1,2,3-, 1,2,4-, 1,2,5-, or 1,3,4-oxadiazolyl, oxazolyl, thiophenyl, thiazolyl, isothiazolyl, and pyrazolyl; 6/5-membered fused ring substituents such as indolyl, indazolyl, benzofuranyl, benzimidazolyl, benzothienyl, benzoxadiazolyl, benzothiazolyl, isobenzothiofuranyl, benzothiofuranyl, benzisoxazolyl, benzoxazolyl, benzodioxolyl, furanopyridinyl, purinyl, imidazopyridinyl, imidazopyrimidinyl, pyrrolopyridinyl, pyrazolopyridinyl, pyrazolopyrimidinyl, thienopyridinyl, triazolopyrimidinyl, triazolopyridinyl (e.g., 5,6,7,8-tetrahydro[1,2,4]triazolo[1,5-a]pyridin-2-yl), and anthranilyl; and 6/6-membered fused ring substituents such as quinolinyl, isoquinolinyl, cinnolinyl, quinazolinyl, oxochromanyl, and 1,4-benzoxazinyl.

The following abbreviations are used throughout this disclosure. Hexadecanoic acid (i.e., palmitic acid) is abbreviated as “PA”. Octadecanoic acid (i.e., stearic acid) is abbreviated as “SA”. Tetradecanoic acid (i.e., myristic acid) is abbreviated as “MA”. (9Z)-Octadecenoic acid (i.e., oleic acid) is abbreviated as “OA”. Dodecanoic acid (e.g., lauric acid) is abbreviated as “LA”. Undecanoic acid (e.g., undecylic acid) is abbreviated as “UA”. Decanoic acid (e.g., capric acid) is abbreviated as “CA”. Icosanoic acid (e.g. arachidic acid) is abbreviated as “AA”. Docosanoic acid (e.g. behenic acid) is abbreviated as “BA”. 1,3-dihydroxypropan-2-yl palmitate (i.e., 2-glyceryl palmitate) is abbreviated as “PA-2G”. 1,3-dihydroxypropan-2-yl octadecanoate (i.e., 2-glyceryl stearate) is abbreviated as “SA-2G”. 1,3-dihydroxypropan-2-yl tetradecanoic acid (i.e., 2-glyceryl myristate) is abbreviated as “MA-2G”. 1,3-dihydroxypropan-2-yl (9Z)-octadecenoate (i.e., 2-glyceryl oleate) is abbreviated as “OA-2G”. 1,3-dihydroxypropan-2-yl arichidate (i.e., 2-glyceryl arichidate) is abbreviated as “AA-2G”. 1,3-dihydroxypropan-2-yl behenate (i.e., 2-glyceryl behenate) is abbreviated as “BA-2G”. 2,3-dihydroxypropan-1-yl palmitate (i.e., 1-glyceryl palmitate) is abbreviated as “PA-1G”. 2,3-dihydroxypropan-1-yl octadecanoate (i.e., 1-glyceryl stearate) is abbreviated as “SA-1G”. 2,3-dihydroxypropan-1-yl tetradecanoate (i.e., 1-glyceryl myristate) is abbreviated as “MA-1G”. 2,3-dihydroxypropan-1-yl (9Z)-octadecenoate (i.e., 1-glyceryl oleate) is abbreviated as “OA-1G”. 2,3-dihydroxypropan-1-yl dodecanoate (i.e., 1-glyceryl laurate) is abbreviated as “LA-1G”. 2,3-dihydroxypropan-1-yl undecanoate (i.e., 1-glyceryl undecanoate) is abbreviated as “UA-1G”. 2,3-dihydroxypropan-1-yl decanoate (i.e., 1-glyceryl caprate) is abbreviated as “CA-1G”. 2,3-dihydroxypropan-1-yl arichidate (i.e., 1-glyceryl arichidate) is abbreviated as “AA-1G”. 2,3-dihydroxypropan-1-yl behenate (i.e., 1-glyceryl behenate) is abbreviated as “BA-1G”. Sodium salt of stearic acid is abbreviated as “SA-Na”. Sodium salt of myristic acid is abbreviated as “MA-Na”. Sodium salt of palmitic acid is abbreviated as “PA-Na”. Sodium salt of arichidic acid is abbreviated as “AA-Na”. Sodium salt of behenic acid is abbreviated as “BA-Na”. Potassium salt of stearic acid is abbreviated as “SA-K”. Potassium salt of myristic acid is abbreviated as “MA-K”. Potassium salt of palmitic acid is abbreviated as “PA-K”. Potassium salt of arichidic acid is abbreviated as “AA-K”. Potassium salt of behenic acid is abbreviated as “BA-K”. Calcium salt of stearic acid is abbreviated as “(SA)₂-Ca”. Calcium salt of myristic acid is abbreviated as “(MA)₂-Ca”. Calcium salt of palmitic acid is abbreviated as “(PA)₂-Ca”. Calcium salt of arichidic acid is abbreviated as “(AA)₂-Ca”. Calcium salt of behenic acid is abbreviated as “(BA)₂-Ca”. Magnesium salt of stearic acid is abbreviated as “(SA)₂-Mg”. Magnesium salt of myristic acid is abbreviated as “(MA)₂-Mg”. Magnesium salt of palmitic acid is abbreviated as “(PA)₂-Mg”. Magnesium salt of arichidic acid is abbreviated as “(AA)₂-Mg”. Magnesium salt of behenic acid is abbreviated as “(BA)₂-Mg”.

As used herein, the terms “substituted” or “substituent” mean an atom or group of atoms is replaced with another atom or group of atoms. Exemplary substituents include, but are not limited to, halogen, hydroxyl, alkoxyl, nitro, cyano, alkyl, alkenyl, alkynyl, cycloalkyl, cycloalkenyl, formyl, acyl, ether, ester, keto, aryl, heteroaryl, and the like.

### Compounds Useful in the Compositions, Materials, and Methods of the Disclosure

The compounds that are useful in the compositions, materials, and methods of this disclosure form coatings and/or polymers that can be used to confer certain characteristics (e.g., hydrophilicity, hydrophobicity, lipophilicity, lipophobicity, omniphobicity, gas and/or grease impermeability, water impermeability, etc.) in fiber-based materials. In some embodiments, the compounds are commercially available, or are derived from plant matter, e.g., cutin or seed oil. In some embodiments, the compounds are obtained by depolymerizing cutin to isolate cutin-derived monomers, oligomers, and/or their esters, and mixtures thereof. In some embodiments, the compounds are extracted from seed oil to obtain seed-oil derived monomers, oligomers and/or their esters, and mixtures thereof.

In one or more embodiments, the compounds according to this disclosure are associated with the fibers of the fiber-based products described herein. In certain such embodiments, the compounds are associated with the fibers through physical adsorption i.e., non-covalent interactions (e.g., Van der Waals interactions, hydrogen bonding, and/or electrostatic interactions), chemical adsorption, i.e., covalent interactions (e.g., covalent bonds and ionic bonds), or associated by proximity, i.e., present within the same material. In some embodiments, the compounds according to this disclosure are associated with the fibers by intercalation with the fibers of the fiber-based products according to this disclosure. In some embodiments, the compounds according to this disclosure are associated with fibers by forming a coating on the surface of the fibers according to this disclosure. In one or more embodiments, the compounds described herein are useful for applying one or more optional coatings to the surface of the fiber-based products described herein.

The compositions, coatings, and/or materials according to this disclosure can be characterized by polymerized monomers. The polymerized monomers are useful for tuning certain characteristics (e.g., hydrophilicity, hydrophobicity, lipophilicity, lipophobicity, omniphobicity, gas and/or grease permeability, water permeability, etc.) of materials when associated with one or more fibers according to this disclosure. In some embodiments the monomers that make up the polymer are commercially available, or are derived from plant matter, e.g., cutin or seed oil. In some embodiments, the polymers are made from cutin-derived monomers that are combined with commercially available monomers. In some embodiments, the polymers are made from seed oil-derived monomers that are combined with commercially available monomers. In some embodiments, the polymers are composed of one or more distinct monomers, i.e., in some embodiments, the polymers are copolymers.

The monomers that are useful in forming the polymers according to this disclosure can include one or more fatty acids, hydroxy fatty acids, amino carboxylic acids, alcohols, polyalcohols, amines, polyamines, or any combination thereof.

In some embodiments, the monomers comprise fatty acids wherein the fatty acid side chain is characterized by one or more polymerizable functional groups, e.g., hydroxyl or amino functional groups. In some embodiments, the monomers comprise fatty acids wherein the fatty acid side chain is characterized by 0, 1, 2, 3, 4, or 5 hydroxyl groups. In some embodiments, the fatty acid side chain is characterized by 2 hydroxyl groups. In some embodiments, the fatty acid side chain is characterized by 3 hydroxyl groups. In some embodiments, the monomers comprise fatty acids wherein the fatty acid side chain is characterized by 0, 1, 2, 3, 4, or 5 amino groups. In some embodiments, the fatty acid side chain is characterized by 2 amino groups. In some embodiments, the fatty acid side chain is characterized by 3 amino groups.

The polymers according to this disclosure can be linear, branched, crosslinked or networked. The type of structure that characterizes the polymer influences the properties of the fiber-based materials according to this disclosure. For example, networked polymers, and those comprising a higher degree of crosslinking sites result in more rigid materials, whereas linear, branched, or those with a lower degree of crosslinking sites result in more flexible materials. As the skilled worker will recognize, the polymeric structure depends on the monomer units that make up the polymer material and the method of polymerization. Accordingly, certain properties of the polymers, such as rigidity, can be tuned by selecting monomer units that are capable of forming polymeric strands that crosslink, i.e., form covalent bonds with other polymeric strands.

The rigidity of the polymer materials can also be tuned by modifying polymer chain length. In particular, longer polymeric chain lengths result in more rigid materials. The chain length can be tuned using techniques known to those skilled in the art. For example, the presence of capping units (i.e., compounds that will terminate the growth of the polymer chain) during the polymerization of monomer units results in shorter chain lengths. Accordingly, increasing the concentration of capping units in the mixture will result in a polymer material characterized by shorter chain lengths than those formed in the presence of little to no capping units.

In some embodiments, the monomers comprise fatty acids characterized by 0 reactive sites (e.g., hydroxyl or amino groups) (FA), 1 reactive site (MFA), and more than 1 reactive sites (e.g., 2, 3, 4, or 5 hydroxy or amino groups) (PFA). In certain such embodiments, the FA serves as a capping unit, MFA serves as a monomer that forms a linear polymer (i.e., cannot crosslink), and PFA serves as a monomer with one or more crosslinking sites. Accordingly, the properties of the resulting polymer can be tuned by modifying the ratio of FA to MFA to PFA. Specifically, monomer compositions favoring PFAs will form polymers with a higher degree of crosslinked sites than monomer compositions favoring MFAs. Thus, the former compositions form more rigid polymer networks than the latter.

Other properties of the material and compositions of this disclosure can also be tuned based on the selection of monomeric units. For example, monomers characterized by hydrophobic side chains (i.e., aliphatic groups), will result in polymeric materials with hydrophobic properties. By contrast, monomers characterized by polar or charged functional groups (e.g., alkoxides) will form materials with hydrophilic properties. Accordingly, in some embodiments, the polymers are hydrophobic, hydrophilic, lipophilic, lipophobic, omniphobic, gas impermeable, grease impermeable, oil impermeable, water impermeable, gas resistant, grease resistant, oil resistant, water resistant, or any combination thereof.

In some embodiments, the compositions, coatings, and/or materials comprise one or more fatty acid derivatives. In some embodiments, the one or more fatty acid derivatives comprise one or more fatty acids, fatty acid esters, or a combination thereof. In some embodiments, the one or more fatty acid derivatives comprise one or more fatty acid salts. In some embodiments, the one or more fatty acid derivatives comprise two or more fatty acids, fatty acid esters, or a combination thereof. In some embodiments, the one or more fatty acid derivatives comprise two or more fatty acid salts. In some embodiments, the one or more fatty acid derivatives comprise one or more fatty acids, fatty acid esters, or a combination thereof and one or more fatty acid salts. In some embodiments, the one or more fatty acid derivatives comprise two or more fatty acids, fatty acid esters, or a combination thereof and two or more fatty acid salts. In some embodiments, the one or more fatty acid derivatives comprise one fatty acid or ester thereof and one fatty acid salt. In some embodiments, the one or more fatty acid derivatives comprise one fatty acid thereof and one fatty acid salt. In some embodiments, the one or more fatty acid derivatives comprise one fatty acid ester and one fatty acid salt. In some embodiments, the one or more fatty acid derivatives comprise two fatty acids, fatty acid esters, or a combination thereof and two fatty acid salts. In some embodiments, the one or more fatty acid derivatives comprise two fatty acid esters and two fatty acid salts. In some embodiments, the one or more fatty acid derivatives comprise two fatty acid esters and one fatty acid salt. In some embodiments, the one or more fatty acid derivatives comprise one fatty acid ester, one fatty acid, and one fatty acid salts. In some embodiments, the one or more fatty acid derivatives comprise one fatty acid ester and one fatty acid salt.

In some embodiments, the one or more fatty acids, fatty acid esters, or a combination thereof comprise one or more fatty acid esters. In some embodiments, the one or more fatty acid esters is one fatty acid ester. In some embodiments, the one or more fatty acid esters is two fatty acid esters. In some embodiments, the one or more fatty acid esters is three or more fatty acid esters.

In some embodiments, the one or more fatty acid salts is one fatty acid salt. In some embodiments, the one or more fatty acid salts is two fatty acid salts. In some embodiments, the one or more fatty acid salts is three or more fatty acid salts.

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride). In some embodiments, the one or more fatty acids, fatty acid esters, or a combination thereof comprise three or more monoglycerides.

In some embodiments, the compositions, coating agents, and/or materials comprise about 40% to 100% by weight of the one or more fatty acids, fatty acid esters, or a combination thereof. For example, the composition comprises about 60% to 80%, 70% to 95%, or 85% to 99%, by weight of the one or more fatty acids, fatty acid esters, or a combination thereof.

In some embodiments, the compositions, coating agents, and/or materials comprise about 1% to 50% by weight of the one or more fatty acid salts. In some embodiments, when the composition comprises two fatty acid salts, weight ratio of the two fatty acid salts is about 1:20 to 20:1. For example, about 1:10 to 10:1, or 1:10 to 2:1.

In some embodiments, the compositions, coating agents, and/or materials comprise about 70% to 99% by weight of the one or more fatty acids, fatty acid esters, or a combination thereof, and about 1% to 30% by weight of the one or more fatty acid salts. In some embodiments, the composition (e.g., coating or coating agent) comprises about 70% to 99% by weight of one fatty acid ester, and about 1% to 30% by weight of one fatty acid salt. In some embodiments, the composition (e.g., coating or coating agent) comprises about 70% to 99% by weight of two fatty acid esters, and about 1% to 30% by weight of one fatty acid salt. In some embodiments, the compositions, coating agents, and/or materials comprise about 70% to 99% by weight of one fatty acid ester; and about 1% to 30% by weight of two fatty acid salts. In some embodiments, the compositions, coating agents, and/or materials comprise about 70% to 99% by weight of two fatty acid esters; and about 1% to 30% by weight of two fatty acid salts. In some embodiments, the composition (e.g., coating or coating agent) comprises about 70% to 99% by weight of three or more fatty acid esters, and about 1% to 30% by weight of three or more fatty acid salts. In some embodiments, the compositions, coating agents, and/or materials comprise one fatty acid ester and one fatty acid salt in a weight ratio of about 70:30 to 95:5. In some embodiments, the compositions, coating agents, and/or materials comprise two fatty acid esters and one fatty acid salt in a weight ratio of about 70:30 to 95:5. In some embodiments, the compositions, coating agents, and/or materials comprise one fatty acid ester and two fatty acid salts in a weight ratio of about 70:30 to 95:5. In some embodiments, the compositions, coating agents, and/or materials comprise two fatty acid esters and two fatty acid salts in a weight ratio of about 70:30 to 95:5. In some embodiments, the compositions, coating agents, and/or materials comprise three or more fatty acid esters and three or more fatty acid salts in a weight ratio of about 70:30 to 95:5.

In some embodiments, each fatty acid and/or ester thereof is an independently selected compound of Formula IA:

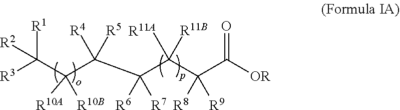

or a salt thereof when R is C₁-C₆ alkyl optionally substituted with one or more of OH and C₁-C₆ alkoxy,

wherein:

R is selected from the group consisting of H and C₁-C₆ alkyl optionally substituted with one or more of OH and C₁-C₆ alkoxy;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

the sum of o and p is from 0 to 17.

In some embodiments, R is H. When R is H, Formula IA is referred to as Formula IA-B.

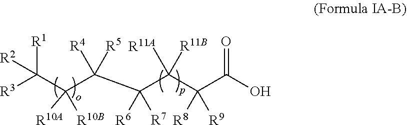

In some embodiments, R is C₁-C₆ alkyl optionally substituted with one or more OH or C₁-C₆ alkoxy. In some embodiments, R is C₁-C₆ alkyl optionally substituted with one or more OH. In some embodiments, R is C₁-C₆ alkyl optionally substituted with two OH. In some embodiments, R is C₁-C₃ alkyl optionally substituted with one or more OH. In some embodiments, R is C₁-C₃ alkyl optionally substituted with two OH. In some embodiments, R is propyl optionally substituted with one or more OH. In some embodiments, R is propyl optionally substituted with two OH. In some embodiments, R is 1,3-dihydroxy-2-propyl. In some embodiments, R is 1,2-dihydroxy-1-propyl.

In some embodiments, R is C₁-C₆ alkyl optionally substituted with one or more C₁-C₆ alkoxy. In some embodiments, R is C₁-C₆ alkyl optionally substituted with two C₁-C₆ alkoxy. In some embodiments, R is C₁-C₃ alkyl optionally substituted with one or more C₁-C₆ alkoxy. In some embodiments, R is C₁-C₃ alkyl optionally substituted with two C₁-C₆ alkoxy.

In some embodiments, the compound of Formula IA is a compound of Formula IA-A-i:

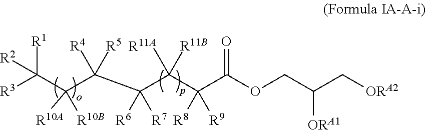

or a salt thereof,

wherein:

R^{A1} and R^{A2} are independently selected from H and C₁-C₆ alkyl;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

the sum of o and p is from 0 to 17.

In some embodiments, R^{A1} is H and R^{A2} is C₁-C₆ alkyl. In some embodiments, R^{A1} is C₁-C₆ alkyl and R^{A2} is H. In some embodiments, R^{A1} and R^{A2} are H.

In some embodiments, the compound of Formula IA is a compound of Formula IA-A-ii:

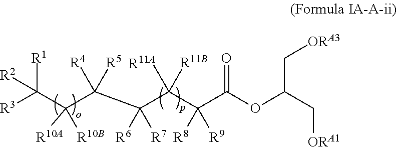

or a salt thereof,

wherein:

R^{A1} and R^{A3} are independently selected from H and C₁-C₆ alkyl;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

the sum of o and p is from 0 to 17.

In some embodiments, R^{A1} is H and R^{A3} is C₁-C₆ alkyl. In some embodiments, R^{A1} is C₁-C₆ alkyl and R^{A3} is H. In some embodiments, R^{A1} and R^{A3} are H. In some embodiments, R^{A1} and R^{A3} are C₁-C₆ alkyl.

In some embodiments, each fatty acid salt is an independently selected compound of Formula IIA:

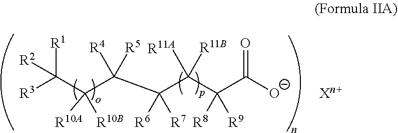

wherein:

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;

o is an integer from 0 to 17;

p is an integer from 0 to 17;

the sum of o and p is from 0 to 17; and

Xⁿ⁺ is a cationic moiety having formal charge n.

In some embodiments, Xⁿ⁺ is selected from Na⁺, K⁺, Ag⁺, Ca²⁺, Mg²⁺, Zn²⁺, Cu²⁺, and (R′)₄N⁺, where each occurrence of R′ is selected from H and C₁-C₆ alkyl.

In some embodiments, each R′ is an independently selected C₁-C₆ alkyl. In some embodiments, one R′ is H and the other three R′ are independently selected C₁-C₆ alkyl. In some embodiments, two R′ are H and the other two R′ are independently selected C₁-C₆ alkyl. In some embodiments, three R′ are H and the other R′ is C₁-C₆ alkyl. In some embodiments, each R′ is H.

In some embodiments, Xⁿ⁺ is selected from Na⁺, K⁺, Ag⁺, Ca²⁺, Mg²⁺, and Zn²⁺. In some embodiments, Xⁿ⁺ is selected from Na⁺, K⁺, Ca²⁺, Mg²⁺, and Zn²⁺. In some embodiments, Xⁿ⁺ is Na⁺. In some embodiments, Xⁿ⁺ is K⁺. In some embodiments, Xⁿ⁺ is Ca²⁺. In some embodiments, X¹ is Mg²⁺. In some embodiments, Xⁿ⁺ is Zn²⁺.

In some embodiments, R¹, R², R³, R⁴, R⁵, R⁶, R⁷, R⁸, and R⁹ are independently selected from the group consisting of: H, OH, C₁-C₆ alkyl, and C₁-C₆ alkoxy. In some embodiments, R¹, R², R³, R⁴, R⁵, R⁶, R⁷, R⁸, and R⁹ are independently selected from the group consisting of: H, OH, and C₁-C₆ alkyl. In some embodiments, R¹, R², R³, R⁴, R⁵, R⁶, R⁷, R⁸, and R⁹ are independently selected from the group consisting of: H and OH. In some embodiments, R¹, R², R³, R⁴, R⁵, R⁶, R⁷, R⁸, and R⁹ are each H. In some embodiments, one of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H. In some embodiments, two of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H.

In some embodiments, R⁴ is OH. In some embodiments, R⁵ is OH. In some embodiments, R⁶ is OH. In some embodiments, R⁷ is OH.

In some embodiments, each occurrence of R^{10A}, R^{10B}, R^{11A}, and R^{11B} is independently selected from the group consisting of: H, OH, C₁-C₆ alkyl, and C₁-C₆ alkoxy. In some embodiments, each occurrence of R^{10A}, R^{10B}, R^{11A}, and R^{11B} is independently selected from the group consisting of: H, OH, and C₁-C₆ alkyl. In some embodiments, each occurrence of R^{10A}, R^{10B}, R^{11A}, and R^{11B} is independently selected from the group consisting of: H and OH. In some embodiments, each occurrence of R^{10A}, R^{10B}, R^{11A}, and R^{11B} is each H. In some embodiments, one of each occurrence of R^{10A}, R^{10B}, R^{11A}, and R^{11B} is OH and the remaining occurrences of R^{10A}, R^{10B}, R^{11A}, and R^{11B} are each H. In some embodiments, two of each occurrence of R^{10A}, R^{10B}, R^{11A}, and R^{11B} is OH and the remaining occurrences of R^{10A}, R^{10B}, R^{11A}, and R^{11B} are each H.

In some embodiments, any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form a double bond. In some embodiments, any two pairs of R¹, R², R³, R⁴, R⁵, R⁶, R⁷, R⁸, R⁹, R^{10A}, R^{10B}, R^{11A}, and R^{11B} on adjacent carbon atoms are each taken together with the carbon atoms to which they are attached to form two double bonds. In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form a double bond, and any two remaining R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, the 3- to 6-membered ring heterocycle is oxiranyl.

In some embodiments, R⁴ is taken together with R⁶ and the carbon atoms to which they are attached to form a double bond. In some embodiments, R⁴ is taken together with R⁶ and the carbon atoms to which they are attached to form a 3- to 6-membered ring heterocycle.

In some embodiments, one of R¹, R², R³, R⁴, R⁵, R⁶, R⁷, R⁸, R⁹, and each occurrence of R^{10A}, R^{10B}, R^{11A}, and R^{11B} is OH; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form an oxiranyl; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form an oxiranyl.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A} and R^{11B} on adjacent carbon atoms are taken together with the carbon atoms to which they are attached to form a double bond.

In some embodiments, the sum of o and p is from 0 to 13. In some embodiments, the sum of o and p is from 1 to 9. In some embodiments, the sum of o and p is from 0 to 13. In some embodiments, the sum of o and p is from 5 to 7. In some embodiments, the sum of o and p is from 10 to 13. In some embodiments, the sum of o and p is from 11 to 13. Without wishing to be bound by theory, it is believed that compounds of Formula IA wherein the sum of o and p is 0 to 9 are able to function as wetting agents when included in the compositions (e.g., mixtures, coatings, and coating agents) described herein, thus increasing the aptitude of the compositions, coating agents, and/or materials to spread over the surface of the fibers to form a coating of substantially uniform thickness.

In some embodiments, the compound of Formula IA is selected from the group consisting of the following compounds. In some embodiments, when one of the following compounds has a carboxyl group, the coating agents can include the corresponding fatty acid salt (e.g., compounds of Formula IIA) with a carboxylate and cationic counter ion X, with n carboxylate groups associated Xⁿ⁺, where n represents the charge state of the cationic counter ion. In some embodiments, n is 1, 2, or 3. In some embodiments, X is sodium, potassium, calcium, or magnesium.

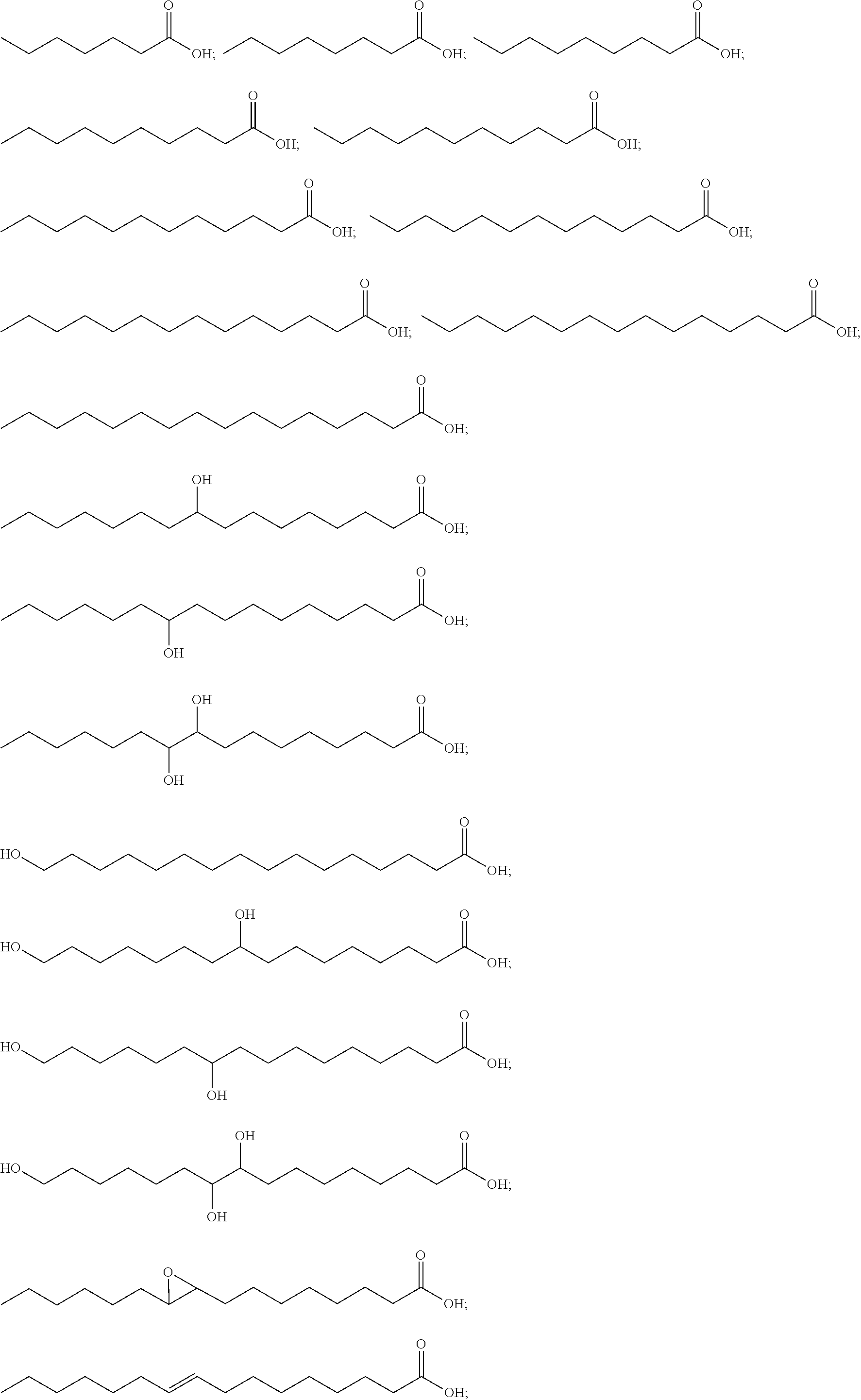

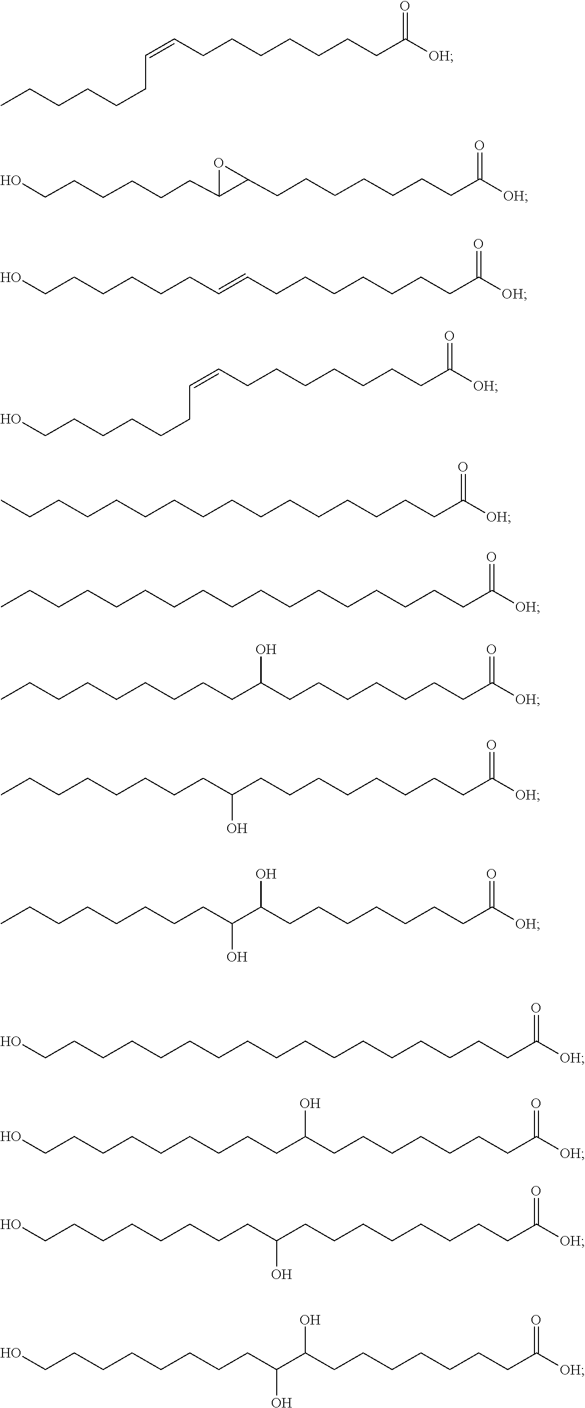

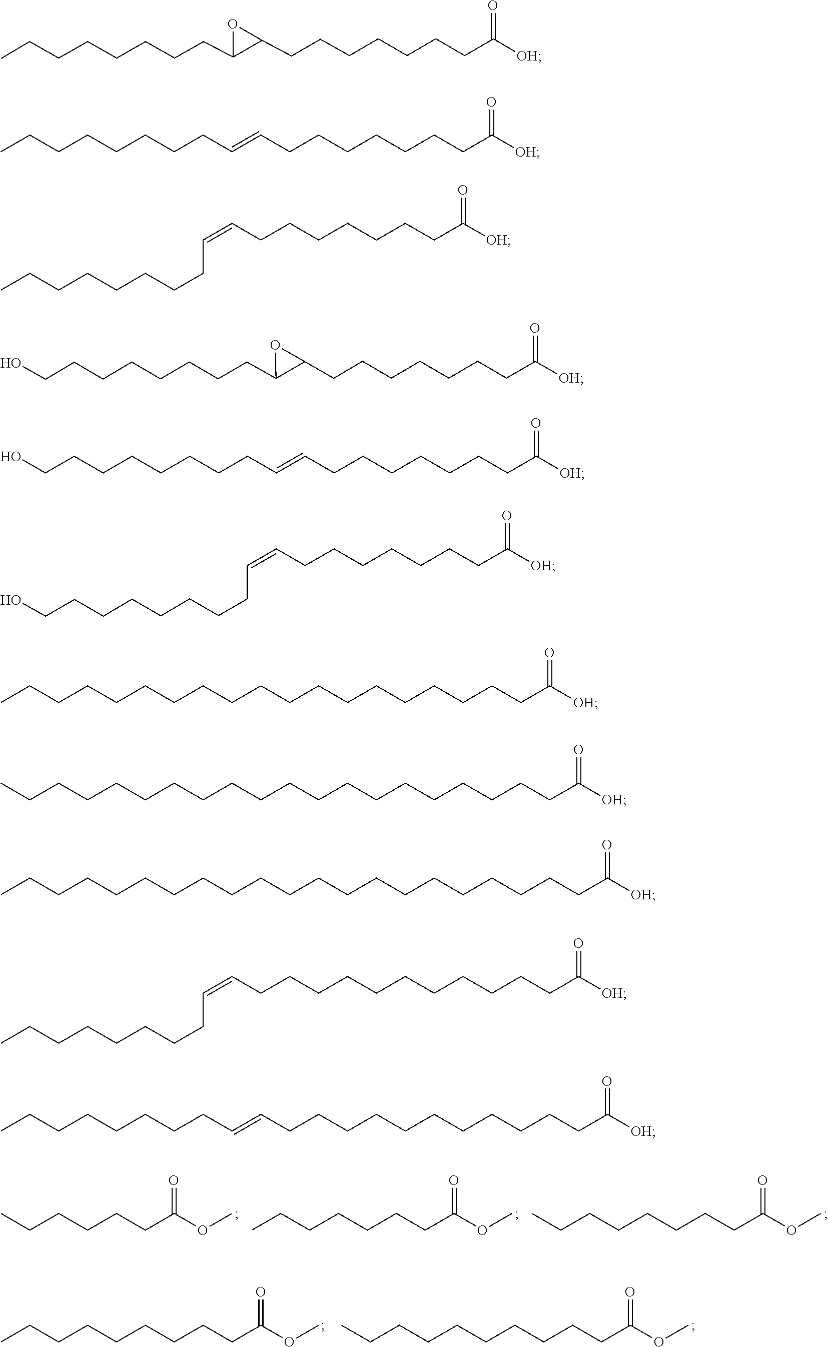

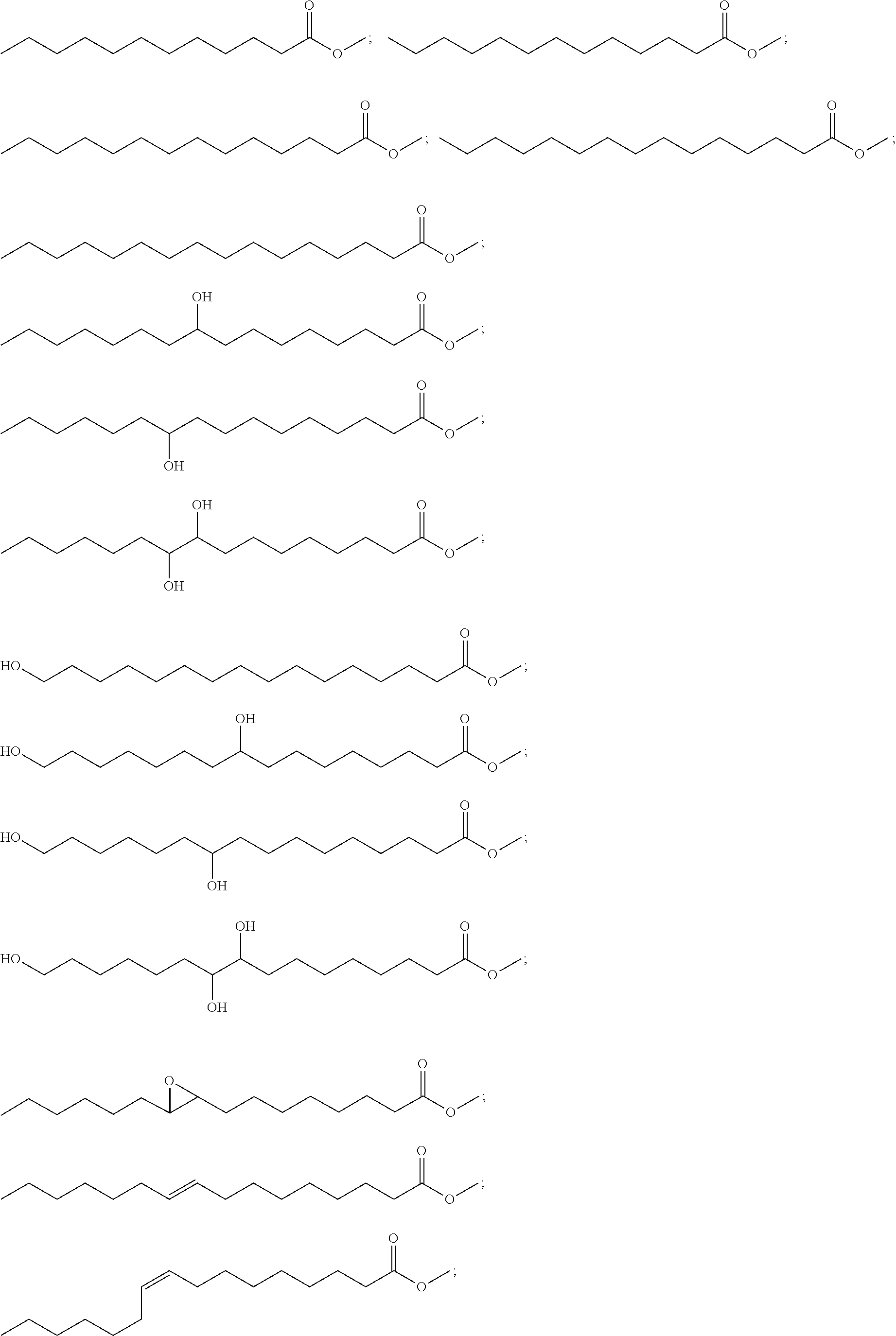

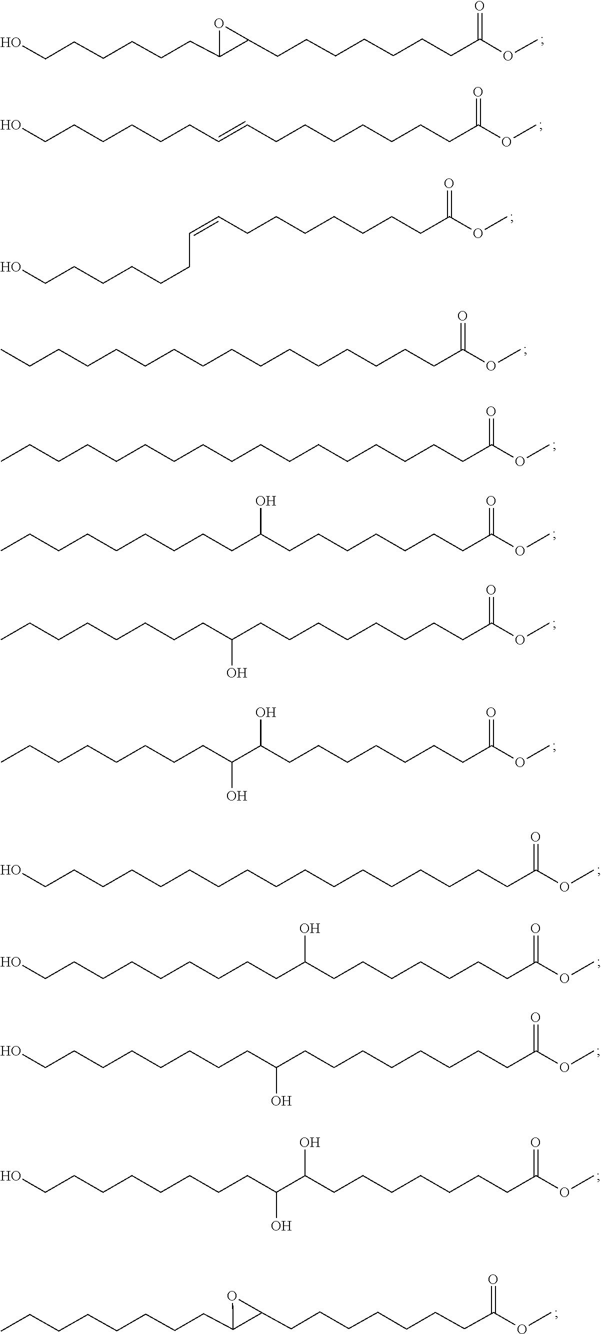

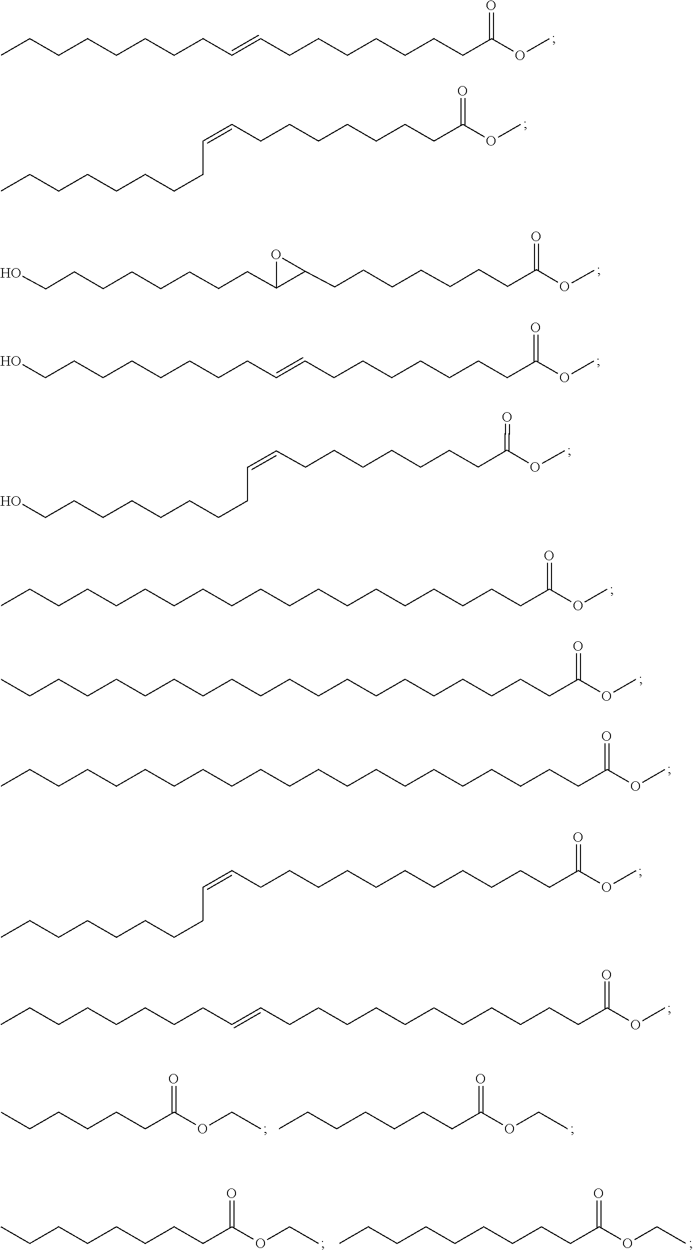

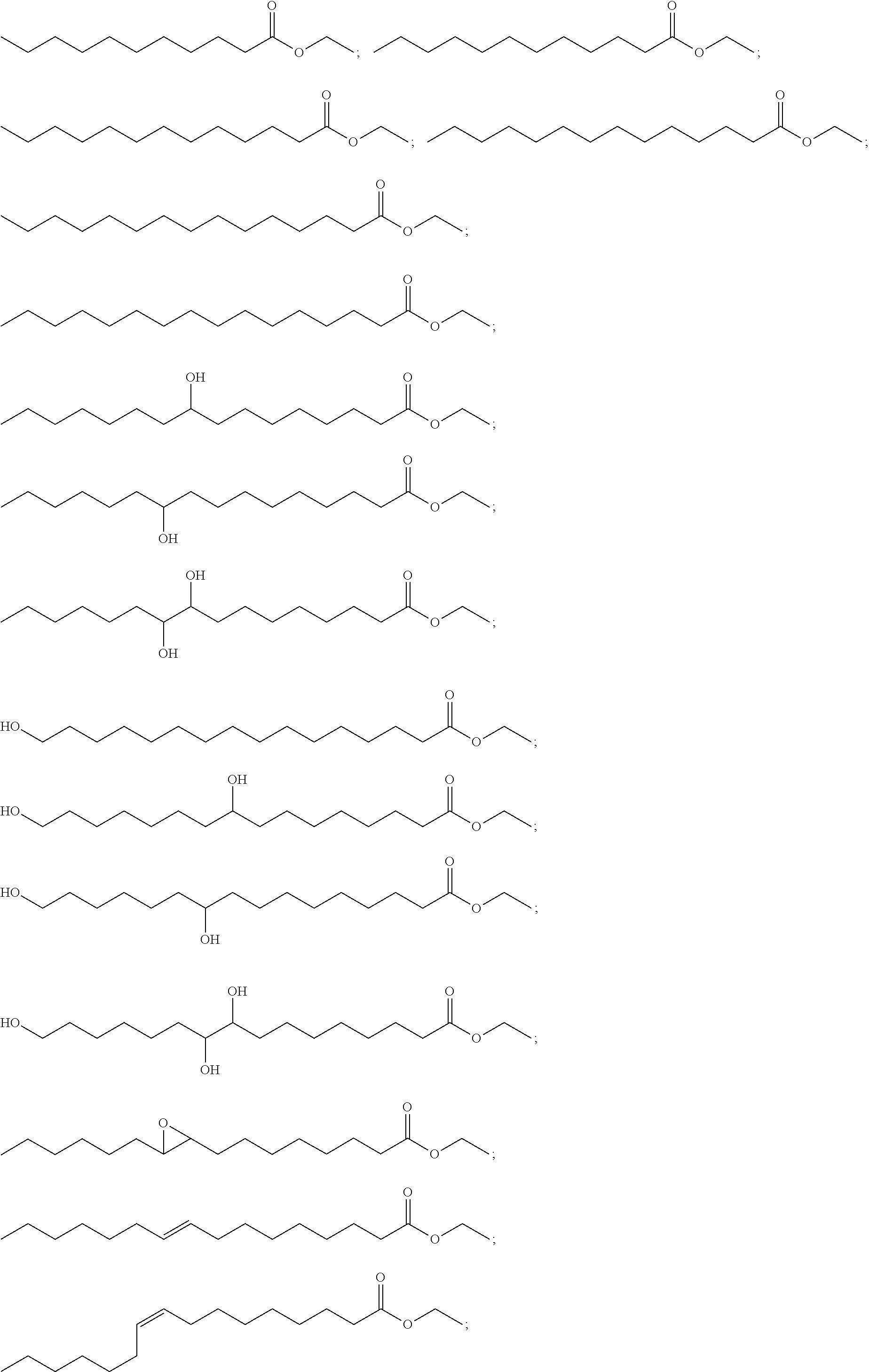

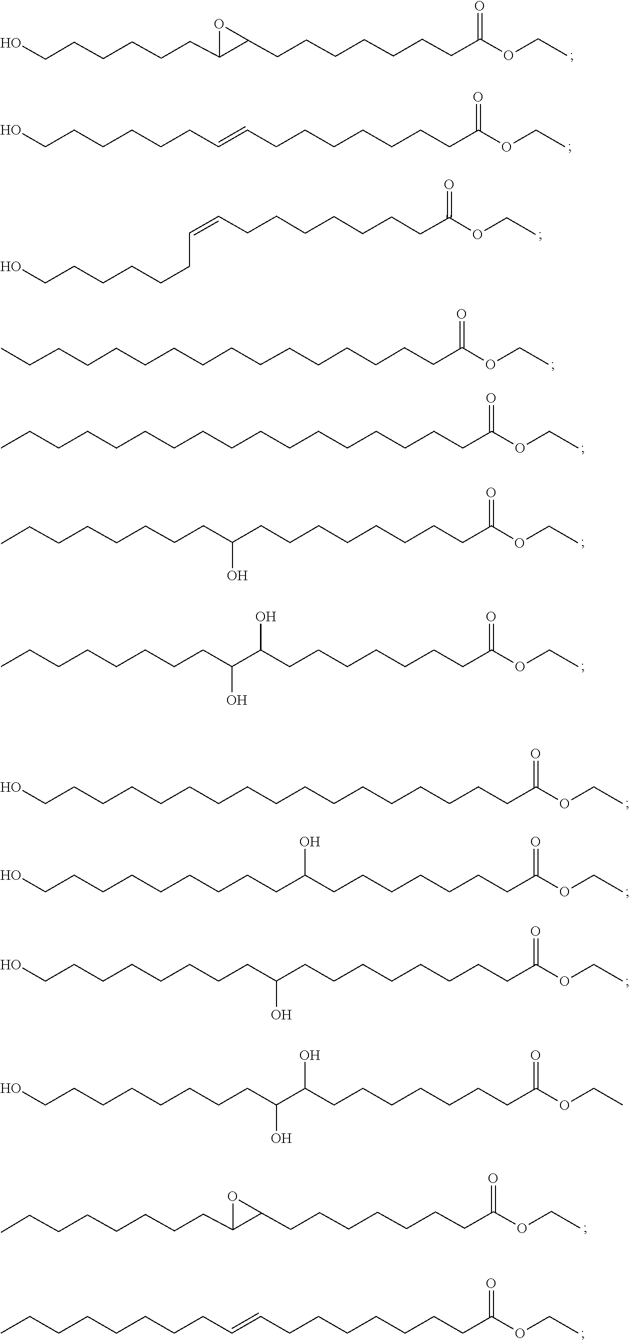

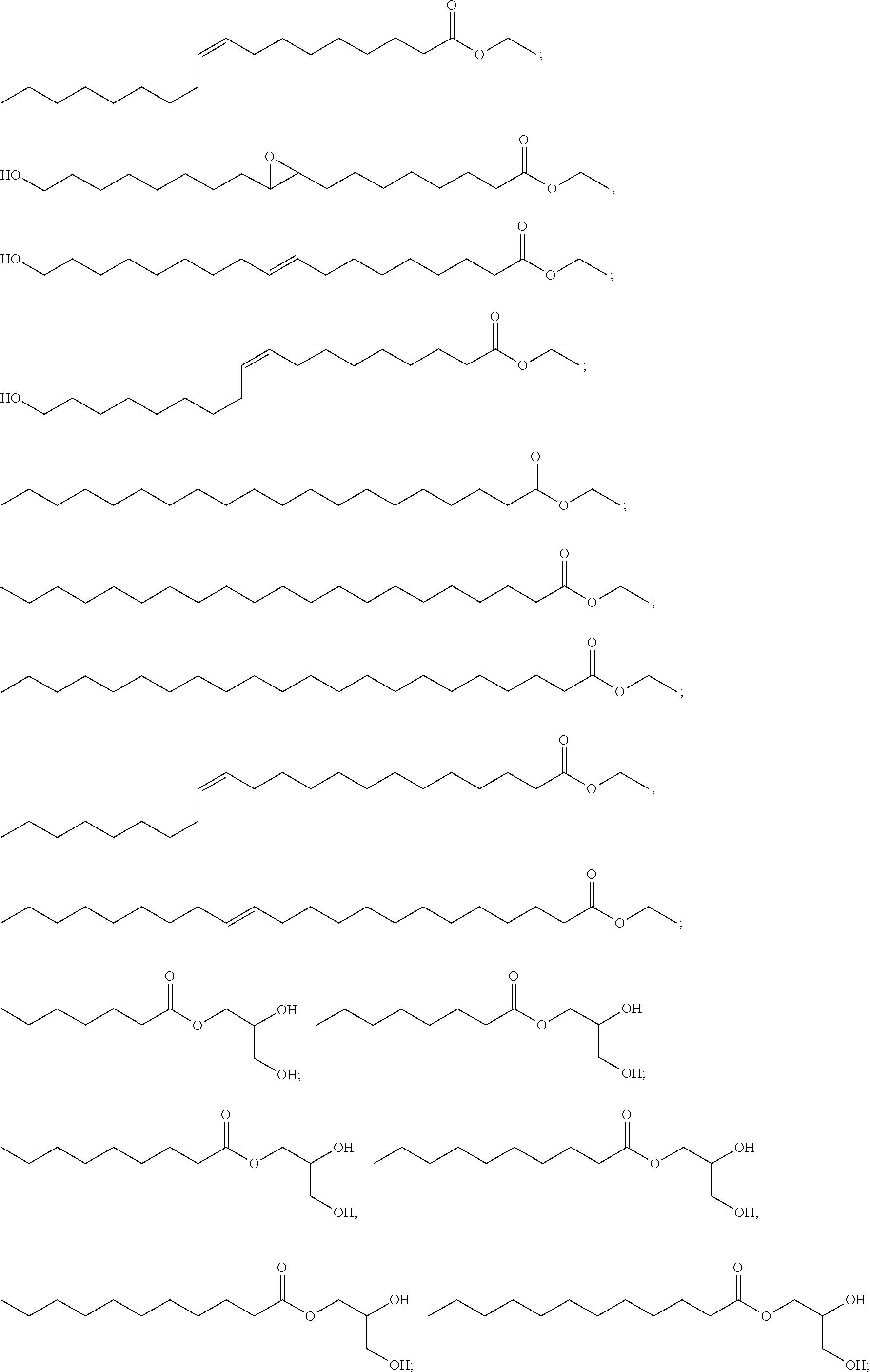

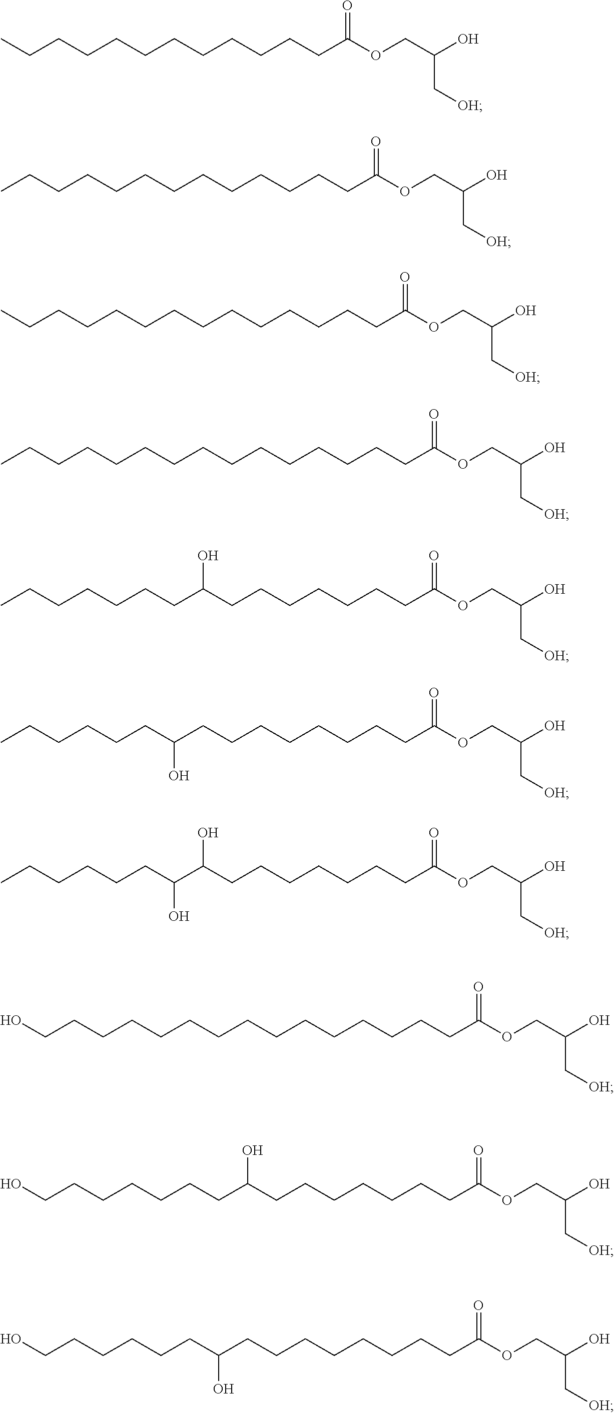

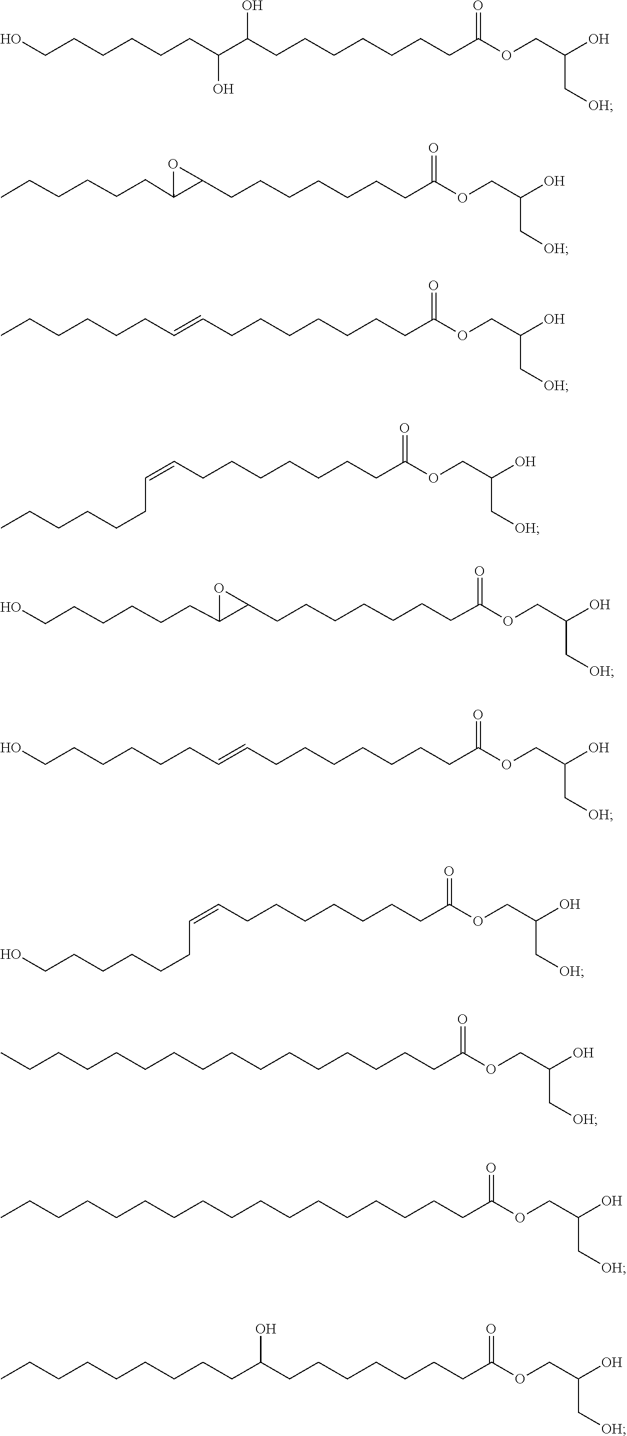

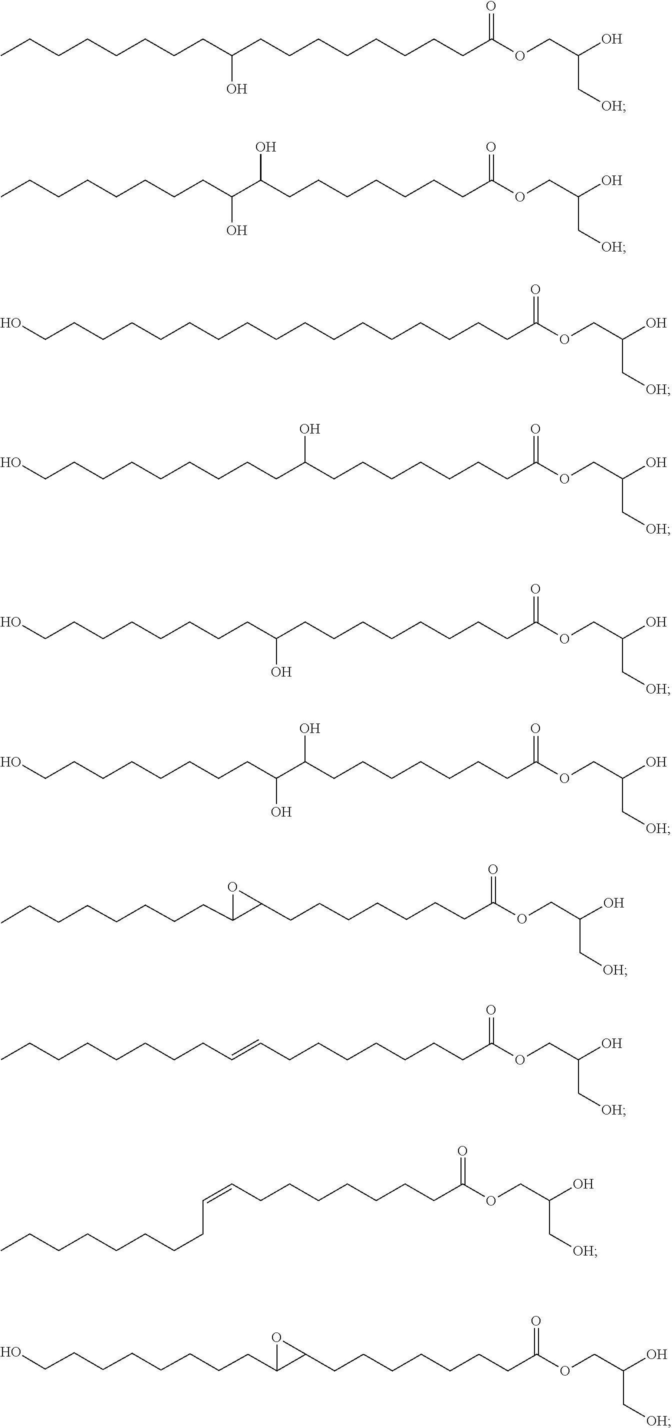

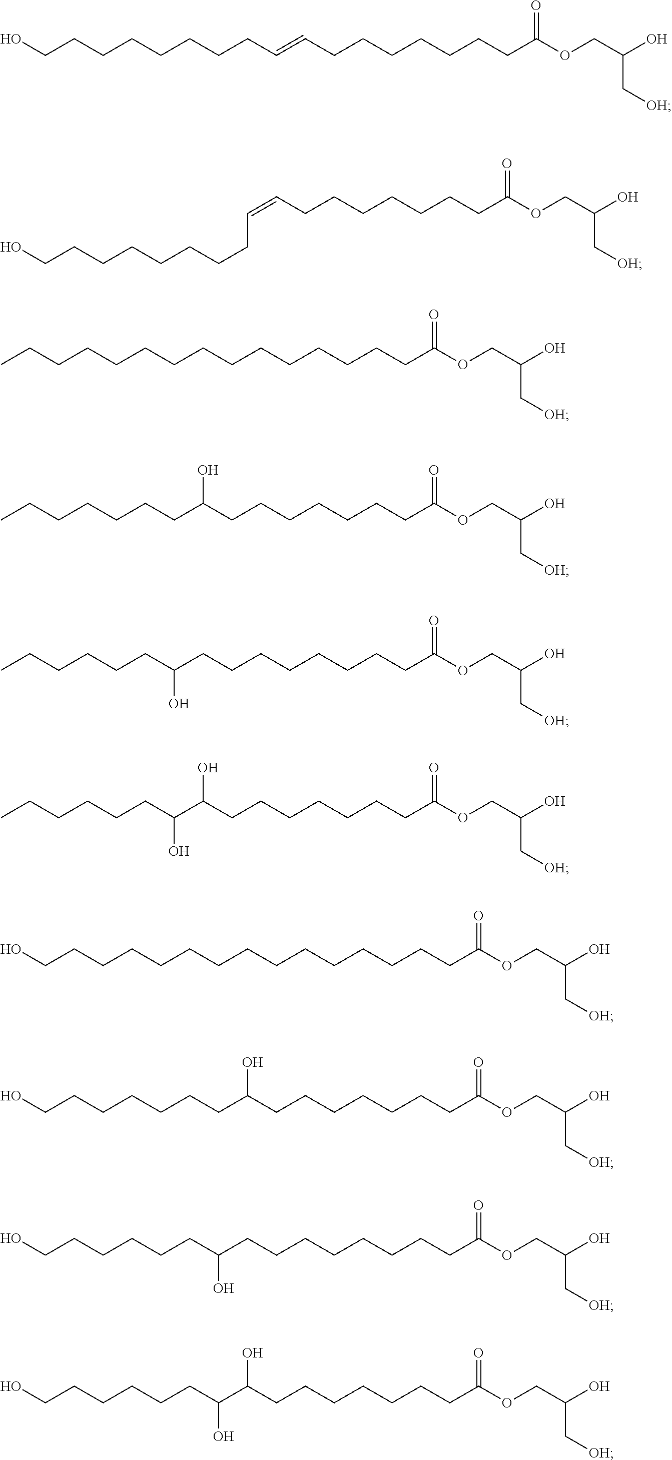

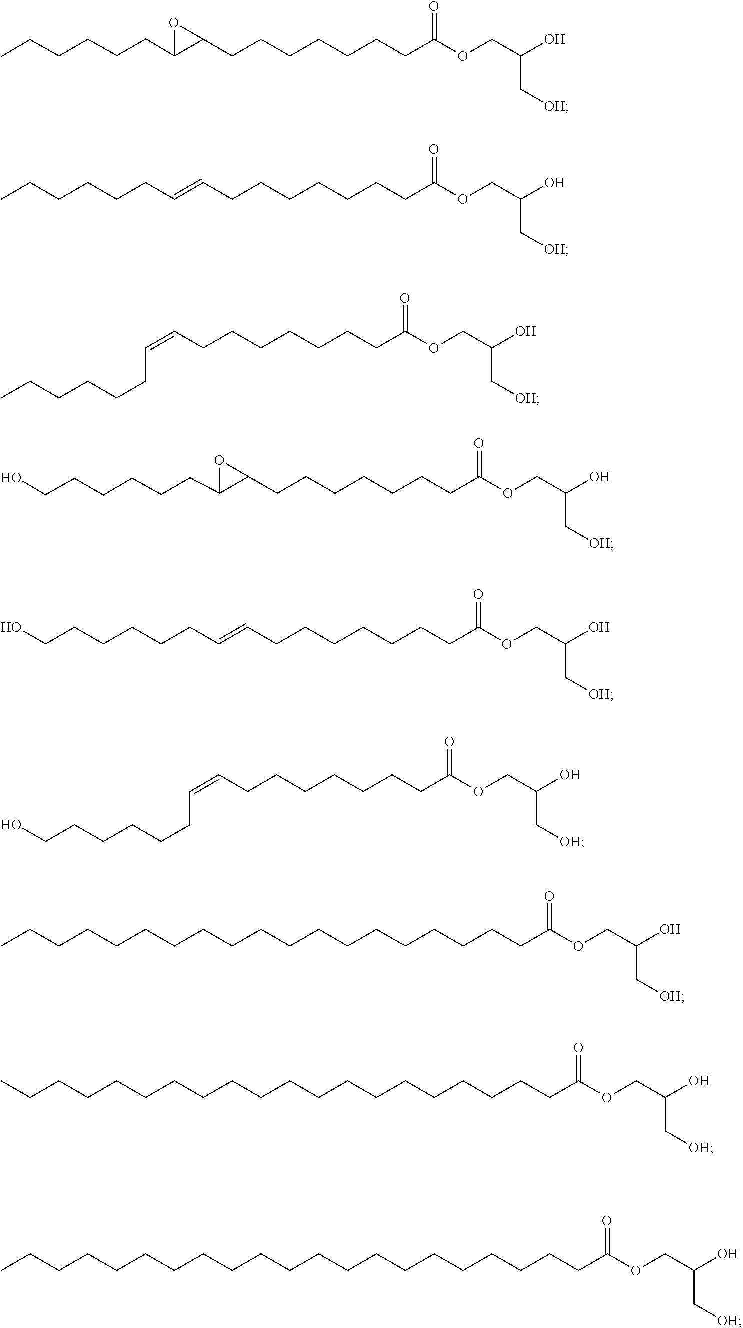

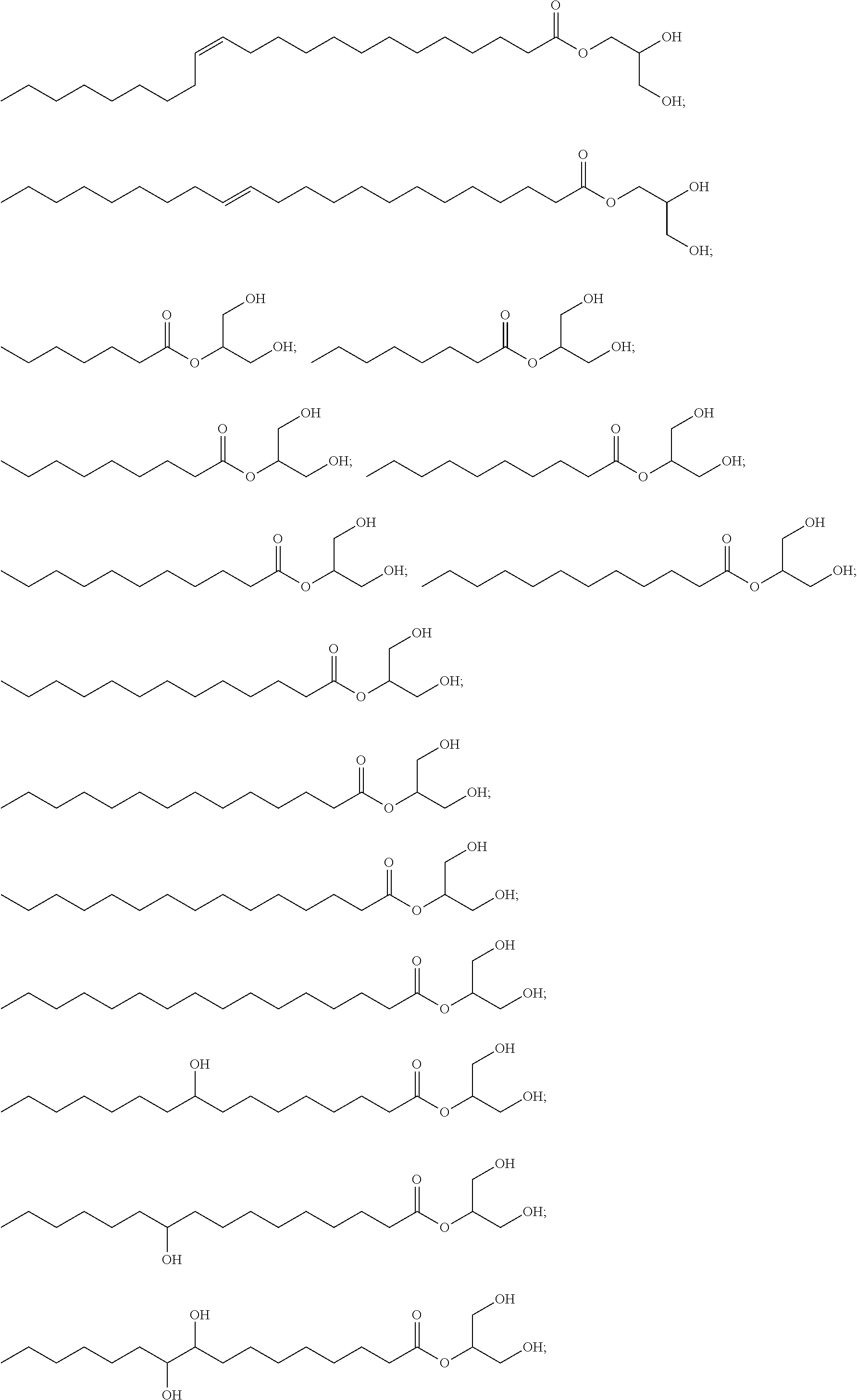

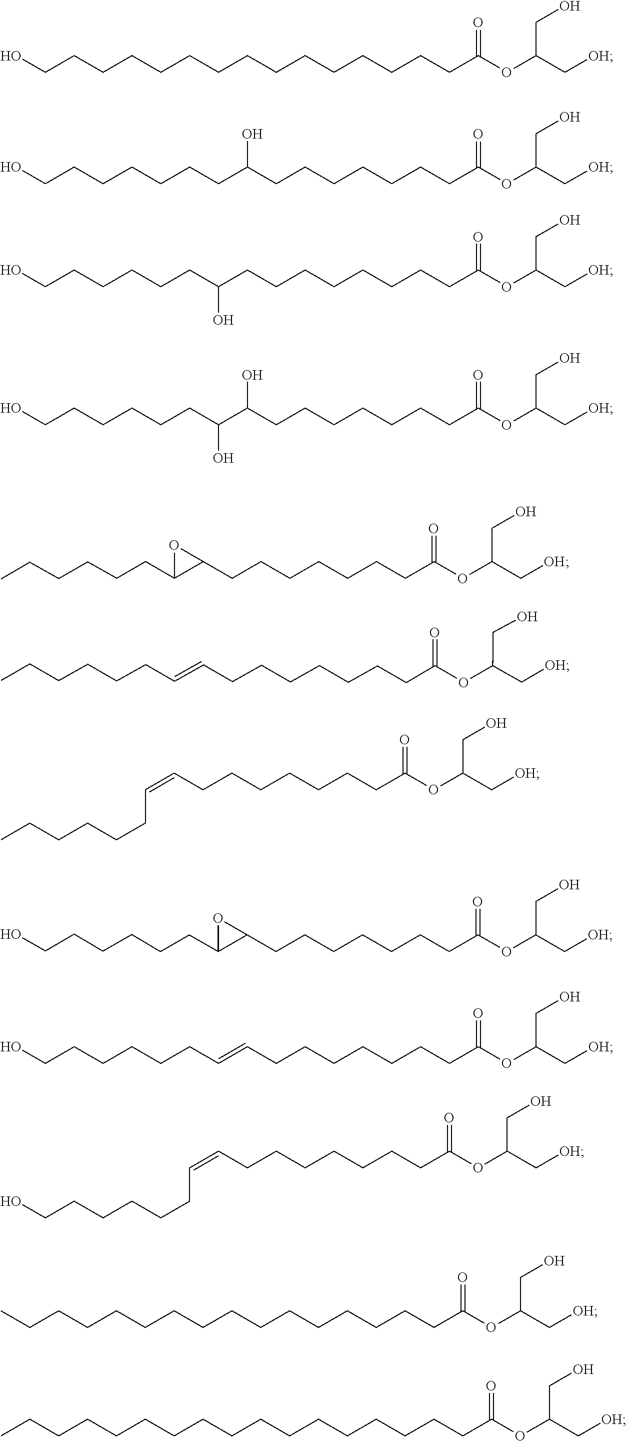

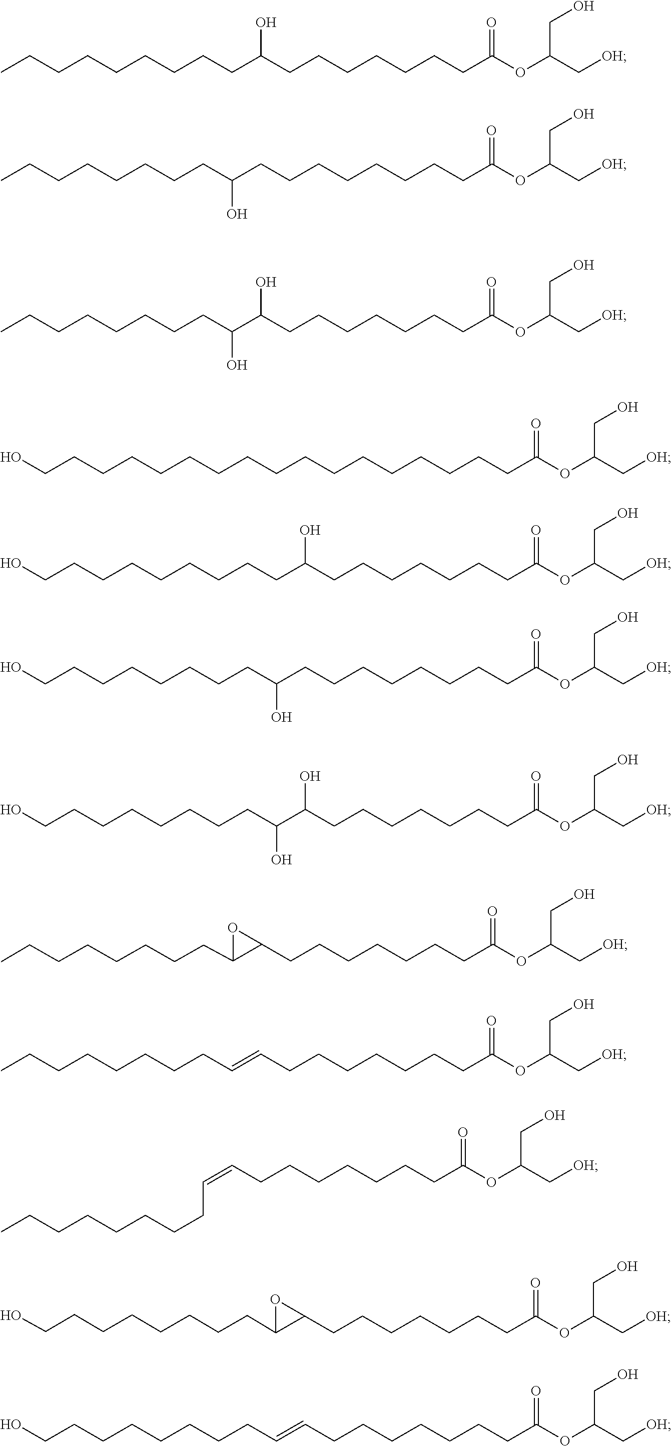

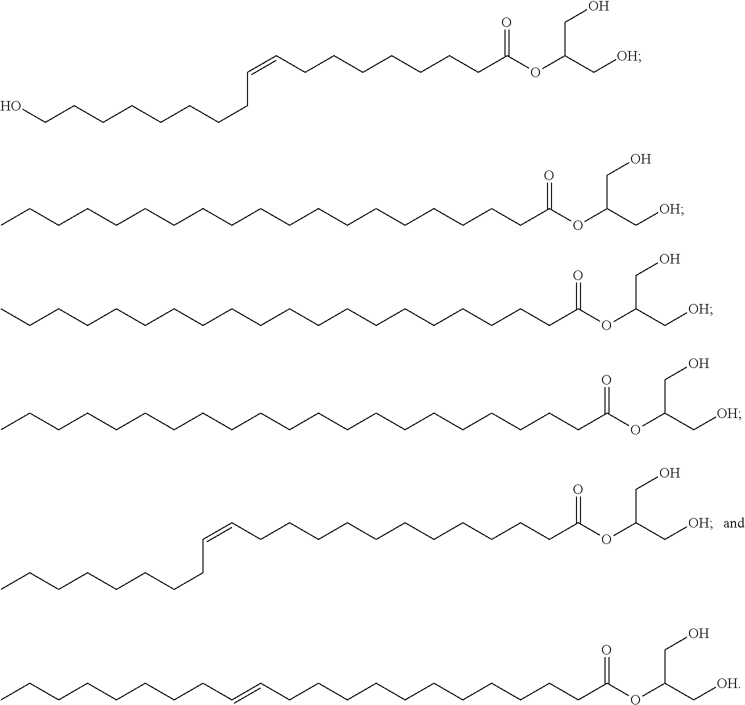

In some embodiments, the compound of Formula IIA is selected from the group consisting of:

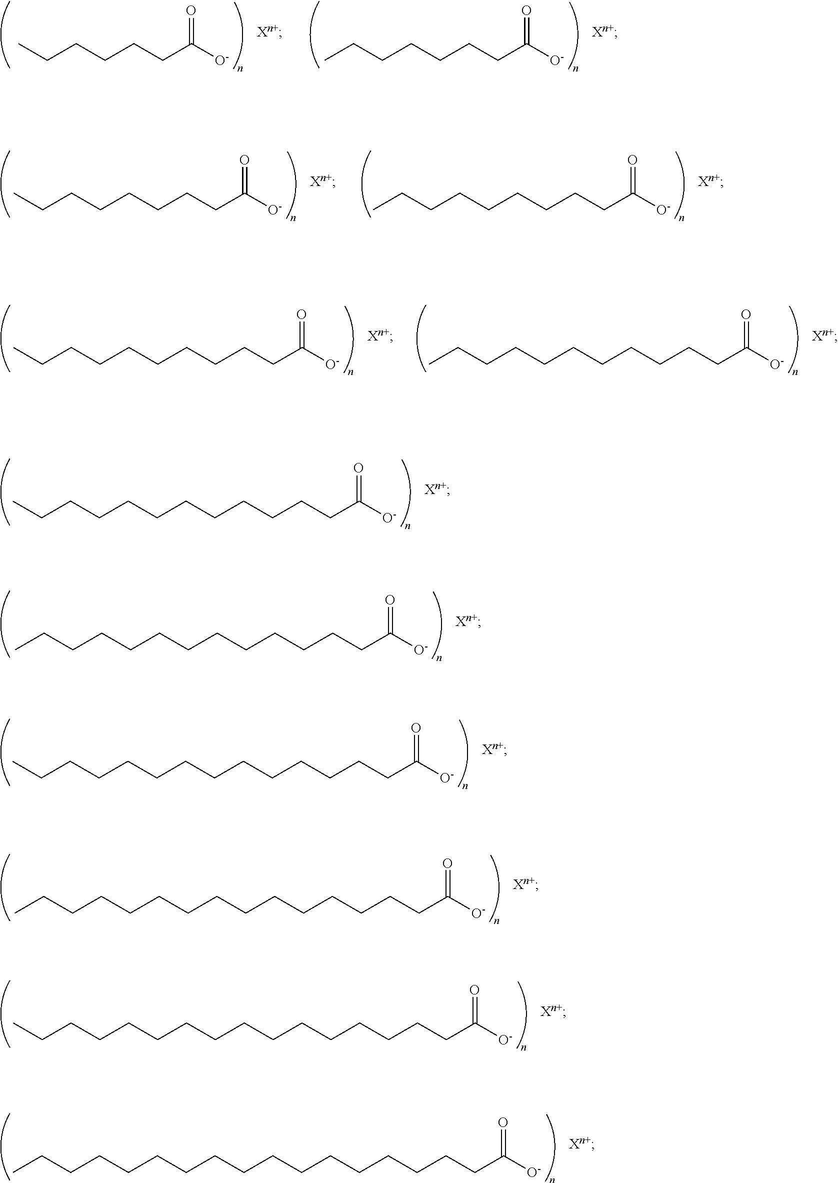

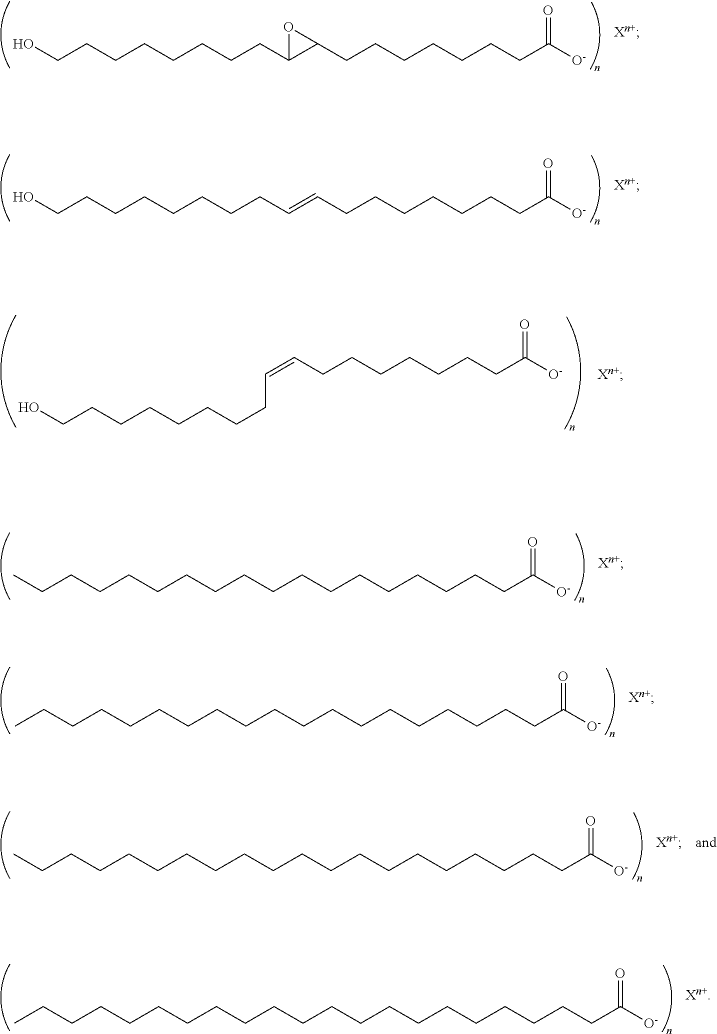

In some embodiments, the compositions, coating agents, and/or materials comprise one or more (e.g., 1, 2, or 3) compounds of Formula IA. In some embodiments, the compositions, coating agents, and/or materials comprise one or more (e.g., 1, 2, or 3) compounds of Formula IA-A-i. In some embodiments, the compositions, coating agents, and/or materials comprise one or more (e.g., 1, 2, or 3) compounds of Formula IA-A-ii. In some embodiments, the compositions, coating agents, and/or materials comprise one or more (e.g., 1, 2, or 3) compounds of Formula IA-B. In some embodiments, the compositions, coating agents, and/or materials comprise one or more (e.g., 1, 2, or 3) compounds of Formula IIA.

In some embodiments, each compound of Formula IA is independently selected from a compound of Formula IA-A-i and a compound of Formula IA-A-ii. In some embodiments, each compound of Formula IA is a compound of Formula IA-A-i. In some embodiments, each compound of Formula IA is a compound of Formula IA-A-ii. In some embodiments, at least one (e.g., 1 or 2) compounds of Formula IA is a compound of Formula IA-A-i and at least one (e.g., 1 or 2) compounds of Formula IA is a compound of Formula IA-A-ii.

In some embodiments, the compositions, coating agents, and/or materials comprise one compound of Formula IA and one compound of Formula IA-B. In some embodiments, the compositions, coating agents, and/or materials comprise one compound of Formula IA-A-i and one compound of Formula IA-B. In some embodiments, the compositions, coating agents, and/or materials comprise one compound of Formula IA-A-ii and one compound of Formula IA-B. In some embodiments, the compositions, coating agents, and/or materials comprise one compound of Formula IA-A-i, one compound of Formula IA-A-ii, and one compound of Formula IA-B.

In some embodiments, the compositions, coating agents, and/or materials comprise one compound of Formula IA-A-i and one compound of Formula IA-A-ii. In some embodiments, the compositions, coating agents, and/or materials comprise two compounds of Formula IA-A-i. In some embodiments, the compositions, coating agents, and/or materials comprise two compounds of Formula IA-A-ii.

In some embodiments, the compositions, coating agents, and/or materials comprise one or more (e.g., 1, 2, or 3) compounds of Formula IA and one or more (e.g., 1, 2, or 3) compounds of Formula IIA. In some embodiments, the compositions, coating agents, and/or materials comprise one compound of Formula IA and one compound of Formula IIA. In some embodiments, the compositions, coating agents, and/or materials comprise two compounds of Formula IA and one compound of Formula IIA. In some embodiments, the compositions, coating agents, and/or materials comprise one compound of Formula IA and two compounds of Formula IIA. In some embodiments, the compositions, coating agents, and/or materials comprise two compounds of Formula IA and two compounds of Formula IIA.

In some embodiments, the compositions, coating agents, and/or materials comprise one or more (e.g., 1, 2, or 3) compounds of Formula IA and one or more (e.g., 1, 2, or 3) compounds of Formula IIA. In some embodiments, the compositions, coating agents, and/or materials comprise one compound of Formula IA and one compound of Formula IIA. In some embodiments, the compositions, coating agents, and/or materials comprise comprises two compounds of Formula IA and one compound of Formula IIA. In some embodiments, the compositions, coating agents, and/or materials comprise one compound of Formula IA and two compounds of Formula IIA. In some embodiments, the compositions, coating agents, and/or materials comprise two compounds of Formula IA and two compounds of Formula IIA.

In some embodiments, the compositions, coating agents, and/or materials comprise one or more (e.g., 1, 2, or 3) compounds of Formula IA-A-i and one or more (e.g., 1, 2, or 3) compounds of Formula IIA. In some embodiments, the compositions, coating agents, and/or materials comprise one compound of Formula IA-A-i and one compound of Formula IIA. In some embodiments, the compositions, coating agents, and/or materials comprise two compounds of Formula IA-A-i and one compound of Formula IIA. In some embodiments, the compositions, coating agents, and/or materials comprise one compound of Formula IA-A-i and two compounds of Formula IIA. In some embodiments, the compositions, coating agents, and/or materials comprise two compounds of Formula IA-A-i and two compounds of Formula IIA.

In some embodiments, the compositions, coating agents, and/or materials comprise a first compound of Formula IA-A-i wherein the sum of o and p is from 9 to 17 (e.g., from 11 to 13); a second compound of Formula IA-A-i wherein the sum of o and p is from 0 to 8 (e.g., from 5 to 7); and one compound of Formula IIA. In some embodiments, the compositions, coating agents, and/or materials comprise a first compound of Formula IA-A-i wherein the sum of o and p is from 9 to 17 (e.g., from 11 to 13); a second compound of Formula IA-A-i wherein the sum of o and p is from 0 to 8 (e.g., from 5 to 7); and two compounds of Formula IIA.

In some embodiments, the compositions, coating agents, and/or materials comprise a first compound of Formula IA-A-i wherein the sum of o and p is from 9 to 17 (e.g., from 11 to 13); a second compound of Formula IA-A-i wherein the sum of o and p is from 9 to 17 (e.g., from 11 to 13); and one compound of Formula IIA. In some embodiments, the compositions, coating agents, and/or materials comprise a first compound of Formula IA-A-i wherein the sum of o and p is from 9 to 17 (e.g., from 11 to 13); a second compound of Formula IA-A-i wherein the sum of o and p is from 9 to 17 (e.g., from 11 to 13); and two compounds of Formula IIA.

In some embodiments, the compositions, coating agents, and/or materials comprise one or more (e.g., 1, 2, or 3) compounds of Formula IA-A-ii and one or more (e.g., 1, 2, or 3) compounds of Formula IIA. In some embodiments, the compositions, coating agents, and/or materials comprise one compound of Formula IA-A-ii and one compound of Formula IIA. In some embodiments, the compositions, coating agents, and/or materials comprise two compounds of Formula IA-A-ii and one compound of Formula IIA. In some embodiments, the compositions, coating agents, and/or materials comprise one compound of Formula IA-A-ii and two compounds of Formula IIA. In some embodiments, the compositions, coating agents, and/or materials comprise two compounds of Formula IA-A-ii and two compounds of Formula IIA.

In some embodiments, the compositions, coating agents, and/or materials comprise one or more (e.g., 1, 2, or 3) compounds of Formula IA-A-i, one or more (e.g., 1, 2, or 3) compounds of Formula IA-A-ii, and one or more (e.g., 1, 2, or 3) compounds of Formula IIA. In some embodiments, the compositions, coating agents, and/or materials comprise one compound of Formula IA-A-i, one compound of Formula IA-A-ii, and one compound of Formula IIA. In some embodiments, the compositions, coating agents, and/or materials comprise two compounds of Formula IA-A-i, one compound of Formula IA-A-ii, and one compound of Formula IIA. In some embodiments, the compositions, coating agents, and/or materials comprise one compound of Formula IA-A-i, two compounds of Formula IA-A-ii, and one compound of Formula IIA. In some embodiments, the compositions, coating agents, and/or materials comprise two compounds of Formula IA-A-i, two compounds of Formula IA-A-ii, and one compound of Formula IIA. In some embodiments, the compositions, coating agents, and/or materials comprise one compound of Formula IA-A-i, one compound of Formula IA-A-ii, and two compounds of Formula IIA. In some embodiments, the compositions, coating agents, and/or materials comprise two compounds of Formula IA-A-i, one compound of Formula IA-A-ii, and two compounds of Formula IIA. In some embodiments, the compositions, coating agents, and/or materials comprise one compound of Formula IA-A-i, two compounds of Formula IA-A-ii, and two compounds of Formula IIA. In some embodiments, the compositions, coating agents, and/or materials comprise two compounds of Formula IA-A-i, two compounds of Formula IA-A-ii, and two compounds of Formula IIA.

In some embodiments, when the compositions, coating agents, and/or materials comprise two or more compounds of Formula IA, Formula IA-A-i, Formula IA-A-ii, Formula IA-B, and/or Formula IIA, the weight ratio of the two compounds is about 1:1 to 10:1. For example, about 1:1 to 8:1, 1:1 to 6:1, 1:1 to 4:1, 1:1 to 3:1, 1:1 to 2:1, 2:1 to 4:1, 4:1 to 6:1, 6:1 to 8:1, 8:1 to 10:1, 1:1, 1:2, 1:4, 1:6, 1:8, o 1:10.

In some embodiments, when the compositions, coating agents, and/or materials comprise two or more compounds of Formula IA, Formula IA-A-i, Formula IA-A-ii, Formula IA-B, and/or Formula IIA, the sum of o and p of at least two compounds is different. In some embodiments, when the compositions, coating agents, and/or materials comprise two or more compounds of Formula IA, Formula IA-A-i, Formula IA-A-ii, Formula IA-B, and/or Formula IIA, the sum of o and p of at least two compounds is the same.

In some embodiments, the compositions, coating agents, and/or materials comprise about 40% to 100% by weight of the one or more compounds of Formula IA, Formula IA-A-i, Formula IA-A-ii, and Formula IA-B. For example, the composition comprises about 40% to 60%, 60% to 80%, 80% to 100%, 60% to 100%, 70% to 100%, 40% to 99%, 60% to 99%, 70% to 99%, 80% to 99%, 85% to 99%, 90% to 99%, of the one or more compounds of Formula IA, Formula IA-A-i, Formula IA-A-ii, and Formula IA-B. For example, the composition comprises about 60% to 80%, 70%, 85% to 99% by weight of the one or more compounds of Formula IA, Formula IA-A-i, Formula IA-A-ii, and Formula IA-B.

In some embodiments, when the compositions, coating agents, and/or materials comprise two compounds of Formula IA, Formula IA-A-i, Formula IA-A-ii, and/or Formula IA-B (for example, two compounds of Formula IA-A-i, two compounds of Formula IA-A-ii, or one compound of Formula IA-A-i and one compound of Formula IA-A-ii), each compound is independently about 0.1% to 99% by weight of the composition. For example, one compound is about 20% to 70%, 60% to 99%, 70% to 99%, 80% to 95%, 20% to 40%, 40% to 60%, 20% to 50%, by weight of the composition; and the other compound is 20% to 70%, 60% to 99%, 70% to 99%, 80% to 95% by weight of the composition. In some embodiments, when the compositions, coating agents, and/or materials comprise two compounds of Formula IA, Formula IA-A-i, Formula IA-A-ii, and/or Formula IA-B (for example, two compounds of Formula IA-A-i, two compounds of Formula IA-A-ii, or one compound of Formula IA-A-i and one compound of Formula IA-A-ii), the weight ratio of the two compounds is about 350:1 to 1:10. For example, 330:1 to 50:1, 50:1 to 10:1, 10:1 to 1:1, 1:1 to 8:1, 1:1 to 6:1, 1:1 to 4:1, 1:1 to 3:1, 1:1 to 2:1, 2:1 to 4:1, 4:1 to 6:1, 6:1 to 8:1, 8:1 to 10:1, 10:1 to 2:1, or 3:1 to 1:3.

In some embodiments the compositions, coating agents, and/or materials comprise about 1% to 50% by weight of the one or more compounds of Formula IIA. For example, the compositions, coating agents, and/or materials comprise about 1% to 10%, 10% to 20%, 20% to 30%, 30% to 40%, 40% to 50%, 1% to 40%, 1% to 30%, 1% to 35%, 1% to 20%, 10% to 50%, 20% to 40%, or 15% to 45% by weight of the one or more compounds of Formula IIA. In some embodiments, when the compositions, coating agents, and/or materials comprise two compounds of Formula IIA, the weight ratio of the two compounds is about 1:20 to 20:1. For example, about 1:10 to 10:1, 1:10 to 2:1, 1:4 to 1:2, 1:3 to 3:1, or 1:2 to 2:1.

In some embodiments, when the compositions, coating agents, and/or materials comprise two compounds of Formula IIA, each compound is independently about 1% to 49% by weight of the composition. For example, one compound is about 1% to 10%, 1% to 20%, 10% to 49%, or 20% to 40% by weight of the composition; and the other compound is 1% to 10%, 1% to 20%, 10% to 49%, 20% to 40%, or 7% to 25% by weight of the composition.

In some embodiments, when the compositions, coating agents, and/or materials comprise rises a compound of Formula IA-A-i and a compound of Formula IA-A-ii, the weight of the compound of Formula IA-A-i to the compound of Formula IA-A-ii is about 1:10 to 10:1. For example, 1:10 to about 2:1, 1:8 to 2:1, 1:4 to 2:1, 1:3 to 2:1, 1:2 to 2:1, 1:10 to 1:1, 1:8 to 1:1, 4:1 to 1:1, 3:1 to 1:1, or 2:1 to 1:1. In some embodiments, the weight of the compound of Formula IA-A-ii to the compound of Formula IA-A-i is about 1:10 to 10:1. For example, about 1:10 to 2:1, 1:8 to 2:1, 1:4 to 2:1, 1:3 to 2:1, 1:2 to 2:1, 1:10 to 1:1, 1:8 to 1:1, 4:1 to 1:1, 3:1 to 1:1, or 2:1 to 1:1.

In some embodiments, when the compositions, coating agents, and/or materials comprise two compounds of Formula IA-A-i, the weight of one of the compounds of Formula IA-A-i to the other of the compounds of Formula IA-A-i is about 1:10 to 10:1. For example, about 1:10 to 2:1, 1:8 to 2:1, 1:4 to 2:1, 1:3 to 2:1, 1:2 to 2:1, 1:10 to 1:1, 1:8 to 1:1, 4:1 to 1:1, 3:1 to 1:1, or 2:1 to 1:1.

In some embodiments, when the compositions, coating agents, and/or materials comprise s two compounds of Formula IA-A-ii, the weight of one of the compounds of Formula IA-A-ii to the other of the compounds of Formula IA-A-ii is about 1:10 to 10:1. For example, 1:10 to 2:1, 1:8 to 2:1, 1:4 to 2:1, 1:3 to 2:1, 1:2 to 2:1, 1:10 to 1:1, 1:8 to 1:1, 4:1 to 1:1, 3:1 to 1:1, or 2:1 to 1:1.

In some embodiments, the compositions, coating agents, and/or materials comprise a compound of Formula IA-A-i and a compound of Formula IIA. In some embodiments, the weight of the compound of Formula IA-A-i to the compound of Formula IIA is about 30:1 to 1:1. For example, 25:1 to 2:1, 20:1 to 2:1, 10:1 to 3:1, 7:1 to 3:1, 5:1 to 2:1, 4:1 to 2:1, 25:1 to 15:1, 22:1 to 18:1, 88:12 to 99:1, 90:10 to 97:3, 92:8 to 96:4, or 93:7 to 95:5. In some embodiments, the composition comprises about 40% to 100% by weight of the compound of Formula IA-A-i. For example, the composition comprises about 40% to 50%, 50% to 60%, 60% to 70%, 70% to 80%, 80% to 90%, 90% to 100%, 40% to 60%, 60% to 80%, 80% to 100%, 60% to 100%, 70% to 100%, 40% to 99%, 60% to 99%, 70% to 99%, 80% to 99%, 85% to 99%, or 90% to 99% by weight of the compound of Formula IA-A-i. In some embodiments, the compositions, coating agents, and/or materials comprise about 1% to 50% by weight of the compound of Formula IIA. For example, the compositions, coating agents, and/or materials comprise about 1% to 10%, 10% to 20%, 20% to 30%, 30% to 40%, 40% to 50%, 1% to 40%, 1% to 35%, 1% to 30%, 1% to 20%, 10% to 50%, 20% to 40%, 15% to 45%, 10% to 20%, 20% to 30%, or 25% to 35% by weight of the compound of Formula IIA.

In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IA-A-i is 2,3-dihydroxypropan-1-yl octadecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{10A}, and R^{11B} is H; and the sum of o and p is from 11 to 13. For example, the compound of Formula IIA is sodium stearate.

In some embodiments, the compositions, coating agents, and/or materials comprise a compound of Formula IA-A-i and two compounds of Formula IIA. In some embodiments, the weight of the compound of Formula IA-A-i to both compounds of Formula IIA is about 30:1 to 1:1. For example, about 25:1 to 2:1, 20:1 to 2:1, 10:1 to 3:1, 7:1 to 3:1, 5:1 to 2:1, or 4:1 to 2:1. In some embodiments, the weight of one compound of Formula IIA to the other compound of Formula IIA is about 1:20 to 20:1. For example, about 1:10 to 10:1, 1:10 to 2:1, 1:4 to 1:2, 1:3 to 3:1, or 1:2 to 2:1. In some embodiments, the compositions, coating agents, and/or materials comprise about 40% to 100% by weight of the compound of Formula IA-A-i. For example, the compositions, coating agents, and/or materials comprise about 40% to 50%, 50% to 60%, 60% to 70%, 70% to 80%, 80% to 90%, 90% to 100%, 40% to 60%, 60% to 80%, 80% to 100%, 60% to 100%, 70% to 100%, 40% to 99%, 60% to 99%, 70% to 99%, 70% to 94%, 80% to 99%, 85% to 99%, or 90% to 99% by weight of the compound of Formula IA-A-i. In some embodiments, the compositions, coating agents, and/or materials comprise about 1% to 50% by weight of both compounds of Formula IIA. For example, the compositions, coating agents, and/or materials comprise about 1% to 10%, 10% to 20%, 20% to 30%, 30% to 40%, 40% to 50%, 1% to 40%, 1% to 35%, 1% to 30%, 1% to 20%, 10% to 50%, 20% to 40%, 15% to 45%, 10% to 20%, 20% to 30%, or 25% to 35% by weight of both compounds of Formula IIA.

In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IA-A-i is 2,3-dihydroxypropan-1-yl octadecanoate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{10A}, and R^{11B} is H; and the sum of o and p is from 11 to 13. For example, one compound of Formula IIA is sodium stearate and the other compound of Formula IIA is sodium palmitate.

In some embodiments, the compositions, coating agents, and/or materials comprise a first compound of Formula IA-A-i, a second compound of Formula IA-A-i, and one compound of Formula IIA. In some embodiments, the weight of the compound of both compounds of Formula IA-A-i to the compound of Formula IIA is about 30:1 to 1:1. For example, about 25:1 to 2:1, 20:1 to 2:1, 10:1 to 3:1, 7:1 to 3:1, 5:1 to 2:1, 4:1 to 2:1, or 25:1 to 15:1. In some embodiments, the weight of one compound of Formula IA-A-i to the other compound of Formula IA-A-i is about 1:20 to 20:1. For example, about 1:10 to 10:1, 1:10 to 2:1, 1:1 to 8:1, 1:1 to 6:1, 1:1 to 4:1, 1:1 to 3:1, 1:1 to 2:1, 2:1 to 4:1, 4:1 to 6:1, 6:1 to 8:1, 8:1 to 10:1, 1:4 to 1:2, 1:3 to 3:1, or 1:2. In some embodiments, the compositions, coating agents, and/or materials comprise about 40% to 100% by weight of both compounds of Formula IA-A-i. For example, the compositions, coating agents, and/or materials comprise about 40% to 45%, 45% to 50%, 50% to 55%, 55% to 60%, 60% to 65%, 65% to 70%, 65% to 99%, 70% to 75%, 75% to 80%, 80% to 85%, 85% to 90%, 90% to 95%, 95% to 100%, 40% to 50%, 50% to 60%, 60% to 70%, 70% to 80%, 80% to 90%, 90% to 100%, 40% to 60%, 60% to 80%, 80% to 100%, 60% to 100%, 70% to 100%, 40% to 99%, 60% to 99%, 70% to 99%, 70% to 94%, 80% to 99%, 85% to 99%, or 90% to 99% by weight of both compounds of Formula IA-A-i. In some embodiments, the compositions, coating agents, and/or materials comprise about 1% to 50% by weight of the compound of Formula IIA. For example, the compositions, coating agents, and/or materials comprise about 1% to 10%, 10% to 20%, 20% to 30%, 30% to 40%, 40% to 50%, 1% to 40%, 1% to 35%, 1% to 30%, 1% to 20%, 10% to 50%, 20% to 40%, 15% to 45%, 10% to 20%, 20% to 30%, or 25% to 35% by weight of the compound of Formula IIA. In some embodiments, the compositions, coating agents, and/or materials comprise about 25% to 75% (e.g., 35% to 65%, 40% to 60%, 25% to 45%, or 30% to 40%) of the first compound of Formula IA-A-i, about 25% to 75% (e.g., 35% to 65%, 40% to 60%, 25% to 45%, or 30% to 40%) of the second compound of Formula IA-A-i, and about 1% to 40% (e.g., 10% to 40%, 20% to 40%, or 25% to 35%) of the compound of Formula IIA. In some embodiments, the compositions, coating agents, and/or materials comprise about 75% to 99% of the first compound of Formula IA-A-i, about 0.1% to 20% (e.g., 0.1% to 5% or 0.1% to 10%) of the second compound of Formula IA-A-i, and about 1% to 10% of the compound of Formula IIA.

In some embodiments, in one compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. In some embodiments, in the other compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 7 to 9. For example, one compound of Formula IA-A-i is 2,3-dihydroxypropan-1-yl octadecanoate and the other compound of Formula IA-A-i is 2,3-dihydroxypropan-1-yl dodecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IIA is sodium stearate.

In some embodiments, the compositions, coating agents, and/or materials comprise a first compound of Formula IA-A-i, a second compound of Formula IA-A-i, a first compound of Formula IIA, and a second compound of Formula IIA. In some embodiments, the weight of both compounds of Formula IA-A-i to both compounds of Formula IIA is about 30:1 to 1:1. For example, about 25:1 to 2:1, 20:1 to 2:1, 10:1 to 3:1, 7:1 to 3:1, 5:1 to 2:1, 4:1 to 2:1, or 25:1 to 15:1. In some embodiments, the weight of one compound of Formula IA-A-i to the other compound of Formula IA-A-i is about 1:20 to 20:1. For example, about 1:10 to 10:1, 1:10 to 2:1, 1:1 to 8:1, 1:1 to 6:1, 1:1 to 4:1, 1:1 to 3:1, 1:1 to 2:1, 2:1 to 4:1, 4:1 to 6:1, 6:1 to 8:1, 8:1 to 10:1, 1:4 to 1:2, 1:3 to 3:1, 1:2 to 2:1. In some embodiments, the weight of one compound of Formula IIA to the other compound of Formula IIA is about 1:20 to 20:1. For example, about 1:10 to 10:1, 1:10 to 2:1, 1:4 to 1:2, 1:3 to 3:1, or 1:2 to 2:1. In some embodiments, the compositions, coating agents, and/or materials comprise about 40% to 100% by weight of both compounds of Formula IA-A-i. For example, the compositions, coating agents, and/or materials comprise about 40% to 45%, 45% to 50%, 50% to 55%, 55% to 60%, 60% to 65%, 65% to 70%, 65% to 99%, 70% to 75%, 75% to 80%, 80% to 85%, 85% to 90%, 90% to 95%, 95% to 100%, 40% to 50%, 50% to 60%, 60% to 70%, 70% to 80%, 80% to 90%, 90% to 100%, 40% to 60%, 60% to 80%, 80% to 100%, 60% to 100%, 70% to 100%, 40% to 99%, 60% to 99%, 70% to 99%, 70% to 94%, 80% to 99%, 85% to 99%, or 90% to 99% by weight of both compounds of Formula IA-A-i. In some embodiments, the compositions, coating agents, and/or materials comprise about 1% to 50% by weight of both compounds of Formula IIA. For example, the compositions, coating agents, and/or materials comprise about 1% to 10%, 10% to 20%, 20% to 30%, 30% to 40%, 40% to 50%, 1% to 40%, 1% to 35%, 1% to 30%, 1% to 20%, 10% to 50%, 20% to 40%, 15% to 45%, 10% to 20%, 20% to 30%, or 25% to 35% by weight of both compounds of Formula IIA. In some embodiments, the compositions, coating agents, and/or materials comprise about 25% to 75% (e.g., 35% to 65%, 40% to 60%, 25% to 45%, or 30% to 40%) of the first compound of Formula IA-A-i, about 25% to 75% (e.g., 35% to 65%, 40% to 60%, 25% to 45%, or 30% to 40%) of the second compound of Formula IA-A-i, about 1% to 30% (e.g., 10% to 30%, 20% to 30%, 10% to 20%, or 5% to 20%) of the first compound of Formula IIA, and about 1% to 30% (e.g., 10% to 30%, 20% to 30%, 10% to 20%, or 5% to 20%) of the second compound of Formula IIA.

In some embodiments, in each compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, one compound of Formula IA-A-i is 2,3-dihydroxypropan-1-yl octadecanoate and the other compound of Formula IA-A-i is 2,3-dihydroxypropan-1-yl palmitate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, one compound of Formula IIA is sodium stearate and the other compound of Formula IIA is sodium palmitate.

In some embodiments, less than 10% (e.g., less than 5%, less than 2%, less than 1%) by weight of the composition is diglycerides. In some embodiments, less than 10% (e.g., less than 5%, less than 2%, less than 1%) by weight of the composition is triglycerides. In some embodiments, the composition does not comprise an acetylated monoglyceride (e.g., a monoglyceride wherein the hydroxyl groups of the glyceryl moiety are acetylated).

Compositions, coating agents, and/or materials formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance thereof. Accordingly, the compositions, coating agents, and/or materials herein can include one or more compounds of Formula IA.

As further described herein, the compositions, coating agents, and/or materials can additionally or alternatively include fatty acid salts such as sodium salts (e.g., SA-Na, PA-Na, MA-Na, AA-Na, or BA-NA), potassium salts (e.g., SA-K, PA-K, MA-K, AA-K, or BA-K), calcium salts (e.g., (SA)₂-Ca, (PA)₂-Ca, (MA)₂-Ca, (AA)₂-Ca, or (BA)₂-Ca) or magnesium salts (e.g., (SA)₂-Mg, (PA)₂-Mg, or (MA)₂-Mg, (AA)₂-Mg, (BA)₂-Mg). Accordingly, the compositions, coating agents, and/or materials herein can include one or more compounds of Formula IIA. In some embodiments of Formula IIA, X is sodium. In some embodiments of Formula IIA, R is -glyceryl. In some embodiments, R¹, R², R⁵, R⁶, R⁹, R¹⁰, R¹¹, R¹² and R¹³ are each independently selected from —H, —C₁-C₆ alkyl, and —OH. In some embodiments, R³, R⁴, R⁷, and R⁸ are each independently selected from —H, —C₁-C₆ alkyl, and —OH. In some embodiments, R³ and R⁴ combine with the carbon atoms to which they are attached to form a 3- to 6-membered ring heterocycle. In some embodiments, R⁷ and R⁸ combine with the carbon atoms to which they are attached to form a 3- to 6-membered ring heterocycle. In some embodiments, q is 1 and the sum of n, m, and r is from 10 to 12.

Any of the compositions, coating agents, and/or materials described herein can include one or more medium chain fatty acid compounds, long chain fatty acid compounds, medium chain fatty acid salt compounds, long chain fatty acid salt compounds, medium chain fatty acid methyl ester compounds, long chain fatty acid methyl ester compounds, medium chain fatty acid ethyl ester compounds, long chain fatty acid ethyl ester compounds, medium chain fatty acid 2-glyceryl ester compounds, long chain fatty acid 2-glyceryl ester compounds, medium chain fatty acid 1-glyceryl ester compounds, and/or long chain fatty acid 1-glyceryl compounds as shown above (e.g., compounds of Formula IA).

### Coating Agent Mixtures

In some embodiments, the composition (e.g., coating agent) can be dissolved, mixed, dispersed, or suspended in a solvent to form a mixture (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water. For example, the solvent is ethanol.

In some embodiments, the concentration of the composition (e.g., coating agent) in the solution or mixture (e.g., solution, suspension, or colloid) is about 1 mg/mL to 200 mg/mL. For example, 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, 10 to 40 mg/mL, 20 to 50 mg/mL, 20 to 40 mg/mL, 25 to 35 mg/mL, 30 to 50 mg/mL, or 35 to 45 mg/mL.

In some embodiments, an inorganic salt (e.g. NaCl, KCl) can be included in the solvent (e.g., water) to aid mixing. In some embodiments, a total amount of inorganic salt in the solvent is at least 1 ppm, at least 3 ppm, at least 5 ppm, at least 10 ppm, at least 20 ppm, at least 30 ppm, at least 50 ppm, at least 100 ppm, at least 150, at least 200, at least 250 ppm, or at least 500 ppm. In some embodiments, a total amount of inorganic salt in the solvent is not more than 10 ppm, not more than 20 ppm, not more than 30 ppm, not more than 50 ppm, not more than 100 ppm, not more than 150, not more than 200, not more than 250 ppm, not more than 500 ppm, or not more than 1000 ppm.

As previously described, coating agents formed predominantly of various combinations of compounds of Formula IA (e.g., coating agents that are at least 50% compounds of Formula IA by mass or by molar composition) each having a carbon chain length of at least 14 have been shown to form protective coatings that are effective at imparting hydrophobicity, hydrophilicity, lipophilicity, lipophobicity, omniphobicity, gas impermeability, grease impermeability, oil impermeability, water impermeability, gas resistance, grease resistance, oil resistance, water resistance, or combinations thereof. As also previously described, the coatings can be formed on the fiber-based material by dissolving, suspending, or dispersing the coating agent in a solvent to form a mixture, applying the mixture thereto (e.g., by spray coating, dipping, or by brushing), and then removing the solvent (e.g., by allowing the solvent to evaporate). The solvent can include any polar, non-polar, protic, or aprotic solvents, including any combinations thereof. Examples of solvents that can be used include water, methanol, ethanol, isopropanol, butanol, acetone, ethyl acetate, chloroform, acetonitrile, tetrahydrofuran, diethyl ether, methyl tert-butyl ether, any other suitable solvent or combinations thereof. Depending on the solvent that is used, the solubility limit of the coating agent in the solvent may be lower than desired for particular applications. For example, when compounds of Formula IA are used as the coating agent and the solvent is water (or is predominantly water), the solubility limit of the coating agent may be relatively low. In these cases, it may still be possible to add the desired concentration of coating agent to the solvent and form a suspension or colloid.

In order to improve the solubility of the coating agent in the solvent, or to allow the coating agent to be suspended or dispersed in the solvent, the coating agent can further include an emulsifier. Furthermore, it is also preferable that the emulsifier either not be incorporated into the coating or, if the emulsifier is incorporated into the coating, that it does not degrade the performance of the coating.

Through extensive experimentation, it has been shown that organic salts (e.g., compounds of Formula IIA) added to the coating agent can increase the solubility of the coating agent or allow the coating agent to be suspended or dispersed in solvents having a substantial water content (e.g., solvents that are at least 50% water by volume), provided that the concentration of the salts is not too low (relative to the concentration of compounds of Formula IA). Furthermore, the added salts do not substantially degrade the performance of subsequently formed coatings provided that the concentration of the salts (relative to the concentration of the compounds of Formula IA) is not too high.

For example, coating agents including a first group of compounds of Formula IA mixed with a second group of compounds of Formula IIA can be added to water to form a suspension by heating the water to about 70° C., adding the coating agent, and then cooling the resulting mixture to about room temperature (or a lower temperature). The cooled mixture can then be applied to substrates such as produce to form a protective coating, as described throughout. However, it has been found that when the compounds of Formula IA make up at least 50% of the mass of the coating agent and the compounds of Formula IIA make up less than about 3% of the coating agent, the coating agent either cannot be suspended in the water at the elevated temperature, or the coating agent can be suspended in the water at the higher temperature but then crashes out as the temperature is reduced, thus preventing coatings from being able to be formed from the mixture.

In view of the above, compositions (e.g., coating agents) can include a first group of compounds that includes one or more compounds of Formula IA (e.g., fatty acids or esters thereof) and a second group of compounds that includes one or more salts Formula IIA (e.g., fatty acid salts). The compound(s) of Formula IA and/or the salt(s) of Formula IIA can optionally have a carbon chain length of at least 14. A weight ratio of the first group of compounds (e.g., compounds of Formula IA such as fatty acids or esters, including monoacylglycerides) to the second group of compounds (salts of Formula IIA, e.g., fatty acid salts) can, for example, be in a range of about 2 to 200, 2 to 100, 2 to 50, 2 to 40, 2 to 30, 2 to 25, 2 to 10, 10 to 100, 10 to 99, 10 to 90, 10 to 80, 10 to 70, 10 to 60, 10 to 50, 10 to 40, or 10 to 30,

As described above, the coating agent can be added to or dissolved, suspended, or dispersed in a solvent to form a colloid, suspension, or solution. The various components of the coating agent (e.g., the compounds of Formula IA and the salts of Formula IIA) can be combined prior to being added to the solvent and then added to the solvent together. Alternatively, the components of the coating agent can be kept separate from one another and then be added to the solvent consecutively (or at separate times).

The concentration of the first group of compounds (compounds of Formula IA) in the solvent/solution/suspension/colloid can, for example, be in a range of about 1 mg/mL to about 200 mg/mL, such as about 1 to 150 mg/mL, 1 to 100 mg/mL, 1 to 50 mg/mL, 10 to 200 mg/mL, 10 to 150 mg/mL, 10 to 100 mg/mL, 10 to 50 mg/mL, 10 to 45 mg/mL, or 10 to 40 mg/mL.

The concentration of the second group of compounds (salts of Formula IIA, e.g., fatty acid salts) in the solvent/solution/suspension/colloid can, for example, be in a range of about 0.01 mg/mL to about 80 mg/mL, 0.01 to 60 mg/mL, 0. 0.01 to 40 mg/mL, 0.01 to 20 mg/mL, 0.01 to 10 mg/mL, 0.1 to 80 mg/mL, 0.1 to 60 mg/mL, 0.1 to 40 mg/mL, 00.1 to 20 mg/mL, 0.1 to 10 mg/mL, 1 to 80 mg/mL, 1 to 60 mg/mL, 1 to 40 mg/mL, 1 to 35 mg/mL, 1 to 20 mg/mL, or 1 to 10 mg/mL.

The concentration of the composition (e.g., the coating agent) in the solvent/solution/suspension/colloid can, for example, be in a range of about 1 mg/mL to about 200 mg/mL, such as about 1 to 150 mg/mL, 1 to 100 mg/mL, 1 to 50 mg/mL, 5 to 200 mg/mL, 5 to 150 mg/mL, 5 to 100 mg/mL, 5 to 50 mg/mL, 10 to 200 mg/mL, 10 to 150 mg/mL, 10 to 100 mg/mL, or 10 to 50 mg/mL.

In some embodiments, the composition can include one or more (e.g., 1, 2, or 3) wetting agents, surfactants, and/or emulsifiers. In some embodiments, the wetting agents, surfactants, and/or emulsifiers can be used in addition to one or more compounds of Formula IA and/or Formula IIA. In some embodiments, the wetting agents, surfactants, and/or emulsifiers can be used alternatively to a compound of Formula IA and/or Formula IIA. In some embodiments, a phospholipid, a lysophospholipid, a glycoglycerolipid, a glycolipid (for example, sucrose esters of fatty acids), an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g. an alkyl sulfate), is included in the composition and functions as a surfactant and/or an emulsifier (and optionally also functions as a wetting agent). In some embodiments, the emulsifier is cationic. In some embodiments, the emulsifier is anionic. In some embodiments, the emulsifier is zwitterionic. In some embodiments, the emulsifier is uncharged.

In some embodiments, the composition (e.g., coating or coating agent) comprises one or more (e.g., 1, 2, or 3) wetting agents, surfactants, and/or emulsifiers. In some embodiments, the one or more wetting agents, surfactants, and/or emulsifiers comprise sodium bicarbonate, citric acid, cetyl trimethylammonium bromide, sodium lauryl sulfate, ammonium lauryl sulfate, sodium laureth sulfate, sodium myreth sulfate, docusate, sodium dodecyl sulfate, sodium stearate, sodium lauroyl sarcosinate, perfluorononanoate, perfluorooctanoate, perfluorooctanesulfonate (PFOS), perfluorobutanesulfonate, alkyl-aryl ether phosphates, alkyl ether phosphates, 2-[4-(2,4,4-trimethylpentan-2-yl)phenoxy]ethanol (Triton X-100), 3-[(3-Cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, cocamide diethanolamine, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, fatty acid esters of sucrose, alkyl polyglucosides, alkyl polyglycoside, decyl glucoside, lauryl glucoside, octyl glucoside, fatty acid esters of sucrose, sucrose monostearate, sucrose distearate, sucrose tristearate, sucrose polystearate, sucrose monopalmitate, sucrose dipalmitate, sucrose tripalmitate, sucrose polypalmitate, sucrose monomyristate, sucrose dimyristate, sucrose trimyristate, sucrose polymyristate, sucrose monolaurate, sucrose dilaurate, sucrose trilaurate, or sucrose polylaurate. For example, the one or more wetting agents, surfactants, and/or emulsifiers comprises sodium lauryl sulfate. For example, the one or more wetting agents, surfactants, and/or emulsifiers comprises sodium bicarbonate. For example, the one or more wetting agents, surfactants, and/or emulsifiers comprises citric acid.

In some embodiments, the mixture or composition (e.g., coating or coating agent) comprises about 0.1% to about 40% by weight of the one or more wetting agents, surfactants, and/or emulsifiers. For example, the mixture or composition (e.g., coating or coating agent) comprises about 0.1% to 35%, 0.1% to 30%, 0.1% to 25%, 0.1% to 20%, 0.1% to 15%, 0.1% to 10%, 0.1% to 8%, 0.1% to 6%, 0.1% to 5%, 0.1% to 4%, 0.1% to 3%, 0.1% to 2%, 0.1% to 1%, 0.1% to 0.5%, 1% to 40%, 1% to 30%, 1% to 20%, 1% to 15%, 1% to 10%, 1% to 5%, 3% to 9%, 5% to 10%, 10% to 20%, 20% to 30%, 30% to 40%, 20% to 40%, or 25% to 35.

In some embodiments, the mixture or composition (e.g., coating or coating agent) comprises one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylatedhydroxyanisole (BHA), butylatedhydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzonic acid, sorbic acid, methyl paraben, propyl paraben, bronidol, and propylene glycol.

In some embodiments, the mixture or composition (e.g., coating or coating agent) comprises about 0.1% to 40% by weight of the one or more preservatives. For example, the mixture or composition (e.g., coating or coating agent) comprises about 0.1% to 35%, 0.1% to 30%, 0.1% to 25%, 0.1% to 20%, 0.1% to 15%, 0.1% to 10%, 0.1% to 8%, 0.1% to 6%, 0.1% to 5%, 0.1% to 4%, 0.1% to 3%, 0.1% to 2%, 0.1% to 1%, 0.1% to 0.5%, 1% to 40%, 1% to 30%, 1% to 20%, 1% to 15%, 1% to 10%, or 1% to 5%.

In view of the above, any of the compositions (e.g., coating agents) described herein can include a first group of compounds of Formulas IA and/or IIA (e.g., fatty acids and/or salts or esters thereof) and a second group of compounds, where the second group of compounds function as an emulsifier (e.g. is a fatty acid salt, a phospholipid, a lysophospholipid, a glycoglycerolipid, a glycolipid (for example, sucrose esters of fatty acids), an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol and derivatives thereof (e.g. an alkyl sulfate).

A weight ratio of the fatty acids and/or esters in the first group of compounds to the emulsifiers in the second group of compounds can be in any of the ranges given previously (e.g., a range such that the solubility of the coating agent in the solvent is sufficient to allow the desired coating agent concentration to be dissolved, suspended, or dispersed in the solvent). A weight ratio of the first group of compounds (carbon chain length of at least 14) to the second group of compounds (carbon chain length of 13 or less, or emulsifier) can be in a range of about 2 to 200, for example about 2 to 100, 2 to 90, 2 to 80, 2 to 70, 2 to 60, 2 to 50, 2 to 40, 2 to 30, 2 to 25, 2 to 20, 2 to 15, 2 to 10, 2.5 to 200, 2.5 to 100, 2.5 to 90, 2.5 to 80, 2.5 to 70, 2.5 to 60, 2.5 to 50, 2.5 to 40, 2.5 to 30, 2.5 to 25, 2.5 to 20, 2.5 to 15, 2.5 to 10, 3 to 200, 3 to 100, 3 to 90, 3 to 80, 3 to 70, 3 to 60, 3 to 50, 3 to 40, 3 to 30, 3 to 25, 3 to 20, 3 to 15, 3 to 10, 4 to 200, 4 to 100, 4 to 90, 4 to 80, 4 to 70, 4 to 60, 4 to 50, 4 to 40, 4 to 30, 4 to 25, 4 to 20, 4 to 15, 4 to 10, 5 to 200, 5 to 100, 5 to 90, 5 to 80, 5 to 70, 5 to 60, 5 to 50, 5 to 40, 5 to 30, 5 to 25, 5 to 20, 5 to 15, or 5 to 10.

As described above, the coating agent can be added to or dissolved, suspended, or dispersed in a solvent to form a suspension, colloid, or solution. The various components of the coating agent (e.g., the compounds of Formula IA, the salts of Formula IIA, and/or the emulsifiers) can be combined prior to being added to the solvent and then added to the solvent together. Alternatively, at least some of the components of the coating agent can be kept separate from other components and can be added to the solvent consecutively (or at separate times).

The concentration of the emulsifier can, for example, be in a range of about 1 mg/mL to 200 mg/mL, such as about 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, or 10 to 40 mg/mL.

The composition that is added to the solvent (e.g., the coating agent) can be composed about 50% to about 99.9% (e.g., about 60%-99.9%, 65%-990.9%, 70%-990.9%, 75%-99.9%, 80%-99.9%, 85%-99.9%, 90%-99.9%, 50%-99%, 60%-99%, 65%-99%, 70%-99%, 75%-99%, 80%-99%, 85%-99%, 90%-99%, 50%-98%, 60%-98%, 65%-98%, 70%-98%, 75%-98%, 80%-98%, 85%-98%, 90%-98%, 50%-96%, 60%-96%, 65%-96%, 70%-96%, 75%-96%, 80%-96%, 85%-96%, 90%-96%, 50%-94%, 60%-94%, 65%-94%, 70%-94%, 75%-94%, 80%-94%, 85%-94%, or 90%-94%) by mass of a first group of compounds of fatty acids, fatty acid esters, fatty acid salts, or combinations thereof (e.g., compounds of Formula IA and/or salts of Formula IIA), where optionally each compound of the first group optionally has a carbon chain length of at least 14. In some embodiments, the compounds of the first group are fatty acid esters, e.g., monoacylglycerides.

The composition that is added to the solvent (e.g., the coating agent) can be composed about 0.1% to 50% (e.g., about 0.1%-45%, 0.1%-40%, 0.1%-35%, 0.1%-30%, 0.1%-25%, 0.1%-20%, 0.1%-15%, 0.1%-10%, 0.1%-8%, 0.1%-6%, 0.1%-5%, 0.1%-4%, 0.4%-50%, 0.4%-45%, 0.4%-40%, 0.4%-35%, 0.4%-30%, 0.4%-25%, 0.4%-20%, 0.4%-15%, 0.4%-10%, 0.4%-8%, 0.4%-6%, 0.4%-5%, 0.4%-4%, 0.7%-50%, 0.7%-45%, 0.7%-40%, 0.7%-35%, 0.7%-30%, 0.7%-25%, 0.7%-20%, 0.7%-15%, 0.7%-10%, 0.7%-8%, 0.7%-6%, 0.7%-5%, 0.7%-4%, 1%-50%, 1%-45%, 1%-40%, 1%-35%, 1%-30%, 1%-25%, 1%-20%, 1%-15%, 1%-10%, 1%-8%, 1%-6%, 1%-5%, or 1%-4%) by mass of a second group of compounds of fatty acids, fatty acid esters, fatty acid salts, or combinations thereof (e.g., compounds of Formula IA and/or salts of Formula IIA), where each compound of the second group is different from the first.

The composition that is added to the solvent (e.g., the coating agent) can be composed about 0.1% to about 50% (e.g., about 0.1%-45%, 0.1%-40%, 0.1%-35%, 0.1%-30%, 0.1%-25%, 0.1%-20%, 0.1%-15%, 0.1%-10%, 0.1%-8%, 0.1%-6%, 0.1%-5%, 0.1%-4%, 0.4%-50%, 0.4%-45%, 0.4%-40%, 0.4%-35%, 0.4%-30%, 0.4%-25%, 0.4%-20%, 0.4%-15%, 0.4%-10%, 0.4%-8%, 0.4%-6%, 0.4%-5%, 0.4%-4%, 0.7%-50%, 0.7%-45%, 0.7%-40%, 0.7%-35%, 0.7%-30%, 0.7%-25%, 0.7%-20%, 0.7%-15%, 0.7%-10%, 0.7%-8%, 0.7%-6%, 0.7%-5%, 0.7%-4%, 1%-50%, 1%-45%, 1%-40%, 1%-35%, 1%-30%, 1%-25%, 1%-20%, 1%-15%, 1%-10%, 1%-8%, 1%-6%, 1%-5%, or 1%-4%) by mass of a third group of compounds comprised of an emulsifier, such as a fatty acid salt, a phospholipid, a lysophospholipid, a glycoglycerolipid, a glycolipid (for example, sucrose esters of fatty acids), an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol and derivatives thereof (e.g. an alkyl sulfate). The compounds of the third group can function as emulsifiers and, for example, increase the solubility of the coating agent, as previously described.

Any of the coating agents described herein can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some embodiments, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultra violet (UV) light, for example to protect the agricultural product (or any of the other products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive.

Any of the coating agents or coatings formed thereof that are described herein can be flavorless or have high flavor thresholds, e.g. above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

The compositions (e.g., coating agents) described herein can be of high purity. For example, the compositions can be substantially free (e.g., be less than 10%, 5%, or 1% by weight) of diglycerides, triglycerides, acetylated monoglycerides, proteins, polysaccharides, phenols, lignans, aromatic acids, terpenoids, flavonoids, carotenoids, alkaloids, alcohols, alkanes, and/or aldehydes. In some embodiments, the compositions comprise less than 10% (e.g., less than 5% or 1%) by weight of diglycerides. In some embodiments, the compositions comprise less than 10% (e.g., less than 5% or 1%) by weight of triglycerides. In some embodiments, the compositions comprise less than 10% (e.g.,) by weight of acetylated monoglycerides.

Any of the coatings described herein can be disposed on the fiber-based material or other substrate using any suitable means. For example, the substrate can be dip-coated in a bath of the coating formulation (e.g., an aqueous or mixed aqueous-organic or organic solution). The deposited coating can form a thin layer thereon. In some embodiments, the deposited coating can have a thickness of less than 20 microns, less than 10 microns, less than 9 microns, less than 8 microns, less than 7 microns, less than 6 microns, less than 5 microns, less than 4 microns, less than 3 microns, less than 2 microns, less than 1.5 microns, 100 nm to 20 microns, 100 nm to 2 microns, 700 nm to 1.5 microns, 700 nm to 1 micron, 1 micron to 1.6 microns, 1.2 microns to 1.5 microns, and/or the coating can be transparent to the naked eye.

### Solvents

The solvent to which the coating agent and wetting agent (when separate from the coating agent) is added to form the solution/suspension/colloid can, for example, be water, methanol, ethanol, isopropanol, butanol, acetone, ethyl acetate, chloroform, acetonitrile, tetrahydrofuran, diethyl ether, methyl tert-butyl ether, an alcohol, any other suitable solvent, or a combination thereof. The resulting solutions, suspensions, or colloids can be suitable for forming coatings on fiber-based materials or other substrates. For example, the solutions, suspensions, or colloids can be applied thereto, after which the solvent can be removed (e.g., by evaporation or convective drying), leaving a protective coating formed thereon from the coating agent.

While a number of the solvents above (particularly water and ethanol) can be safely and effectively used, in many cases it can be advantageous to use either water or otherwise a solvent which is at least about 40% (and in many cases higher) water by volume. This is because water is typically cheaper than other suitable solvents and can also be safer to work with than solvents that have a higher volatility and/or a lower flash point (e.g., acetone or alcohols such as isopropanol or ethanol). In some embodiments, the solvent comprises water. For example, the solvent is water. Accordingly, for any of the solutions/suspensions/colloids described herein, the solvent or solution/suspension/colloid can be at least about 40%, 45%, 50%, 55%, 60%, 65%, 70%, 75%, 80%, 85%, 90%, 95%, or 99% water by mass or by volume. In some embodiments, the solvent includes a combination of water and ethanol, and can optionally be at least 40%, 45%, 50%, 55%, 60%, 65%, 70%, 75%, 80%, 85%, 90%, 95%, or 99% water by volume. In some embodiments, the solvent or solution/suspension/colloid can be 40% to 100%, 40% to 99%, 40% to 95%, 40% to 90%, 40% to 85%, 40% to 80%, 50% to 100%, 50% to 99%, 50% to 95%, 50% to 90%, 50% to 85%, 50% to 80%, 60% to 100%, 60% to 99%, 60% to 95%, 60% to 90%, 60% to 85%, 60% to 80%, 70% to 100%, 70% to 99%, 70% to 95%, 70% to 90%, 70% to 85%, 80% to 100%, 80% to 99%, 80% to 95%, 80% to 90%, 85% to 100%, 85% to 99%, 85% to 97%, 85% to 95%, 90% to 100%, 90% to 99%, or 90% to 98% water by mass or volume.

The coating agent that is added to or dissolved, suspended, or dispersed in the solvent to form the coating solution/suspension/colloid can be any compound or combination of compounds capable of forming a protective coating over the substrate to which the solution/suspension/colloid is applied.

### Coating Properties

In some embodiments, when the components of the coating agent (e.g., fatty acids, fatty acid esters, or a combination thereof and/or fatty acid salts) are mixed with a solvent, they form microstructures, such as, for example, vesicles in the solvent. When this mixture contacts a surface, such that of a fiber-based material, the vesicles can adsorb to the surface, rupture, and form a lamella (e.g., a lipid bilayer) on the surface. As more vesicles approach the surface and rupture, additional lamellae can be added to the lamella to form a lamellar structure. In some embodiments, upon removal or drying of the solvent, the lamellar structure partitions into grains. The boundaries between the grains are crystal defects.

In some embodiments, an advantage of the lamellar structure is its low permeability (e.g. low water permeability, low water vapor permeability, low oil permeability, low gas permeability). Without being bound by any theory, when water passes through the coating, it travels through grain boundaries and between the lamellae if the outer surfaces of the lamellae are sufficiently hydrophilic (e.g., when the lamellae are lipid bilayers). In some embodiments, when the lamellar structure is composed of lipid bilayers formed from fatty acids, fatty acid esters, or a combination thereof and/or fatty acid salts, higher amounts of fatty acid salts in the coating increases the hydrophilicity of the outer surfaces of the lipid bilayers that make up the coating, thus allowing more water to intercalate between the lipid bilayers and therefore increasing the water permeability of the coating. In some embodiments, the water vapor permeability of a coated substrate can be increased by increasing the fatty acid salt content of the coating, or, alternatively, the water vapor permeability of the coated substrate can be decreased by decreasing the fatty acid salt content. In some such embodiments, increasing the fatty acid salt content of the coating can decrease the oil permeability of the coated substrate. In some embodiment, increasing the chain length of the fatty acid can decrease the oil permeability of the coated substrate.

In some embodiments, increasing the concentration of the coating agent in the mixture increases the thickness of the coating, which, for example, can reduce the water permeability and can lower the gas diffusion ratio.

In some embodiments, the higher the temperature of drying, the larger the grain size and lower the mosaicity (which is a measure of the probabilities that the orientation of lamellae in a coating deviate from a plane that is substantially parallel with the plane of the substrate surface, recognized as a type of crystal defect) in the coating, which can result in fewer grain boundaries and defects for water and/or gas to travel through. In some embodiments, this can result in a lower water, oil, and gas permeability.

In some embodiments, heating the coating (or coated agricultural product) from a first temperature to a second temperature higher than the first temperature but below the melting point (i.e., the phase transition temperature) of the coating, then cooling the coating, can increase the grain size in the coating, which can result in a lower water permeability and lower gas diffusion ratio.

### Coated Fiber-Based Material

In one aspect, described herein is a coated fiber-based material or substrate comprising a coating that forms a lamellar structure on the substrate, wherein the coating has a thickness of less than 20 microns.

In another aspect, described herein is a coated substrate comprising a coating that forms a lamellar structure on the substrate, wherein the coating comprises a plurality of grains.

In some embodiments (e.g., when the lamella is a lipid bilayer (e.g., when the lamella is a lipid bilayer comprising one or more fatty acid derivatives)), the lattice formation is defined by a hexagonal unit cell. The distance between each adjacent molecule in the unit cell is typically about 0.2 nm to 2 nm. For example, about 0.2 to 0.7 nm, 0.2 to 1.2 nm, 0.2 nm to 0.4 nm, 0.3 nm to 0.5 nm, or 0.4 nm to 0.6 nm.

In some embodiments, the lamellar structure comprises a plurality of lamellae. The distance between a surface of a lamella and the surface of an adjacent lamella that is facing the same direction is referred to herein as “interlayer spacing”. In some embodiments, the interlayer spacing of the lamellae is about 1.0 to 20 nm. For example, the interlayer spacing is about 1 to 20 nm, 3 nm to 10 nm, 3 to 5 nm, or 4 to 6 nm.

In some embodiments, the coating comprises a plurality of grains.

In some embodiments, the grain size is about 2 nm to 100 nm. For example, about 6 nm to 80 nm, 6 nm to 60 nm, 6 nm to 40 nm, 2 nm to 10 nm, or 5 nm to 10 nm.

In one aspect, described herein is a coated substrate comprising a coating that forms a lamellar structure on the substrate, wherein:
the coating has a thickness of less than 2 microns;
the lamellar structure comprises a plurality of lamellae;
the interlayer spacing of the lamellae is about 3 nm to about 6 nm; and
the coating comprises one or more compounds of Formula IA and one or more compounds of Formula IIA.

In one aspect, described herein is a coated substrate comprising a coating that forms a lamellar structure on the substrate, wherein:
the coating has a thickness of less than 2 microns;
the grain size is about 13 nm to about 25 nm; and
the coating comprises one or more compounds of Formula IA and one or more compounds of Formula IIA.

In one aspect, described herein is a coated substrate comprising a coating that forms a lamellar structure on the substrate, wherein:
the coating has a thickness of less than 2 microns;
the lamellar structure comprises a plurality of lamellae;
the interlayer spacing of the lamellae is about 3 nm to about 6 nm; and
the grain size is about 13 nm to about 25 nm.

### Methods of the Disclosure

The methods according to this disclosure are useful for the manufacture of fiber-based materials, e.g., textiles, paper, packaging materials, and packages. The methods comprise associating one or more fibers with one or more compounds, compositions, mixtures, or monomers as described herein. In some embodiments, the one or more fibers are associated with one or more compounds, compositions, mixtures, or monomers prior to the formation of the final material, e.g., during the pulping phase of paper and/or packaging material or other fiber-based material manufacturing, or to a collection of, for example, individual fibers prior to weaving the fibers into a textile. In other embodiments, the one or more fibers are associated with one or more compounds, compositions, mixtures, or monomers according to this disclosure after the formation of the final material, e.g., after a textile has been woven, or after paper and/or packaging material, or other fiber-based material has been formed.

In some embodiments, the compounds, compositions, mixtures, or monomers as described herein are contacted with a pre-manufactured textile, paper, packaging, or other fiber-based material. In some embodiments, the individual fibers of the fiber-based material have been woven or pressed to produce a fiber-based material prior to contacting the material with the compounds, compositions, mixtures, or monomers described herein.

In some embodiments, the compounds, compositions, mixtures, or monomers as described herein are combined with a fiber-based material before weaving or pressing to yield a fiber-based product. Monomers combined with the fiber-based material can be polymerized during formation of the fiber-based product (e.g., during thermoforming the fiber-based material). Polymerization of the monomers during formation of the fiber-based product can result in the formation of a gas barrier in the fiber-based product.

In some embodiments, the compounds, compositions, mixtures, or monomers as described herein are contacted with a textile, paper, packaging, or other fiber-based material. The compounds, compositions, mixtures, or monomers can be contacted with the textile, paper, packaging, or other fiber-based material in a number of ways recognizable to those skilled in the art. For example, the compounds, compositions, mixtures, or monomers can be dissolved, suspended, or dispersed in a solvent to form a solution that can then be used to apply the compounds, compositions, mixtures, or monomers to the surface of the textile, paper, packaging, or other fiber-based material. The solvent can be any solvent recognizable to those skilled in the art. In some embodiments, the solvent may include organic or inorganic solvents. In some embodiments, the solvent may include water, an alcohol, an ester, an ether, an amide, an amine, a ketone, a sulfoxide, or a hydrocarbon, or any combination thereof. The solution can be sprayed, aerosol sprayed, brushed, dripped, dropcast, rolled, dabbed, or poured over the surface of the textile, paper, packaging, or other fiber-based material. Alternatively, the textile, paper, packaging, or other fiber-based material can be dipped, soaked, or submerged in the solution. The method in which the compounds, compositions, mixtures, or monomers according to this disclosure are contacted with the textile, paper, packaging, or other fiber-based material can influence the properties of the resulting material. Without wishing to be bound by theory, methods that allow for a greater surface area of coverage of the compounds, compositions, mixtures, or monomers according to this disclosure on the surface of the material will allow for a greater degree of modification of the properties of the resulting material. For example, the gas permeability of a paper substrate can be reduced more drastically when the compounds and/or monomers according to this disclosure are dropcast onto the surface of the paper substrate compared to aerosol application of the compounds and/or monomers onto the surface of the paper substrate.

A solution containing the compounds, compositions, mixtures, or monomers as described herein can be formulated to achieve a desired penetration of the fiber-based material. In some examples, the solution is formulated to penetrate and fill pores in the fiber-based material to a selected depth. In certain examples, the solution is formulated to coat fibers on the surface of the fiber-based material (e.g., localize on top of the surface) with little or no penetration into the pores. Thus, the solution can be formulated to control a porosity of the fiber-based material to which it is applied, as well as the gas permeability of products made from the fiber-based material.

After the solution containing the compounds, compositions, mixtures, or monomers described herein have been applied to the surface of the textile, paper, packaging, or other fiber-based material, the solvent can subsequently be removed, e.g., by drying, heating, evaporation, forced convection, or any combination thereof, thereby causing an association between the compounds or monomers described herein with the textile, paper, packaging or other fiber-based material. In some embodiments, a majority of the solvent is removed. In some embodiments, at least about 90%, 95%, 99%, or 100% by volume of the solvent is removed. In some embodiments, the solvent is removed to dryness. In some embodiments, the association of the compounds or monomers according to this disclosure with the textile, paper, packaging, or other fiber-based material results in a coating on the textile, paper, packaging, or other fiber-based material.

The solvent can be removed by drying the fiber-based material at a selected temperature. In some embodiments, the fiber-based material is dried at a temperature less than the melting temperature or glass transition temperature (e.g., 10° C. less or 20° C. less) of one or more components in the composition applied to the fiber-based material. In one example, the fiber-based material is dried at a temperature between 40° C. and 100° C. (e.g., between 40° C. and 50° C., 60° C., 70° C.). Drying the fiber-based material at a temperature less than the melting temperature or glass transition temperature of one or more components in the composition applied to the fiber-based material decreases the permeability of the fiber-based material to fluids (e.g., gases and liquid) relative to fiber-based material dried at a temperature above the melting temperature or glass transition temperature of the one or more components of the composition (e.g., 180° C. or 200° C.). Drying the fiber-based material at a temperature above the melting temperature or glass transition temperature of the one or more components in the composition is believed to liquefy the one or more components, thereby promoting deeper penetration of the one or more components into the fiber network, thereby reducing efficacy of the coating.

The temperature at which the fiber-based materials are heated can also have an impact on the mosaicity of the resulting coating/layer. Mosaicity is a measure of the probabilities of relative orientation of the bilayers relative to the plane of the substrate. Bilayer stacking mosaicity is also a type of crystal defect that creates a pathway for water and gas transport. Lower mosaicity means that more of the bilayers are sitting more parallel to the plane of the substrate. Increase in drying temperature drastically decreases the bilayer stacking mosaicity, and thus leads to increased barrier performance of the resulting coating/layer.

In some embodiments, the monomers according to this disclosure are contacted with a textile, paper, packaging, or other fiber-based material such that they subsequently form a polymer that is associated with the fibers of the textile, paper, packaging, or other fiber-based material. In some embodiments, the monomers are contacted with the surface of a textile, paper, packaging, or other fiber-based material according to methods described herein, and are subsequently heated to induce polymerization of the monomers, thereby associating the polymer with the surface of the textile, paper, packaging, or other fiber-based material. In certain such embodiments, the textile, paper, or other fiber-based product is heated to at least 100° C. (e.g., 110° C., 120° C., 130° C., 140° C., 150° C., 160° C., 170° C., 180° C., 190° C., 200° C., 210° C., 220° C., or 230° C.) after the monomers have been added to the surface of the textile, paper, packaging, or other fiber-based material. In certain embodiments, the textile, paper, or other fiber-based material is maintained at high temperature for at least 5, 10, 20, 30, 40, 50, 60, or 90 minutes, or at least 2 hours or 3 hours.

The temperature and duration of time during which the fiber-based material is heated can play a role in the properties of the resulting fiber-based material. For example, the gas permeability of the material can be tuned by modifying the polymerization temperature, as well as the time during which the polymerization step takes place. Without wishing to be bound by theory, higher polymerization temperatures result in a higher degree of polymerization of the monomers thereby increasing the barrier properties of the resulting material. For example, a fiber based material that has been contacted with the monomers according to this disclosure that is heated to 177° C. will have a higher degree of polymerization than the same fiber-based material that has been contacted with the same monomers that was heated to 140° C. Similarly, a fiber-based material that has been contacted with one or more monomers according to this disclosure, that is heating for longer periods of time (e.g., 1 hour) will also be characterized by a higher degree of polymerization compared to the same fiber-based material that has been contacted with the same one or monomers that is heated for a shorter period of time (e.g., 20 minutes). Thus, polymerization temperature as well as the length of time during which polymerization takes place can be tuned to achieve fiber-based materials with desirable barrier properties.

In some embodiments, the fibers of the fiber-based material are contacted with the compounds and/or monomers described herein prior to the manufacture of the fiber-based product. In some embodiments, the fibers of the fiber-based material are contacted with the compounds and/or monomers described herein prior to being woven or pressed into the fiber based-material.

As used herein, “fiber products” refers to products made from cellulose-containing materials, including wood materials, non-wood materials, other renewable materials, or any combination thereof. Examples of non-wood materials include bast fibers (e.g., jute, kenaf, flax, hemp), bamboo, bagasse, switchgrass, and the like. These cellulose-containing materials typically contain hemicellulose and lignin in addition to cellulose. The manufacture of fiber products, such as fiber-based packaging materials, typically involves the separation of fibers from lignin and other components present in the cellulose-containing materials, the optional bleaching of the separated fibers, followed by formation of the fiber products (e.g., paper) from a pulp slurry. In some embodiments of this disclosure, the fibers are associated with the compounds, compositions, materials, or monomers described herein after the fibers have been separated from lignin and other components present in the cellulose-containing materials, and after the optional bleaching of the separated fibers. In certain such embodiments, the compounds, compositions, materials and, or monomers are combined with the fibers in a solvent to form a mixture.

In some embodiments, the compounds, compositions, materials, or monomers are combined with the pulp and/or fibers in excess, e.g., a compound or monomer to pulp/fiber weight ratio of at least 2:1, 3:1, 4:1, 5:1, 6:1, 7:1, 8:1, 9:1, or 10:1. In some embodiments, the compounds, compositions, materials, or monomers are combined with the pulp and/or fibers in a ratio between 1:1 and 2:1. In some embodiments, the compounds, compositions, materials, or monomers are combined with the pulp and/or fibers in a ratio between 1:1 and 1:2. In some embodiments, the compounds or monomers are combined with an excess of pulp/fiber, e.g., in a compound or monomer to pulp/fiber weight ratio of at least 1:2, 1:3, 1:4, 1:5, 1:6, 1:7, 1:8, 1:9, 1:10, 1:20, 1:30, 1:40, 1:50, 1:60, 1:70, 1:80, 1:90, 1:100, 1:250 1:500, 1:750, or 1:1000. In some embodiments, the solvent is water, an alcohol, an ester, an ether, an amide, an amine, a ketone, a sulfoxide, a hydrocarbon, or any combination thereof. The mixture can then be agitated to ensure that the compounds, compositions, or monomers are uniformly mixed with, and sufficiently become associated with the fibers present in the mixture. The resulting mixture can then be subjected to traditional paper making methods, i.e., pressing and drying to form the paper/paper product, or textile making methods, i.e., removing the solvent, and weaving the fibers to form a textile, or other fiber-based material.

In some embodiments, the fibers are combined with a solution of monomers according to this disclosure to form a mixture. The mixture can optionally be agitated to ensure uniform mixing, and sufficient association of the monomers with the fibers in solution. The mixture can then be used in traditional paper making steps (e.g., pressing and drying) or textile or other fiber-based material making steps (e.g., fiber weaving) to form a textile, paper, or other fiber-based product. In some embodiments, the at least a majority of the solvent is removed from the mixture to form a material. The solvent can be removed according to methods known to those skilled in the art, e.g., by filtering, drying, heating, evaporation, forced convection, or any combination thereof. In some embodiments, the material is further heated to induce polymerization of the monomers remaining on the material to cause an association of polymerized monomers with the fiber-based material. In some embodiments, the mixture is subsequently heated after about 50% to 100% of the solvent by volume has been removed. In some embodiments, the mixture is subsequently heated after at least about 50%, 55%, 60%, 65%, 70%, 75%, 80%, 85%, 90%, 95%, 96%, 97%, 98%, 99%, or 100% by volume of the solvent has been removed. In certain such embodiments, the mixture is heated to at least 100° C. In some embodiments, the mixture is heated to at least 110° C., 120° C., 130° C., 140° C., 150° C., 160° C., 170° C., 180° C., 190° C., 200° C., 210° C., 220° C., or 230° C. In certain embodiments, the mixture is heated to at least 140° C. In one or more embodiments, the mixture is heated for at least 5 minutes. In some embodiments, the mixture is heated for at least 5 minutes, 10 minutes, 15 minutes, 20 minutes, 25 minutes, 30 minutes, 35 minutes, 40 minutes, 45 minutes, 50 minutes, 55 minutes, 1 hour, 1.5 hours, 2 hours, 2.5 hours, or 3 hours.

In another aspect, this disclosure is directed to a method of producing a packaging material, a textile, or other fiber-based product comprising fibers associated with polymerized monomers, the method comprising:
a. obtaining a slurry comprising fibers and a solvent;
b. adding one or more monomers according to this disclosure to the slurry to form a mixture;
c. polymerizing the monomers; and
d. removing a majority of the solvent to produce the packaging, paper, textile, or other fiber-based material.

In some embodiments, the fibers are combined with a solution of monomers according to this disclosure to form a mixture. The mixture can optionally be agitated to ensure uniform mixing of, and sufficient association of the fibers with the monomers. Subsequently, the mixture can be heated to induce polymerization of the monomers. In certain such embodiments, the mixture is heated to at least 100° C., e.g., 110° C., 120° C., 130° C., 140° C., 150° C., 160° C., 170° C., 180° C., 190° C., 200° C., 210° C., 220° C., or 230° C. In a certain embodiment, the mixture is heated to at least 140° C. In some embodiments, the mixture is heated to at least 175° C. The mixture containing the fibers and polymerized monomers is subsequently used in traditional paper making steps (e.g., pressing and drying) or textile or other fiber-based material making steps (e.g., fiber weaving) to form the final textile, paper, or other fiber-based product. In some embodiments, the majority of the solvent, e.g., at least about 90%, 99%, or 100% by volume of the solvent, is removed using methods known to those skilled in the art, e.g., by filtering, drying, heating, evaporation, forced convection, or any combination thereof. In some embodiments, at least 90%, 99%, or 100% by volume of the solvent is removed using methods known to those skilled in the art, e.g., by filtering, drying, heating, evaporation, forced convection, or any combination thereof.

The fibers, textiles, paper, packaging, or other fiber-based materials that have been contacted with the compounds, monomers, or compositions described herein can further be treated with the compounds, monomers, or compositions described herein to form additional layers (i.e., coatings) on the surface of the fiber, textile, paper, packaging, or other fiber-based material. For example, a fiber, textile, paper, packaging, or other fiber-based material that has been associated with one or more polymerized monomers described herein can further be contacted with one or more compounds, monomers, or compositions described herein (e.g., one or more glyceryl esters of fatty acids (e.g., 1-monoglycerides, 2-monoglycerides, diglycerides, and triglycerides), fatty acids, fatty acid salts, fatty acid esters, compounds of Formula IA, Formula IIA, or any combination thereof) to form one or more additional coatings on the fiber, textile, paper, packaging, or other fiber-based material. In some embodiments, fibers, textiles, paper, packaging, or other fiber-based materials that are associated with one or more polymerized monomers described herein are further treated with one or more compounds of Formula IA. In some embodiments, the one or more compounds of Formula IA are monoglycerides. In some embodiments, the fibers, textiles, paper, packaging, or other fiber-based materials are characterized by a base layer of polymerized monomers, and one or more additional layers comprising one or more compounds of Formula IA (e.g., one or more monoglycerides). In some embodiments, the additional coating further comprises a fatty acid salt. In some embodiments, the fibers, textiles, paper, packaging, or other fiber-based materials are characterized by a base layer (i.e., coating) of polymerized monomers, and one or more additional coatings comprising one or more polymerized monomers. In certain such embodiments, the base coating and the one or more additional coatings comprise the same polymerized monomer or a different polymerized monomer. In some embodiments, the one or more additional coatings comprise more than one additional coating of polymerized monomers. In some embodiments, the one or more additional coatings comprise more than one additional coating of one or more compounds of Formula IA (e.g., one or more monoglycerides). In some embodiments, the one or more additional coatings comprise one or more additional coatings of polymerized monomers and one or more additional coatings of one or more compounds of Formula IA (e.g., one or more monoglycerides).

The properties of the fiber-based materials according to this disclosure can be tuned based on the number of the additional coatings that are used. For example, fiber-based materials that are characterized by 5 additional coatings will have stronger barrier properties than the same fiber-based material that is characterized by 1 additional coating.

In some embodiments, the methods according to this disclosure further comprise applying one or more additional coatings to the fibers, textile, paper, packaging, or other fiber-based materials according to this disclosure. In some embodiments, the additional coatings comprise one or more compounds described herein. The additional coatings can be applied according to methods known to those skilled in the art. For example, the one or more compounds described herein (e.g., one or more glyceryl esters of fatty acids (e.g., 1-monoglycerides, 2-monoglycerides, diglycerides, and triglycerides), fatty acids, fatty acid salts, fatty acid esters, compounds of Formula IA, Formula IIA, or any combination thereof) can be dissolved, suspended, or dispersed in a solvent to form a mixture. The solvent can be water, an alcohol, an ester, an ether, an amide, an amine, a ketone, a sulfoxide, or a hydrocarbon, or any combination thereof. The mixture can then be applied to the surface of the fibers, textile, paper, packaging, or other fiber-based material, for example, by spraying, aerosol spraying, brushing, dripping, dropcasting, rolling, dabbing, or pouring the mixture on the surface of the fibers, textile, paper product, packaging, or other fiber-based material. Alternatively, the textile, paper product, packaging, or other fiber-based material can be dipped, soaked, or submerged in the solution. After the mixture has been applied to the surface of the fibers, textile, paper product, packaging, or other fiber-based material, the solvent can subsequently be removed thereby forming an additional coating on the surface of the fibers, textile, paper product, packaging, or other fiber-based material. The solvent can be removed by drying, heating, evaporation, forced convection, or any methods known to those skilled in the art. In some embodiments, the one or more additional coatings comprises one or more compounds of Formula IA. In some embodiments, the one or more compounds of Formula IA comprise one or more fatty acids or fatty acid esters (e.g., 1-monoglycerides, 2-monoglycerides, etc.). In some embodiments, the one or more additional coatings comprise a first compound of Formula IA and one or more second compounds of Formula IA. In some embodiments, the first compound of Formula IA has a different carbon chain length than one or more of the second compounds of Formula IA. In some embodiments, the one or more additional coatings comprise one or more fatty acids. In some embodiments, the one or more additional coatings comprises one or more monoglycerides. In some embodiments, the one or more additional coatings further comprise a fatty acid salt. In some embodiments, the one or more additional coatings comprise one or more polymerized monomers described herein.

### Materials of the Disclosure

The compounds, compositions, materials and monomers described herein are combined with fibers in order to form materials with desirable properties. In some embodiments, materials comprising the fibers associated with the compounds and/or polymerized monomers according to this disclosure are useful in a variety of consumer products, e.g., textiles, paper products, and packaging materials. In some embodiments, this disclosure is directed to a packaging or other fiber-based material comprising one or more fibers associated with one or more compounds described herein, such as one or more glyceryl esters of fatty acids (e.g., 1-monoglycerides, 2-monoglycerides, diglycerides, and triglycerides), fatty acids, fatty acid salts, fatty acid esters, compounds of Formula IA, Formula IIA, or any combination thereof, where Formula IA includes Formula IA-A-i, Formula IA-A-ii, and Formula IA-B. In another embodiment, this disclosure is directed to a packaging material comprising one or more fibers associated with one or more polymerized monomers described herein. In one or more embodiments, the materials are further characterized by at least one outer layer comprising one or more compounds according to this disclosure, such as one or more glyceryl esters of fatty acids (e.g., 1-monoglycerides, 2-monoglycerides, diglycerides, and triglycerides), fatty acids, fatty acid salts, fatty acid esters, compounds of Formula IA, Formula IIA, or any combination thereof, where Formula IA includes Formula IA-A-i, Formula IA-A-ii, and Formula IA-B. In one or more embodiments, the fibers are nylon, polyester, polyethylene, polypropylene, polycarbonates, polyamides, or cellulose fibers. In one or more embodiments, the fibers are cellulose fibers. In some embodiments, this disclosure is directed to packages or other products made from the fiber-based materials, e.g., packages or textiles.

The materials according to the disclosure comprise one or more fibers that are associated with a compound and/or polymerized monomers according to this disclosure. The fibers can be associated to the compounds or polymerized monomers through physical adsorption i.e., non-covalent interactions (e.g., Van der Waals interactions, hydrogen bonding, and/or electrostatic interactions), chemical adsorption, i.e., covalent interactions (e.g., covalent bonds and ionic bonds), or associated by proximity, i.e., present within the same material. In some embodiments, the compounds and/or polymers according to this disclosure form covalent bonds with the fibers.

The materials according to this disclosure can also be associated with the fibers by intercalating them with the one or more compounds, and/or the one or more polymerized monomers described herein. Alternatively, the materials according to this disclosure can comprise an inner layer of fibers and an outer layer of the one or more compounds, and/or one or more polymerized monomers described herein. In some embodiments, the base layer of the materials described herein (i.e., the fibers associated with the one or more compounds or the one or more polymerized monomers) serves as a scaffold that allows for the application of one or more additional layers (i.e., coatings). Without wishing to be bound by theory, the base layer according to this disclosure makes the fibers, textile, paper, packaging, or other fiber-based material more amenable to being further associated with one or more additional coatings according to this disclosure. For example, the one or more compounds or the one or more polymerized monomers present in the base layer of the materials described herein provides a surface that one or more additional layers (i.e., coatings) can adhere to. Without wishing to be bound by theory, adherence of one or more additional coatings to the base layer comprising the one or more compounds or the one or more polymerized monomers described herein is stronger than adherence of one or more additional coatings to a base layer that does not comprise the one or more compounds or the one or more polymerized monomers according to this disclosure. Accordingly, this disclosure provides materials (e.g., fibers, textiles, paper, packaging, or other fiber-based products) whose properties can be more easily tuned through the application of one or more additional layers (i.e., coatings), having one or more desirable properties, than materials lacking the base layer described herein.

The properties of the materials according to this disclosure can be tuned based on the identity of the one or more compounds or polymerized monomers described herein, or based on the one or more additional coatings applied to or associated with the base layers described herein. Accordingly, the materials of this disclosure can be hydrophobic, hydrophilic, lipophilic, lipophobic, omniphobic, gas impermeable, grease impermeable, oil impermeable, gas resistant, grease resistant, oil resistant, or any combination thereof. The hydrophilicity, hydrophobicity, lipophobicity, and lipophobicity of the material according to this disclosure can be measured according to methods known to those skilled in the art, e.g., by measuring the contact angle of that material. For the purposes of this disclosure, a contact angle of water on the material less than 50 (e.g. less than 45°, less than 40°, less than 35°, less than 30°, less than 20°, or less than 10°) means that the material is hydrophilic, and a contact angle of water on the material greater than 500 (e.g. greater than 60°, greater than 70°, greater than 80°, greater than 90°, greater than 100°, or greater than 110°) on a material means the material is hydrophobic. In some embodiments, the materials according to this disclosure are hydrophobic, i.e., have a contact angle of water on the material greater than 500 greater than 60°, greater than 70°, greater than 80°, greater than 90°, greater than 100°, or greater than 110°. In some embodiments, the materials according to this disclosure are hydrophilic, i.e., have a contact angle of water on the material less than 50°, less than 45°, less than 40°, less than 35°, less than 30°, less than 20°, or less than 10°. For the purposes of this disclosure, a contact angle of oil (e.g. plant-based oil) on the material less than 50 (e.g. less than 45°, less than 40°, less than 35°, less than 30°, less than 20°, or less than 10°) means that the material is lipophilic, and a contact angle of oil on the material greater than 500 (e.g. greater than 60°, greater than 70°, greater than 80°, greater than 90°, greater than 100°, or greater than 110°) on a material means the material is lipophobic. In some embodiments, the materials according to this disclosure are oil repellant (lipophobic), i.e., have a contact angle of oil on the material greater than 500 greater than 60°, greater than 70°, greater than 80°, greater than 90°, greater than 100°, or greater than 110°. In some embodiments, the materials according to this disclosure are not oil repellant (lipophilic), i.e., have a contact angle of oil on the material less than 50°, less than 45°, less than 40°, less than 35°, less than 30°, less than 20°, or less than 10°. In some embodiments, the materials according to this disclosure are omniphobic, i.e., have a contact angle of oil on the material and a contact angle of water on the material greater than 50°, greater than 60°, greater than 70°, greater than 80°, greater than 90°, greater than 100°, or greater than 110°. In some embodiments, the degree of hydrophobicity, hydrophilicity, lipophilicity, and/or lipophobicity of the fiber-based materials according to this disclosure is modified compared to the same fiber-based material that is not associated with the monomers, compounds, compositions, or coatings described herein. In some embodiments, the degree of hydrophobicity, hydrophilicity, lipophilicity, and/or lipophobicity of the fiber-based materials according to this disclosure is increased compared to the same fiber-based material that is not associated with the monomers, compounds, compositions, or coatings described herein. In some embodiments, the degree of hydrophobicity, hydrophilicity, lipophilicity, and/or lipophobicity of the fiber-based materials according to this disclosure is decreased compared to the same fiber-based material that is not associated with the monomers, compounds, compositions, or coatings described herein.

In some embodiments the fiber-based materials comprising one or more fibers associated with one or more compounds or polymerized monomers according to this disclosure (the “treated material”) have reduced water absorption and/or oil or grease absorption compared to materials made with the same fibers in the absence of the one or more compounds or polymerized monomers described herein. The water and/or oil absorption can be measured according to methods known to those skilled in the art, e.g., using visual inspection or the Cobb test. One example of visual inspection includes disposing an amount of oil on treated material described herein and observing whether the oil penetrates the treated material (e.g., is visible from a side of the treated material opposite the side on which the oil is disposed) in a certain amount of time (e.g., 60 minutes). Oil that penetrates the treated material is typically visible as a dark spot on the side of the treated material opposite the side on which the oil is disposed. The oil can be heated (e.g., to 90° C.) before it is applied to the treated material In some embodiments, the water and/or oil absorption of the materials described herein is between 50% to 100%, e.g., at least about 55%, 60%, 65%, 70%, 75%, 80%, 85%, 90%, 91%, 92%, 93%, 94%, 95%, 96%, 97%, 98%, 99%, or 100% by mass less than the water and/or oil absorption of materials made with the same fibers in the absence of the one or more compounds or polymerized monomers described herein.

The textile, paper, packaging, or other fiber-based material making process can result in porous materials. Pores present in the materials can make it difficult to tune the properties of those materials. For example, coatings applied to the surface of textiles, paper, packaging, or other fiber-based materials may not sufficiently fill the pores present in those materials, resulting in vulnerable sections of the material. Such vulnerable sections can counteract any beneficial properties that the coating is intended to provide to the material. For example, if a coating is applied to a textile, paper, packaging, or other fiber-based material that is intended to reduce the water absorptivity of the material, the pores present in the material can serve as a point of vulnerability wherein water absorption is more likely to occur. Without wishing to be bound by theory, the methods according to this disclosure that involve associating the compounds or monomers with fibers during the manufacturing process of the textile, paper, packaging, or other fiber-based material result in materials wherein the compounds, or polymerized monomers serve to fill the pores that typically characterize textile, paper, packaging, or other fiber-based materials. Accordingly, the methods according to the disclosure reduce areas of vulnerability in textiles, paper, packaging, or other fiber-based materials, and result in materials whose properties are more easily tuned.

### EQUIVALENTS

The foregoing description and following examples detail certain specific embodiments of the disclosure and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

Cobb tests described herein were conducted according to TAPPI T441 on a GURLEY Cobb Sizing Tester available from Thwing-Albert Instrument Company. During each test, liquid (deionized water or vegetable oil heated to 100° C.) was poured into a cylinder covering a 10 cm² filter paper or wax paper sample (previously weighed). The sample was held in place and allowed to sit for 2 minutes. After 2 minutes, the liquid was decanted, and each sample was pressed between 2 sheets of blotting paper (AX05022) with a 10 kg roller (rolled over twice: back and forth) to remove excess liquid. The samples were then weighed, and the initial weight was subtracted from the final weight, giving the absorptivity for the liquid.

Filter paper substrates were from Whatman, 110 mm diameter and 160 m thickness. Ratios of components (e.g., 95:5) are weight ratios. “Coating Standard” refers to an aqueous solution of 95:5 weight ratio mixture of monoglycerides to SA-Na, where the monoglycerides are about a 9:1 ratio of SA-1G to PA-1G. Unless specified otherwise, a concentration of the Coating Standard is 50 g/L.

### Example 1: Effect of the Compounds of the Disclosure on Water Absorption of Cardboard

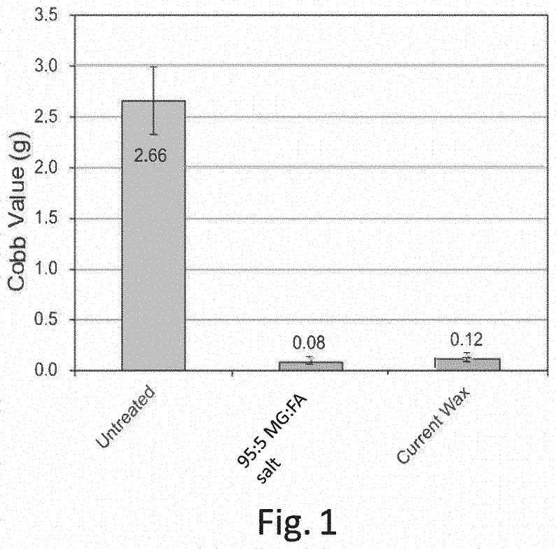

1 L of the Coating Standard was added to 10 g of paper pulp. The mixture was then blended for 30 minutes, and then pressed into cardboard, and allowed to dry at ambient temperature for 48 hours. A Cobb test was subsequently performed on the resulting cardboard material to determine its water absorptivity compared to untreated cardboard (made from the same pulp), and that of cardboard treated with commercially available wax. The results demonstrated that the material treated with the 95:5 mixture of monoglycerides to fatty acid salt absorbed significantly less water than the untreated cardboard (2.58 g less), and less water than the wax treated cardboard (0.04 g less) (FIG. 1).

### Example 2: Contact Angle and Gas Permeation of Paper Substrates Treated with Compounds of This Disclosure

Using a pipette, 1 mL of an aqueous solution containing 50 g/L of 10,16-dihydroxypalmitic acid (10,16-DHIPA) or 1 mL of the Coating Standard was dropcast onto filter paper substrates (Whatman filter paper, 110 mm diameter, 160 m thickness) in a volume sufficient to coat the entirety of and fully wet the substrates. The paper samples were dried under ambient conditions to dryness. Contact angle and gas permeability of treated and untreated paper samples were measured. Gas permeability was measured by using a flow cell to provide a gas comprising carbon dioxide and ethylene to a first side of the sample, sampling the gas on a second side of the sample, and measuring the concentration (ppm) of the carbon dioxide and ethylene of the sampled gas with a Micro gas chromatograph.

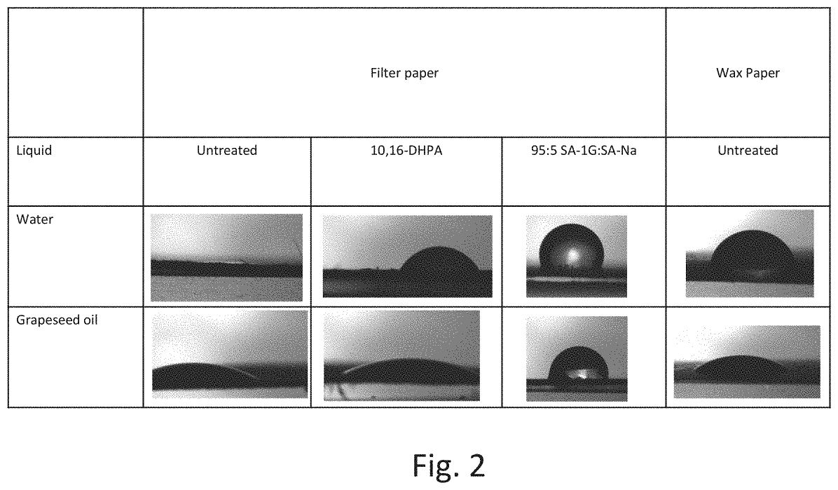

The contact angle experiments were conducted on the filter paper samples with water and grapeseed oil with a DSA25S KRUSS Scientific goniometer. FIG. 2 shows images of drops of water and grapeseed oil on untreated filter paper, filter paper treated with a 50 g/L solution of 10,16-dihydroxypalmitic acid (10,16-DHPA), and 10,16-dihydroxypalmitic acid (10,16-DHPA) followed by the Coating Standard. The images show that treatment of the paper substrates with the Coating Standard resulted in an omniphobic material, i.e., both hydrophobic and lipophobic, and treatment of the paper substrates with 10,16-DHPA increased the hydrophobicity of filter paper but had minimal impact on the lipophobicity. The repellency shown by the images in FIG. 2 is summarized qualitatively in Table 1.

TABLE 1
Liquid repellency of samples shown in FIG. 2

| | | Filter paper | | | Wax |
|---|---|---|---|---|---|
| | | | 10,16- | Coating | paper |
| Function | | Untreated | DHPA | Standard | Untreated |
| Liquid | Oil | × | × | ✓✓ | × |
| repellency | Water | × | ✓ | ✓✓ | ✓ |

✓ - slight change
✓✓- significant change
× - minimal to no change

### Example 3: Contact Ange and Gas Permeability of Paper Substrates Containing Polymerized Monomers

Using a pipette, 0.5 mL of an aqueous solution containing 50 g/L 10,16-dihydroxypalmitic acid (10,16-DHPA) was dropcast onto four paper substrates (two filter paper substrates and two wax paper substrates) to coat the entirety of the substrates. All four samples were then dried at 149° C. for ˜20 minutes to induce polymerization of 10,16-DHPA. Next, to one of the filter paper samples and one of the wax paper samples, 1 mL of the Coating Standard was dropcast onto the surface of the samples. The samples kept at ambient conditions until dry to the touch before measuring contact angle and gas permeability compared to untreated samples of filter paper and wax paper.

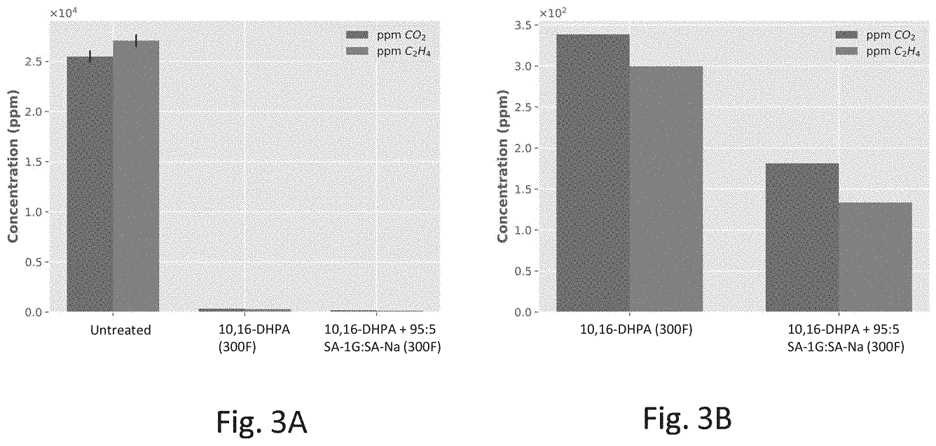

Gas permeation experiments with CO₂ and ethylene were conducted on all four samples, as well as untreated filter paper substrate and untreated wax paper substrate. FIG. 3A shows permeability of untreated wax paper, wax paper treated with 10,16-DHPA, and wax paper treated with the Coating Standard to CO₂ and ethylene (left bar and right bar of each pair, respectively). FIG. 3B shows an enlarged view of the treated samples in FIG. 3A (10² scale in FIG. 3B versus 10⁴ scale in FIG. 3A). The results demonstrate that wax paper samples containing polymerized 10,16-DHPA have dramatically reduced gas permeability compared to untreated wax paper, with the effect being enhanced for the sample further coated with the Coating Standard.

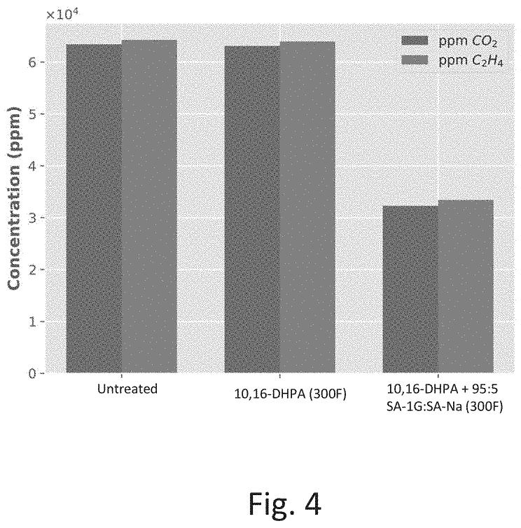

FIG. 4 is a chart depicting the gas permeability of the untreated filter paper, the filter paper sample containing polymerized 10,16-DHPA, and the filter paper sample containing polymerized 10,16-DHPA and a coating of the Coating Standard to CO₂ and ethylene (left bar and right bar of each pair, respectively). The filter paper sample containing polymerized 10,16-DHPA did not demonstrate significantly reduced gas permeability compared to the untreated filter paper sample. The filter paper sample containing polymerized 10,16-DHPA further coated with the Coating Standard demonstrated reduced gas permeability.

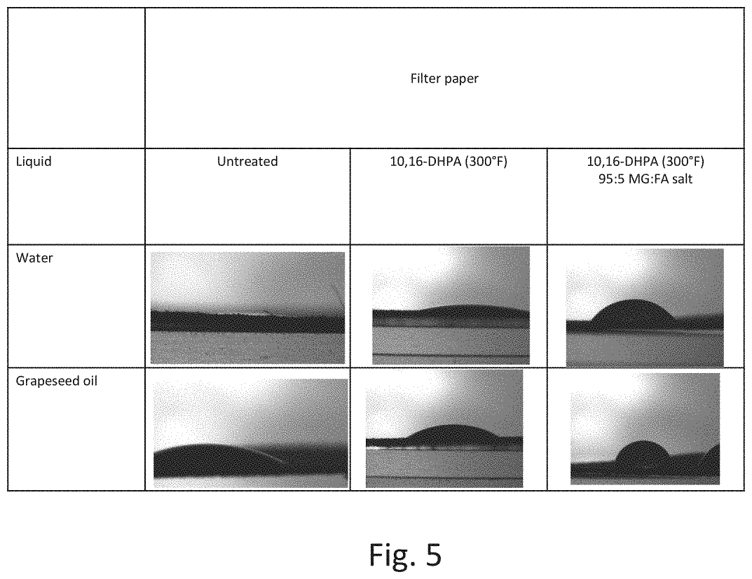

Contact angle experiments were conducted with water and grapeseed oil on the filter paper and wax paper samples. FIG. 5 shows images of drops of water and grapeseed oil on untreated filter paper, filter paper containing polymerized 10,16-DHPA, and filter paper containing polymerized 10,16-DHPA and a coating of the Coating Standard. The images show that treating the filter paper with 10,16-DHPA and drying at high temperature (e.g., between 160° C. and 220° C.) to induce polymerization did not have a substantial impact on the water or oil repellency (i.e., hydrophobicity or lipophilicity) of the filter paper. The filter paper sample further coated with the Coating Standard demonstrated enhanced hydrophobicity and lipophobicity compared to an untreated sample. The repellency shown by the images in FIG. 5 is summarized qualitatively in Table 2. The results for the wax paper samples are shown in Table 3.

TABLE 2
Liquid repellency of samples shown in FIG. 5

| | | Filter Paper | | |
|---|---|---|---|---|
| | | | 10,16- | 10,16-DHPA |
| | | | DHPA | (149° C.) + Coating |
| Function | | Untreated | (149° C.) | Standard |
| Gas barrier | | × | × | ✓ |
| Liquid repellency | Oil | × | × | ✓ |
| | Water | × | × | ✓ |

✓ - slight change
× - minimal to no change

TABLE 3
Properties of untreated and treated samples of filter paper

| | | Filter Paper | | |
|---|---|---|---|---|
| | | | 10,16- | 10,16-DHPA |
| | | | DHPA | (149° C.) + Coating |
| Function | | Untreated | (149° C.) | Standard |
| Gas barrier | | * | ✓✓ | ✓✓ |
| Liquid repellency | Oil | × | × | × |
| | Water | * | ✓ | ✓ |

* - as compared to filter paper, wax paper has a higher gas barrier and water repellency
✓ - slight change
× - minimal to no change

### Example 4: Effect of Deposition on Gas Permeability

10 mL of a 10 g/L ethanol solution of 10,16-dihydroxypalmitic acid (10,16-DHPA) was aerosol sprayed onto the surface of filter paper and wax paper substrates. The paper samples were then heated to 149° C. for 5 minutes to polymerize the monomers. Next, the Coating Standard (40 g/L) was subsequently aerosol sprayed to the surface of the paper samples. The samples were allowed to dry under ambient conditions to dryness (˜5 hours).

10 mL of a 50 g/L ethanol solution of 10,16-dihydroxypalmitic acid (10,16-DHPA) was dropcast onto the surface of filter paper and wax paper substrates. The resulting paper samples were then heated to 149° C. for 20 minutes to polymerize the monomers. Next, the Coating Standard was subsequently dropcast onto the surface of the paper samples. The samples were allowed to dry under ambient conditions to dryness (˜5 hours).

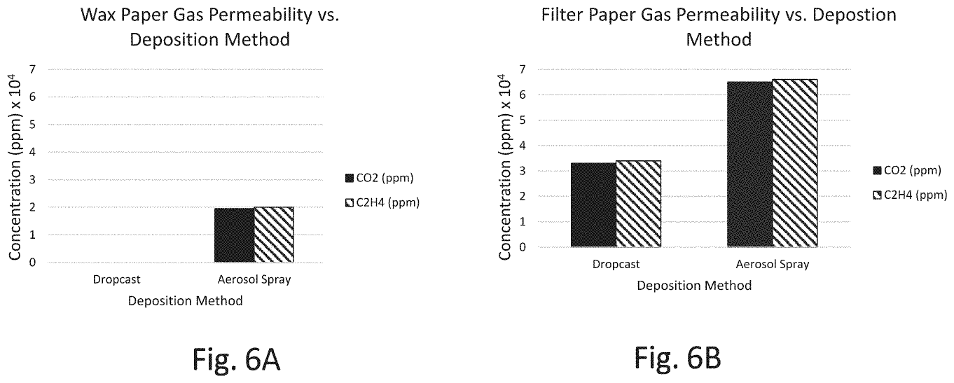

The gas permeability of all four paper samples was next evaluated using CO₂ and ethylene gas. FIGS. 6A and 6B are charts depicting the effect of the deposition method on the gas permeability of wax and filter paper samples, respectively. The results demonstrate that the gas permeability of both the filter paper and wax paper samples was dramatically reduced when the coatings were dropcast onto the surface of the substrates compared to aerosol application. The gas permeabilities shown in FIGS. 6A and 6B are summarized qualitatively in Table 4.

TABLE 4
Gas permeability of wax paper containing polymerized monomers

| | Wax Paper | | |
|---|---|---|---|
| | | 10,16- | 10,16-DHPA |
| | | DHPA | (149° C.) + Coating |
| Function | UT | (149° C.) | Standard |
| Gas barrier | * | ✓✓ | ✓✓ |

* - A property exhibited by untreated wax paper
✓- slight change
✓✓- significant change
× - minimal to no change

### Example 5: Effect of Polymerization Temperature on Gas Permeability of Wax Paper

A 10 g/L ethanol solution of 10,16-dihydroxypalmitic acid (10,16-DHPA) was aerosol sprayed onto the surface of two wax paper substrates. One of the samples was then heated to 149° C. for 5 minutes to polymerize the monomers. The other was heated to 177° C. for 5 minutes. Next, the Coating Standard (40 g/L) was subsequently aerosol sprayed to the surface of both paper samples. The samples were allowed to dry under ambient conditions to dryness (˜5 hours).

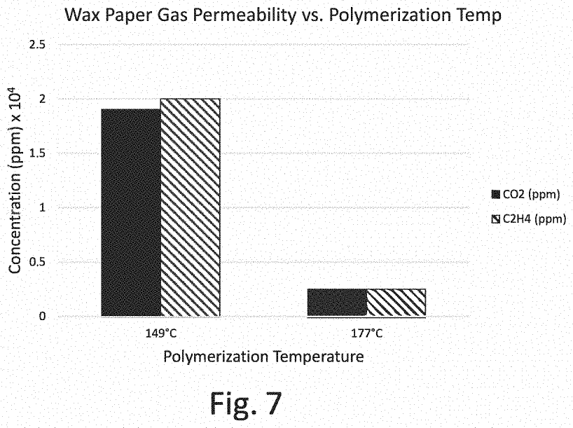

The gas permeability of the paper samples was next evaluated using CO₂ and ethylene gas. FIG. 7 is a chart depicting the effect of polymerization temperature on the gas permeability of wax paper substrates. The results demonstrate that the gas permeability of the paper samples was dramatically reduced when the heating temperature was increased from 149° C. to 177° C.

### Example 6: Effect of Number of Coating Layers on the Gas Permeability of Wax Paper

A 10 g/L ethanol solution of 10,16-dihydroxypalmitic acid (10,16-DHPA) was aerosol sprayed onto the surface of two wax paper substrates and two filter paper substrates. The samples were then heated to 149° C. for 5 minutes to polymerize the monomers. Next, the Coating Standard (40 g/L) w was subsequently aerosol sprayed to the surface of all four paper samples. The samples were allowed to dry under ambient conditions to dryness (˜24 h). To one of the wax paper samples and one of the filter paper samples, this process was repeated four additional times to form paper samples with 5 layers of polymerized monomers and 5 layers of the 40 g/L Coating Standard.

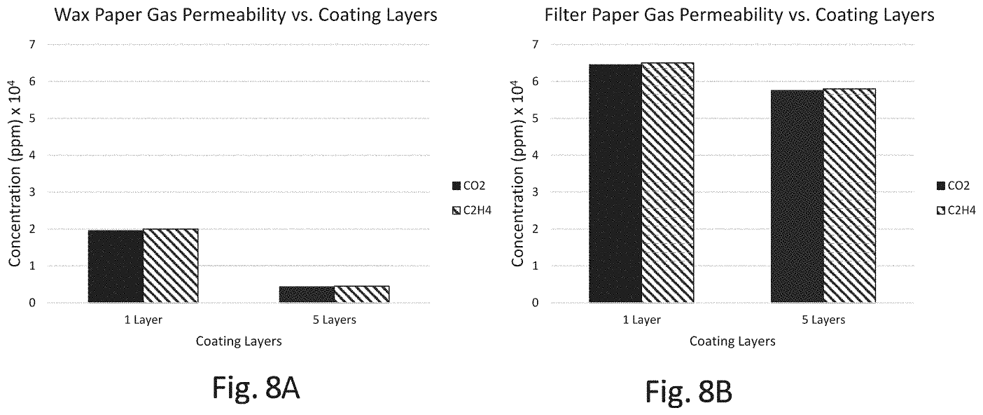

The gas permeability of the wax paper samples and the filter paper samples was next evaluated using CO₂ and ethylene gas. FIGS. 8A and 8B are charts depicting the effect of the number of coating layers (1 layer and 5 layers) on the gas permeability of wax and filter paper substrates, respectively. The results demonstrate that the gas permeability was reduced for the wax paper samples and filter paper samples that were coated 5 times compared to the samples that were coated 1 time.

### Example 7: Omniphobicity of Coated Samples

Filter paper samples were weighed, then dunked in a treatment solution, held to allow excess solution to drip off, then placed on foil. The treatment solution included various weight ratios of monoglyceride (9:1 SA-1G to PA-1G) and fatty acid salt (SA-Na) in water, with a total concentration of 50 g/L. The foil was put in an oven at 35° C. for 2 hours until the samples were fully dry (visually appeared dry and felt dry to the touch). Samples were weighed before and after coating to get grammage of coating added before performing a Cobb test as described above. Table 5 shows absorptivity results for Samples 1-4, having a 95:5, 90:10, 80:20, and 70:30 weight ratio of monoglyceride to fatty acid salt. Table 6 shows coating parameters for Samples 5-12, having a 95:5, 90:10, 80:20, and 70:30 weight ratio of monoglyceride to fatty acid salt. Table 7 shows Cobb test results (water) for Samples 5, 7, 9, and 11. Table 8 shows Cobb test results (oil) for Samples 6, 8, 10, and 12. The data shows that samples with the monoglyceride to fatty acid salt weight ratio of 80:20 and 70:30 to be omniphobic.

TABLE 5
Absorptivity tests for oil and water for Samples 1-4

| | | Conc. | Init. | Fin. | Δ | % | | Oil | Water |
|---|---|---|---|---|---|---|---|---|---|
| Sample | Formulation | (g/L) | mass (g) | mass (g) | mass | change | g/m² | drop | drop |
| 1 | 95:5 wt. ratio | 50 | 0.5855 | 0.6499 | 0.0644 | 11.00 | 10.12 | Low pass | Fail |
| 2 | 90:10 wt. ratio | 50 | 0.5864 | 0.6645 | 0.0781 | 13.32 | 12.28 | Low pass | Fail |
| 3 | 80:20 wt. ratio | 50 | 0.5812 | 0.6461 | 0.0649 | 11.17 | 10.20 | Pass | Pass |
| 4 | 70:30 wt. ratio | 50 | 0.5724 | 0.6383 | 0.0659 | 11.51 | 10.36 | Pass | Pass |

TABLE 6
Coating parameters for Samples 5-8

| | | Con. | Initial | Final | Δ | % | |
|---|---|---|---|---|---|---|---|
| Sample | Formulation | (g/L) | mass (g) | mass (g) | mass | change | g/m² |
| 5 | 95/5 wt. ratio | 50 | 0.5794 | 0.6171 | 0.0377 | 6.51 | 5.93 |
| 6 | 95/5 wt. ratio | 50 | 0.5799 | 0.631 | 0.0511 | 8.81 | 8.03 |
| 7 | 90/10 wt. ratio | 50 | 0.5853 | 0.6458 | 0.0605 | 10.34 | 9.51 |
| 8 | 90/10 wt. ratio | 50 | 0.568 | 0.6364 | 0.0684 | 12.04 | 10.75 |
| 9 | 80/20 wt. ratio | 50 | 0.5865 | 0.652 | 0.0655 | 11.17 | 10.30 |
| 10 | 80/20 wt. ratio | 50 | 0.5646 | 0.6099 | 0.0453 | 8.02 | 7.12 |
| 11 | 70/30 wt. ratio | 50 | 0.5683 | 0.63 | 0.0617 | 10.86 | 9.70 |
| 12 | 70/30 wt. ratio | 50 | 0.573 | 0.6359 | 0.0629 | 10.98 | 9.89 |

TABLE 7
Cobb test results (water) for Samples 1, 3, 5, and 7

| | Initial | Final | Water | Absorptivity | Visual |
|---|---|---|---|---|---|
| Sample | mass (g) | mass (g) | absorbed (g) | (g/m²) | Pass/Fail |
| 5 | — | — | — | — | FAIL |
| | | | | | immediately |
| 7 | — | — | — | — | FAIL |
| | | | | | immediately |
| 9 | 0.652 | 0.6805 | 0.0285 | 28.5 | Pass |
| 11 | 0.63 | 0.6694 | 0.0394 | 39.4 | Pass |

TABLE 8
Cobb test results (oil) for Samples 2, 4, 6, and 8

| | Initial | Final | Oil | Absorptivity | Visual |
|---|---|---|---|---|---|
| Sample | mass (g) | mass (g) | absorbed (g) | (g/m²) | Pass/Fail |
| 6 | 0.631 | 0.6692 | 0.0382 | 38.2 | Pass |
| 8 | 0.6364 | 0.651 | 0.0146 | 14.6 | Pass |
| 10 | 0.6099 | 0.6511 | 0.0412 | 41.2 | Pass |
| 12 | 0.6359 | 0.6605 | 0.0246 | 24.6 | Pass |

TABLE 9
Oil absorptivity results

| Sample | Absorptivity (g/cm²) |
|---|---|
| Untreated | 0.0302 |
| Coating Standard | 0.0188 |
| 10,16-DHPA | 0.0264 |
| PFAS-free control | 0.0497 |
| PFAS-free + 10,16-DHPA + Coating Standard | 0.00331 |
| PLA laminate | 0.00853 |
| PBAT laminate | 0.00346 |

TABLE 10
Water vapor transmission rates for various
thermoformed samples

| Sample | WVTR (mg/min) |
|---|---|
| AKD in slurry | 1.3 |
| 10,16-DHP Ain slurry | 1.5 |
| AKD in slurry + 5 coats | 0.9 |
| Coating Standard | |
| 10,16-DHPA in slurry + 5 | 1.0 |
| coats Coating Standard | |

### Example 8: Oil Absorptivity of Packaging Samples

The oil absorptivity of perfluoroalkyl substance (PFAS)-free and alkyl ketene dimer (AKD)-free switchgrass fiber thermoformed paper products were tested. A single coating of the Coating Standard was applied as a post-processing spray to the paper products, and the samples were allowed to air dry for 24 hours. Samples coated with 1 wt % 10,16 DHPA in water were heat pressed at 200° C. for 60 seconds. A Cobb test was performed with oil as described above. Oil absorptivity results are shown in Table 9.

### Example 9: Oil Absorptivity on Paper Plates

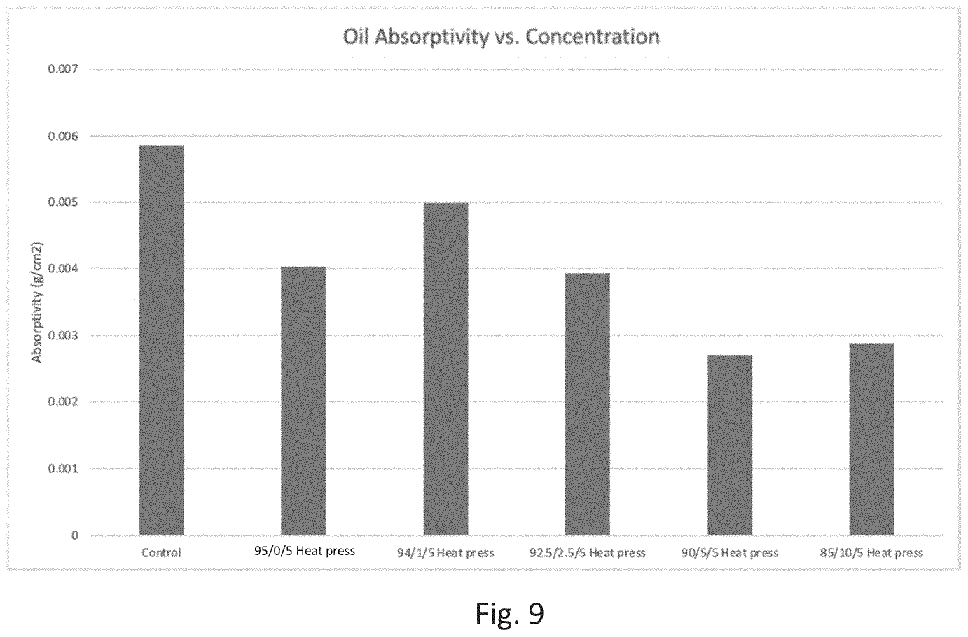

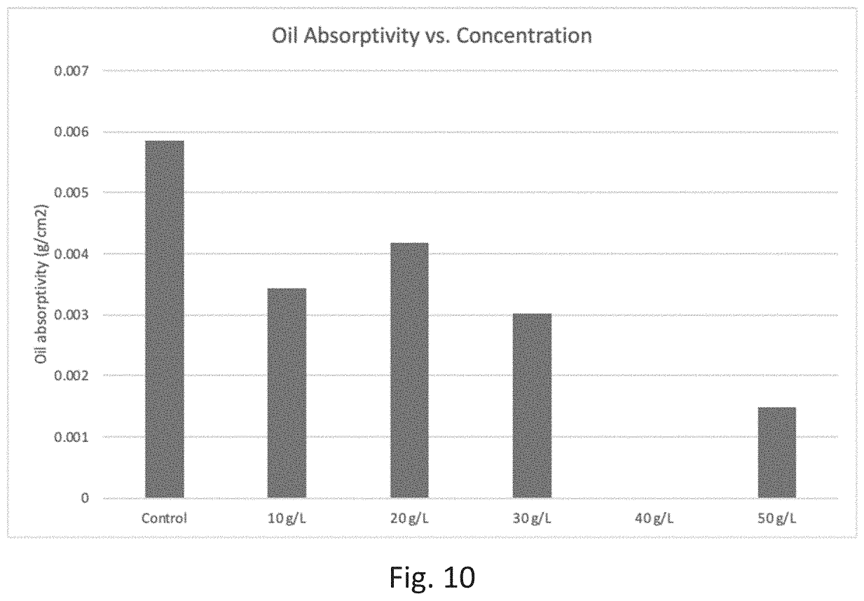

Oil absorptivity on untreated paper plates and paper plates treated with various coating solutions was compared. Commercially available paper plates were dipped in a coating solution and then heat pressed for 5 minutes in a hot plate press between a TEFLON mat and a top plate, with the top plate heated to 204° C. The coating solutions were 50 g/L of monoglyceride (9:1 SA-1G to PA-1G)/12-hydroxystearic acid/fatty acid salt (SA-Na), all at 50 g/L with water as a solvent. Results are shown in FIG. 9. FIG. 10 shows the effect of different concentrations of the Coating Standard (10 g/L, 20 g/L, 30 g/L, and 50 g/L) on oil absorptivity of the heat pressed paper plates.

### Example 10: Oil Resistance Based on Timing of Introduction of Coating Solution in a Thermoforming Process

Oil resistance of fiber material based on the timing of the introduction of the coating solution (various combinations of alkyl ketene dimer (AKD), 12-hydroxy stearic acid (12-HSA), 10,16-DHPA, and 95:5 mixture of SA-1G to SA-Na) at various stages in a thermoforming process was assessed. First, the coating solution was combined with a switchgrass pulp slurry, and the pulp slurry was thermoformed. Second, coating solutions were sprayed onto fibers on a formed mesh before heat pressing. Third, coating solutions were applied to paper products after thermoforming was complete. One to five coats were applied.

An oil-resistant sample was prepared by dispersing 45 g of fiber pulp in 2 L of water. The mixture was poured into a reservoir and drained, leaving behind the fiber on a wire mesh to form a plate. 5.2 g of 10,16-DHPA was mixed with 500 mL of water, and the resulting solution was sprayed on the surface of the formed (but not pressed) paper on the wire mesh. The formed paper was pressed at 100 psi and 200° C. for 60 s. The pressed paper was then removed from the wire mesh and sprayed with the Coating Standard until completely saturated. The saturated paper was then placed back on the thermoforming press and pressed for 40 s at 200° C. and ˜100 psi. This coating and pressing process was repeated 4 more times, and each sample (1 coat to 5 coats) was tested using vegetable oil in a beaker at ˜100° C. with an eye dropper in it. Samples judged to “pass” if the oil did not soak into the product. Visual assessment was used to determine whether the substrate had darkened as a result of oil penetration. The sample with 5 coats of the SA-1G: SA-Na mixture showed the best oil resistance.

Table 10 shows water vapor transmission rates (WVTR) in mg/min for several samples. WVTR were measured with Thwing-Albert Vapometer cups compatible with TAPPI T448. Samples prepared with AKD or 10,16-DHPA in the slurry, along with 5 coats of the Coating Standard applied to the thermoformed product, demonstrated lower WVTR than products with AKD or 10,16-DHPA in the slurry alone.

### Example 11. Aleuritic Acid Additive and Substrate Loading

Filter paper was soaked in an aqueous solution of 0.01 wt % aleuritic acid (9,10,16-trihydroxyhexadecanoic acid, ALA) and heated at 200° C. for 5 minutes to polymerize the aleuritic acid, thereby forming polyaleurate. A coating was applied by soaking the polymerized sample in the Coating Standard and pressing at 200° C. for 40 s. This coating process was repeated 4 times. Oil droplets placed on the treated filter paper showed little or no pass-through of oil after an hour.

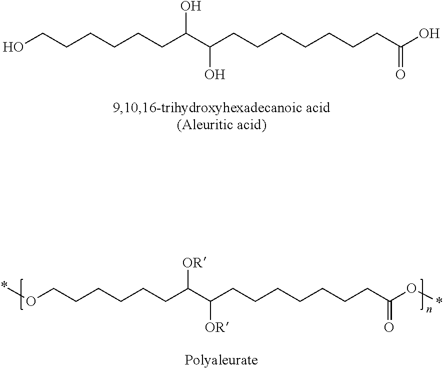

Treatment conditions were varied to assess the amount of solid uptake by substrates (grams per square meter (GSM) or “grammage”) based on various treatments. Table 12 lists the GSM of filter paper under three different conditions. Treatment “A” refers to soaking a filter paper substrate in the solution, then air drying the sample. Treatment “B” refers to the coating and pressing process performed 5 times as described in Example 12. Treatment “C” refers to the coating and pressing process of Treatment B, with aleuritic acid (0.1 wt %) combined with the Coating Standard. Based on the results in Table 12, aleuritic acid appears to improve the grammage of samples at low concentrations of the Coating Standard.

TABLE 11
Grammage of filter paper substrates with various treatments

| Treatment | Solution | GSM (g/m²) |
|---|---|---|
| A | 10 g/L Coating Standard | 3.96 |
| A | 20 g/L Coating Standard | 6.87 |
| A | 30 g/L L Coating Standard | 8.10 |
| A | 40 g/L Coating Standard | 11.43 |
| B | 5 × 10 g/L Coating Standard | 11.40 |
| B | 5 × 20 g/L Coating Standard | 14.05 |
| B | 5 × 30 g/L Coating Standard | 29.13 |
| B | 5 × 40 g/L Coating Standard | 50.84 |
| C | 5 × 10 g/L Coating Standard + ALA | 18.39 |
| C | 5 × 20 g/L Coating Standard + ALA | 22.92 |
| C | 5 × 30 g/L Coating Standard + ALA | 30.23 |
| C | 5 × 40 g/L Coating Standard + ALA | 36.80 |

Additional data showed that for Coating Standard concentrations between 50 g/L and 90 g/L, addition of aleuritic does not significantly increase grammage, but may contribute to lipophobicity. For a Coating Standard concentration of 100 g/L, grammage increases linearly as a function of the number of coating/pressing cycles. At this concentration of the Coating Standard, the addition of aleuritic acid does not contribute significantly to grammage, but may facilitate retention of coating on the surface of the sample.

### Example 12: Visual Omniphobicity Test Using Various Molded Fiber Substrates

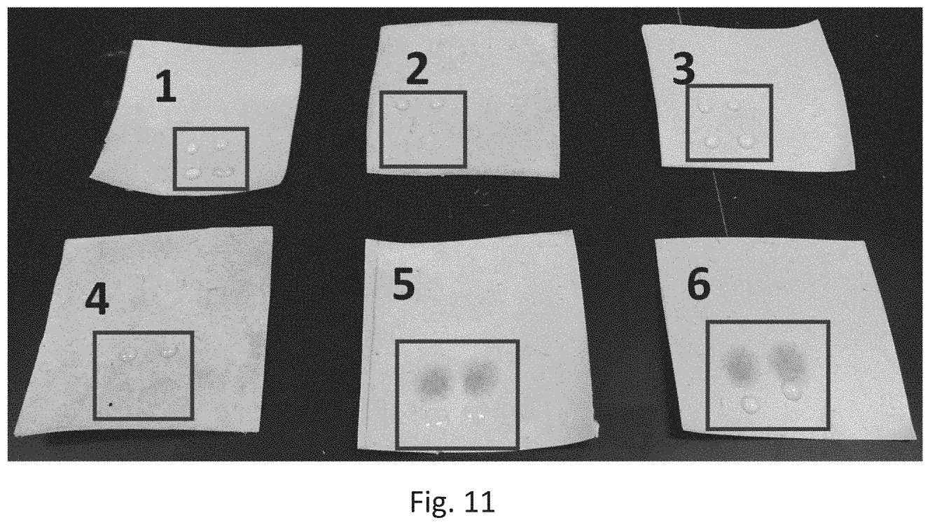

The oil and water absorptivity of treated perfluoroalkyl substance (PFAS)-free switchgrass fiber thermoformed paper products were tested and the results are shown visually in FIG. 11. Samples 1-4 are free of perfluoroalkyl substances (PFAS) and alkyl ketene dimers (AKD). Samples 5 and 6 are free of perfluoroalkyl substance (PFAS) but contain alky ketene dimers in the molded fiber. Samples 1, 3, 5, and 6 were treated with the corresponding treatment and then dried at 35° C. for 2 hours. Samples 2 and 4 were treated with the corresponding treatment and then heat pressed at 200° C. for 60 seconds. Samples 1, 2, and 5 were treated with 150 g/L 95:5 monoglyceride (90:10 SA-1G to PA-1G) to SA-Na and 300 ppm of NaCl (referred to as “Coating standard at 150 g/L” in the table). Samples 3, 4, and 6 were treated with 50 g/L 95:5 monoglyceride derived from hydrogenated high erucic acid rapeseed oil to SA-Na (referred to as “HEARO” in the table below). All samples were allowed to cool before testing. Below is a summary of the treatment conditions and results:

TABLE 12
Grammage of filter paper substrates with various treatments

| Sample | Substrate | Drying Conditions | Treatment |
|---|---|---|---|
| 1 | PFAS & AKD-free | 35° C. for 2 hours | Coating standard |
| | switchgrass | | at 150 g/L |
| 2 | PFAS & AKD-free | 200° C. for 60 seconds | Coating standard |
| | switchgrass | | at 150 g/L |
| 3 | PFAS & AKD-free | 35° C. for 2 hours | 50 g/L HEARO |
| | switchgrass | | |
| 4 | PFAS & AKD-free | 200° C. for 60 seconds | 50 g/L HEARO |
| | switchgrass | | |
| 5 | PFAS-free switchgrass | 35° C. for 2 hours | Coating standard |
| | with AKD | | at 150 g/L |
| 6 | PFAS-free switchgrass | 35° C. for 2 hours | 50 g/L HEARO |
| | with AKD | | |

FIG. 11 shows the visual results of the oil and water absorptivity tests. Two drops of approximately 100° C. vegetable oil were placed on each substrate (the top droplets), and two drops of room temperature water was additionally placed on each substrate (the bottom droplets). The results of FIG. 11 are summarized in Table 13 below:

TABLE 13
Results of oil and water absorptivity test, as shown in FIG. 11

| Sample | Oil Absorptivity | Water Absorptivity |
|---|---|---|
| 1 | PASS | PASS |
| 2 | PASS | FAIL |
| 3 | PASS | PASS |
| 4 | PASS | FAIL |
| 5 | FAIL | PASS |
| 6 | FAIL | PASS |

As shown in Table 13, Samples 1 and 3 are omniphobic. Samples 2 and 4 are oleophobic but not hydrophobic. Samples 5 and 6 are hydrophobic, but not lipophobic.

What is claimed is:

1. A fiber-based composite comprising:
a network comprising a multiplicity of fibers; and
a coating on the multiplicity of fibers, wherein the coating comprises:
one or more compounds of Formula IA; and
one or more compounds of Formula IIA,
wherein a ratio of a total weight of the one or more compounds of Formula IA to a total weight of the one or more compounds of Formula IIA is in a range of 1:1 to 99:1,
Formula IA is: 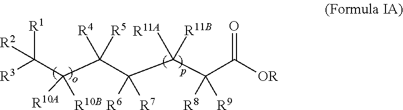
or a salt thereof when R is C₁-C₆ alkyl optionally substituted with one or more of OH and C₁-C₆ alkoxy,
wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
the sum of o and p is from 0 to 17, and
Formula IIA is: 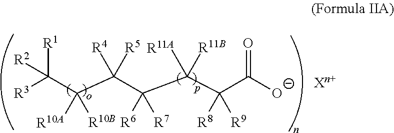
wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;
o is an integer from 0 to 17;
p is an integer from 0 to 17;
the sum of o and p is from 0 to 17;
Xⁿ⁺ is a cationic moiety having formal charge n; and
wherein a surface of the fiber-based composite is hydrophobic and lipophobic.

2. The composite of claim 1, wherein the ratio is in a range of 2:1 to 20:1 or 5:1 to 10:1.

3. The composite of claim 1, wherein:
a carbon chain length of at least one of the compounds of Formula IA is in a range of C12 to C30,
a carbon chain length of at least one of the compounds of Formula IIA is in a range of C12 to C30, or
a carbon chain length of at least one of the compounds of Formula IA is in a range of C12 to C30 and a carbon chain length of at least one of the compounds of Formula IIA is in a range of C12 to C30.

4. The composite of claim 1, wherein:
a carbon chain length of at least one of the compounds of Formula IA is in a range of C16 to C24,
a carbon chain length of at least one of the compounds of Formula IIA is in a range of C16 to C24, or
a carbon chain length of at least one of the compounds of Formula IA is in a range of C16 to C24 and a carbon chain length of at least one of the compounds of Formula IIA is in a range of C16 to C24.

5. The composite of claim 1, wherein the network defines pores, and some of the pores are at least partially filled with the coating.

6. The composite of claim 1, wherein the coating comprises a polymerization product of one or more compounds of Formula IA-B, wherein Formula IA-B is Formula IA when R is hydrogen.

7. The composite of claim 6, wherein:
at least one of the one or more compounds of Formula IA-B has a chain length of C16 or C18,
at least one of the one or more compounds of Formula IA-B has 0, 1, 2, or 3 hydroxyl groups, or
at least one of the one or more compounds of Formula IA-B has a chain length of C16 or C18 and at least one of the one or more compounds of Formula IA-B has 0, 1, 2, or 3 hydroxyl groups.

8. The composite of claim 6, wherein:
the one or more compounds of Formula IA-B comprise two or more compounds of Formula IA-B, and the two or more compounds of Formula IA-B comprise at least:
a first compound of Formula IA-B and a second compound of Formula IA-B;
a first compound of Formula IA-B and a third compound of Formula IA-B; or
a second compound of Formula IA-B and a third compound of Formula IA-B,
wherein:
the first compound of Formula IA-B is an omega hydroxy compound, wherein at least one of R¹, R², R³, R⁴, and R⁵ or at least one occurrence of R^{10A}, R^{10B}, R^{11A}, and R^{11B} is a hydroxyl group,
the second compound of Formula IA-B is a mid-chain hydroxy compound, wherein at least one of R⁴, R⁵, R⁶, and R⁷ or at least one occurrence of R^{10A}, R^{10B}, R^{11A}, and R^{11B} is a hydroxyl group, and
the third compound of Formula IA-B is a dihydroxy compound, wherein two of R¹, R², R³, R⁴, R⁵, R⁶, R⁷, R⁸, and R⁹ or at least one occurrence of R^{10A}, R^{10B}, R^{11A}, and R^{11B} are hydroxyl groups.

9. The composite of claim 1, wherein the coating is hydrophobic and lipophobic.

10. The composite of claim 9, wherein:
a contact angle of water on the surface in air at 25° C. is at least 50°, and
a contact angle of an oil on the surface in air at 25° C. is at least 50°.

11. The composite of claim 1, wherein the surface is a first exterior surface, and a second exterior surface opposite the first exterior surface is hydrophilic, lipophilic, or both.

12. The composite of claim 1, wherein the multiplicity of fibers comprises one or more cellulose-containing materials.

13. An article comprising the fiber-based composite of claim 1.

14. The article of claim 13, wherein a surface of the article is hydrophobic and lipophobic.

15. The article of claim 13, wherein the fiber-based article is a package, a dish, or a container.

16. A method of making the fiber-based composite of claim 1, the method comprising:
contacting the network comprising the multiplicity of fibers with a liquid composition, wherein the liquid composition comprises:
the one or more compounds of Formula IA; and
the one or more compounds of Formula IIA; and
drying the liquid composition to yield the fiber-based composite.

17. A method of making a fiber-based composite, the method comprising:
combining a multiplicity of fibers and a liquid to yield a slurry;
combining one or more compounds of Formula IA with the slurry;
removing some of the liquid from the slurry to yield a fibrous mass; and
drying the fibrous mass, wherein drying the fibrous mass comprises polymerizing the one or more compounds of Formula IA, thereby forming a polymer in contact with the multiplicity of fibers to yield the fiber-based composite,
wherein a surface of the fiber-based composite is hydrophobic and lipophobic, and
Formula IA is: 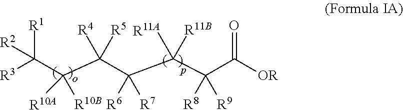
or a salt thereof when R is C₁-C₆ alkyl optionally substituted with one or more of OH and C₁-C₆ alkoxy,
wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
the sum of o and p is from 0 to 17.

18. The method of claim 17, further comprising disposing a liquid comprising one or more compounds of Formula IA and one or more compounds of Formula IIA on the surface of the fiber-based composite to form a coating on the fiber-based composite, wherein Formula IIA is: 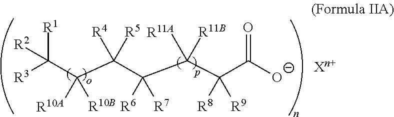
wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy; and
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
any two R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycle, or a C₃-C₆ cycloalkyl;
o is an integer from 0 to 17;
p is an integer from 0 to 17;
the sum of o and p is from 0 to 17; and
Xⁿ⁺ is a cationic moiety having formal charge n.

19. The method of claim 18, wherein the fiber-based composite defines pores, and some of the pores are at least partially filled with the coating.

20. The method of claim 17, wherein drying the fibrous mass comprises forming a fiber-based article comprising the fiber-based composite.

21. The method of claim 17, wherein drying the fibrous mass comprises heating the fibrous mass to a temperature greater than 140° C.

22. The method of claim 18, wherein forming the coating comprises removing at least a portion of the solvent by heating to a temperature at least 10° C. less or at least 20° C. less than a melting point or glass transition temperature of at least one of the one or more compounds of Formula IA.

23. The method of claim 18, wherein forming the coating comprises removing at least a portion of the solvent by heating the fibrous mass to a temperature in a range of 50° C. to 100° C.

24. The method of claim 17, wherein drying the fibrous mass comprises thermoforming the fibrous mass.

25. The method of claim 17, wherein the fiber-based composite defines pores, and some of the pores are at least partially filled with a polymerization product of one or more compounds of Formula IA-B, wherein Formula IA-B is Formula IA when R is hydrogen.

26. The method of claim 17, wherein the multiplicity of fibers comprises one or more cellulose-containing materials.

27. A fiber-based composite formed by the method of claim 17.

28. An article comprising the fiber-based composite of claim 27.

29. The article of claim 28, wherein a surface of the article is hydrophobic and lipophobic.

30. The article of claim 28, wherein the fiber-based article is a package, a dish, or a container.
